(19) United States
(12) Patent Application Publication
(10) Pub. No.: US 2004/0059552 A1
(43) Pub. Date: Mar. 25, 2004

(54) Process for modeling photons, electrons, protons, neutrons, atoms and the universe

(76) Inventor: John R. Ross, Del Mar, CA (US)

Correspondence Address: JOHN R. ROSS, PO BOX 2138, DEL MAR, CA, 92014, US

(21) Appl. No.: 10/655,817

(22) Filed: Sep. 5, 2003

Related U.S. Application Data
(63) Continuation-in-part of application No. 10/436,286, filed on May 12, 2003.
(63) Continuation-in-part of application No. 10/251,577, filed on Sep. 21, 2002.
(63) Continuation-in-part of application No. 09/908,297, filed on Jul. 17, 2001.
(63) Continuation-in-part of application No. 10/161,823, filed on Jun. 3, 2002.

(51) Int. Cl. G06F 17/10

(52) U.S. Cl. 703/2

(57) ABSTRACT

Processes for modeling photons, electrons, protons, neutrons and atomic nuclei; for analyzing light and other radiation, subatomic particles, atoms, molecules, mass, energy, electricity, heat, temperature, chemical reactions, fusion reactions, fission reactions, gravity and the entire universe, its evolution; and for analyzing all forces of nature. The present invention describes a new “thing” that is offered as the basic building block of everything in the universe. I call these things “trons”. There are two types of trons, a plus tron and a minus tron. Trons have no inherent mass but they have a charge equal to the electron charge of about +1.6×10⁻¹⁹ Coulomb for the plus tron and about −1.6×10⁻¹⁹ Coulomb for the minus tron. The charge on each tron results in an electric force field that travels out from the tron with a velocity equal to the speed of light. The magnitude of the force field decreases as the inverse square of the distance from the point from which it started expanding. The field from an individual tron is attractive for unlike trons and repulsive for like trons. All trons are pushed and pulled by these expanding force fields. In preferred embodiments each tron is pushed away by its own force field and therefore its velocity is never less than the speed of its own force field (i.e., c in most of my preferred embodiments). This specification discloses new models for the electron, the proton and gravity not disclosed in the parent applications. In the electron model all trons are moving faster than the speed of light. All electrons except electrons “at rest” are driven by captured photons. The proton of the new model is comprised of one negatron and two positrons each driven by high energy/mass photons. Gravity in the new model results from the backward Coulomb force from photons (such as neutrinos) passing through matter pushing the matter toward the source of the photons.

This Application is a Continuation-in-Part Application of Ser. No. 10/436,286 filed May 12, 2003, Ser. No. 10/251,577 filed Sep. 21, 2002 and Ser. No. 09/908,297, filed Jul. 17, 2001, which was a Continuation-in-Part of Ser. No. 10/161,823 filed Jun. 3, 2002, now abandoned. This invention relates to processes for analyzing nature, for modeling light, atomic and subatomic particles and their inter-reactions, and for modeling the universe and its evolution.

### BACKGROUND OF THE INVENTION

### What We Are Made Of

Since civilizations first developed the smartest men in the world have sought to explain what we and the rest of the universe are made of. Scientist have discovered that the observable universe seems to be comprised of atoms each of which comprises a nucleus having a positive charge surrounded by one or more electrons each having a negative charge. There is general agreement among leading nuclear scientists that the nuclei of all atoms except H¹ consist of protons and neutrons. (The H¹ isotope has only a single proton and no neutron in the nucleus. The nuclei of the H² and H³ isotopes of hydrogen contain one and two neutrons respectively in addition to a single proton.) In prior art models charge neutral atoms have a number of negative electrons surrounding the nucleus equal to the number of protons in the nucleus and that number determines the chemical properties of the atom. Scientists generally believe that substantially all of the hydrogen in the universe was created during or shortly after a “big bang” which occurred at the origin of the universe and that some helium was also created during this very early stage of the evolution of the universe by the fusion of nuclei of hydrogen atoms. There is a generally accepted belief that all other naturally occurring elements in the universe were created by fusion processes in large stars which explode to scatter the elements widely in the universe. These elements then later collect together to form objects like planets.

### Electrons—Positrons and Negatrons

The word “electron” can be used to refer to only negative electrons or it can be used more generally to refer to either negative or positive electrons. Most of us are very familiar with negative electrons which orbit atomic nuclei. A “positron” is a positive electron. Another name for the negative electrons is “negatron”. A positron has a mass equal to the mass of a negative electron and a charge opposite that of the negative electron but equal in magnitude. When the term “electron” is used later in this specification, its meaning will be clear so long as the reader understands that the word has these two possible meanings.

### The Size of Things

Experiments indicate that the size (distance across) of a typical atom is about 10⁻¹⁰ meter. The size of the nucleus of a typical atom (such as sodium with 26 protons and 26 neutrons) is about 10⁻¹⁴ m or about 1/10,000 the size of the atom. The size of a proton is about 10⁻¹⁵ m. The size of an electron is not known for certain but scattering experiments indicate that electrons are smaller that 10⁻¹⁸ m, and some sources indicate that they may be point-like. A diameter of 10⁻¹⁸ would make the electron about 1,000 times smaller than a proton. Its mass is about 1800 times smaller than the mass of a proton.

### Charges

A negative electron (negatron) has a negative charge of about −1.6×10⁻¹⁹ Coulomb and a positive electron has a positive charge of about +1.6×10⁻¹⁹ C. The prior art teaches that a proton has a positive charge of +1.6×10⁻¹⁹ C. (This charge is sometime referred to as a charge of e referring to the magnitude of the electron charge.) Since neutral atoms have an equal number of positive protons in the nucleus and surrounding negative electrons (negatrons); at distances substantially greater than atomic dimensions, the neutral atom has no charge that is apparent to us.

### Photons

In the prior art a photon is believed to be a quantum of electromagnetic radiation. A photon has energy equal to its frequency multiplied by Plank's constant. A photon is believed to be have zero charge and is believed to travel at the speed of light. Virtual photons are believed to be exchanged between charged particles and are believed to carry electromagnetic force.

### Creation of Mass

Pair production is an event in which a gamma ray photon with energy in excess of 1.02 MeV interacts with matter to create a negatron—positron pair. The “rest mass” of a negatron is 9.1100×10⁻³¹ kilograms. This mass in energy units is equal to about 0.51 MeV. The rest mass of the positron is exactly the same as that of the negatron. It is also known that the combination of a positron and a negatron results in the annihilation of both of them with the release of high-energy photons. This creation and annihilation is well documented, but the prior are does not provide a good explanation as to what actually takes place in either case.

### Composition of Little Things

The prior art does not provide a good physical description of either photons or electrons. Photons are treated as particles in some cases and as waves of electromagnetic radiation in other cases. There have even been attempts in the prior are to apply wave characteristics to electrons. Electrons are normally treated as particles; however, most modem descriptions of atoms treat the electrons in the atoms as if they were some sort of cloud orbiting the nuclei.

### Quarks

Modem nuclear scientists have tried to explain the structure of protons and neutrons. There is a general belief that protons and neutrons are comprised of particles they call “quarks”. They think that there are various types of quarks including “u-type” quarks and “d-type” quarks. The idea is that protons and neutrons are made up of three quarks each. The proton is supposed to be comprised of two u-type quarks and one d-type quark. The neutron is supposed to be comprised of two d-type quarks and one u-type quark. Since the u-type quarks are suppose to have a charge of 2e/3 and the d-type quarks a charge of −e/3 (where e is the magnitude of the electron charge), the net charge of the proton is +e and the net charge of the neutron is zero. (See, for example, Chapter 15, pages 608-651, Modern Physics, Second Edition, Serway et al, Saunders College Publishing, for a general discussion of these issues, especially page 633.) Most leading nuclear physicists apparently have accepted this concept of quarks as truth.

### Masses

As stated above, the rest mass of an electron (positive or negative) is 9.1100×10⁻³¹ kg (or 0.000911×10⁻²⁷ kg which is equivalent to 0.511 Mev). The mass of a proton at rest is about 1.6726×10⁻²⁷ kg (939.19 Mev). The rest mass of a neutron is about 1.6750×10⁻²⁷ kg (939.54 Mev). The combined mass of a proton and the mass of an electron is about 15×10⁻³¹ kg less than the mass of a neutron. According to Einstein's theory of relativity the mass of a particle increases as its velocity increases according to the following relationship:

$$m = \frac{{m}_{0}}{\sqrt{1 - {( v / c )}^{2}}}$$

where v is the velocity of the particle and c is the speed of light.

### Atomic and Nuclear Forces

### Forces on Orbiting Electrons

The electrical force between charged particles is governed by Coulomb's Law and is defined by the following equation:

$$F = \frac{{q}_{1} {q}_{2}}{4 π {ϵ}_{0} {r}^{2}}$$

The ratio 1/4πe₀=9.0×10⁹ Nm²/C² and the radius r of the hydrogen atom is about 5.3×10⁻¹¹ m. Therefore, (making the assumption that the electron is orbiting at the outer region of the atom and the proton is at the center) the attractive force between the proton and the electron in the hydrogen atom is about:

F=8.2×10⁻⁸ N

The electron is not pulled into the nucleus. Why this is so is not completely understood. In the Bohr atomic model electrons are merely assumed to be confined to one of several specific obits. Another answer is that the electron orbits at an orbital velocity great enough so that the centripetal force on it exactly matches the attractive electrical force. Centripetal force is:

$$F = \frac{m {v}^{2}}{r}$$

If this is correct, the velocity of the electron would be about:

$$v = \sqrt{F \frac{r}{m}} = \sqrt{\frac{( 8.2 \times {10}^{- 8} N ) ( 5.3 \times {10}^{- 11} m )}{9.1 \times {10}^{- 31} kg}}$$

$$v = 2.18 \times {10}^{6} m \text{/} s .$$

This is a very large velocity (2.18 million meters per second), almost 1 percent the speed of light. It also would imply a frequency of about 6.5×10¹⁵/sec. In any event the Bohr atomic model is not currently accepted by leading physics experts. The modem thinking, as stated above, is that the electrons surrounding the nucleus should not be thought of as being in a defined orbit, but instead some sort of electron cloud or probability density is suggested.

Experiments have shown that the exponent of r (i.e., 2) in the Coulomb equation is very accurately 2.0000 for dimensions down to 10⁻¹⁴ m. However, there is a current belief that in nuclei forces between charged particles do not obey this equation. (See Parker, Concise Encyclopedia of Science and Technology, 3^{rd} Ed., McGraw Hill, p. 492.)

### Forces in the Nucleus

In all atoms except hydrogen atoms, there are multiple positively charged protons closely packed in the nucleus along with a roughly equal number of neutrons. Thus, these protons are believed to exert tremendous repulsive forces against each other as suggested by the following example of two protons separated by 4.0×10⁻¹⁵ m, which is a typical nucleus dimension:

$$F = \frac{{q}_{1} {q}_{2}}{4 π {ϵ}_{0} {r}^{2}} = \frac{( 9.0 \times {10}^{9} N {m}^{2} / {C}^{2} ) {( 1.6 \times {10}^{- 19} C )}^{2}}{{( 4.0 \times {10}^{- 15} m )}^{2}}$$

$$F = 14 N$$

A force of 14 N is equivalent to about 3.2 pounds; this force acting on the two protons each of which has a mass of only 9.1×10⁻³¹ kg should cause the protons to fly apart with enormous velocities. This does not happen. There is a current belief among the most knowledgeable nuclear scientists that there must be some other force acting in the nucleus to hold it together. Scientists call this force the “strong force”. The Applicant is not aware of any specific proof of this “strong force”. Nevertheless most leading nuclear scientists apparently have accepted this concept of this strong force.

### Neutrinos

Neutrinos are believed to be tiny neutral particles of either zero mass or almost zero mass with no charge. There are supposed to be an enormous number of them. Some scientists estimate that billions of them generated in our sun pass through our bodies each second. They are believed to be generated as a consequence of nuclear fusion and (of the ones that head out in the direction of earth) nearly all of them pass right through it and continue on out through the universe. Neutrinos are very hard to detect; however, scientists believe they have detected a few of them in large underground tanks. Apparently they (in 1987) detected a few neutrinos that had traveled 170,000 light years to our earth from an exploding super nova.

### Magnetism and Gravity

We are very well aware of the force of gravity which holds us to the earth and keeps the earth in its orbit about our sun. And we can feel magnetic forces when we use a little magnet to hold our kids' pictures tightly against the refrigerator door. However, to my knowledge there is not available in the prior art a good basic explanation for what produces either of these forces.

### Unanswered Physics Questions

As additional background for the present invention Applicant includes the following excerpts from the very popular physics set, Feynman, Lectures on Physics, Addison Wesley, Vol. II, p 1-2, 8-6&7, 20-9&10:

“What holds the nucleus together?” In a nucleus there are several protons, all of which are positive. Why don't they push themselves apart? It turns out that in nuclei there are, in addition to electrical forces, non-electrical forces, called nuclear forces, which are greater than the electrical forces and which are able to hold the protons together in spite of the electrical repulsion. The nuclear forces, however, have a short range- their forces fall off much more rapidly than 1/r² . . . . We may ask, finally, what holds a negatively charged electron together (since it has no nuclear forces). If an electron is all made of one kind of substance, each part should repel the other parts. Why, then, doesn't it fly apart? But does the electron have “parts”? Perhaps we should say that the electron is just a point and that electrical forces only act between different point charges, so that the electron does not act upon itself. Perhaps. All we can say is that the question of what holds the electron together has produced many difficulties in the attempts to form a complete theory of electromagnetism. The question has never been answered. (Emphasis added.)

[A] big program was started for the study of the scattering of protons, in the hope of finding the law of force between [neutrons and protons]; but after thirty years of effort, nothing has emerged. A considerable knowledge of the force between proton and proton has been accumulated, but we find that the force is as complicated as it can possibly be. What we mean by “as complicated as it can be” is that the force depends on as many things as it possibly can . . . . There is, however, one important way in which the nucleon forces are simpler than they could be. That is that the nuclear force between two neutrons is the same as the force between a proton and a neutron, which is the same as the force between two protons! If, in any nuclear situation, we replace a proton by a neutron (or vice versa) the nuclear interactions are not changed. The “fundamental reason” for this equality is not known.

I have no picture of [the] electromagnetic field that is in any sense accurate. I have known about the electromagnetic field a long time—I was in the same position 25 years ago that you are now, and I have had 25 years more of experience thinking about these wiggling waves. When I start describing the magnetic field moving through space, I speak of the E- and B fields and wave my arms and you may imagine that I can see them. I'll tell you what I see. I see some kind of vague shadowy, wiggling lines—here and there is an E and B written on them somehow, and perhaps some of the lines have arrows on them—an arrow here or there which disappears when I look to closely at it. When I talk about the fields swishing through space, I have a terrible confusion between the symbols I use to describe the objects and the objects themselves. I cannot really make a picture that is even nearly like the true waves. So if you have some difficulty in making such a picture, you should not be worried that your difficulty is unusual.

### The Need

Prior existing descriptions of the basic building blocks of the universe are not satisfactory. What is needed is a simpler unifying process for describing of the particles making up the universe, processes for modeling photons, protons, neutrons, nuclei, atoms and the universe and techniques and processes for confirming or disproving this simpler unifying description.

### SUMMARY OF THE INVENTION

The present invention provides processes for modeling photons, electrons, protons, neutrons and atomic nuclei; processes for analyzing light and other radiation, subatomic particles, atoms, molecules, mass, energy, electricity, heat, temperature, chemical reactions, fusion reactions, fission reactions and the entire universe, its evolution; and possibly processes for analyzing all forces of nature.

### Basic Building Blocks of the Universe

The present invention describes a new “thing” that is offered as the basic building block of everything in the universe. I identify this thing as a “tron”. There are two types of trons, a plus tron and a minus tron. In a preferred embodiment of the invention everything in the universe can be modeled as being comprised of nothing but combinations of these two types of trons. Trons have no mass and no volume but they have a charge equal to the electron charge of about +1.6×10⁻¹⁹ Coulomb for the plus tron and about −1.6×10⁻¹⁹ Coulomb for the minus tron. The charge on each tron results in an electric force field that travels out from the tron spherically with a velocity equal to the speed of light. The magnitude of the force field decreases as the inverse square of the distance from the point from which it started expanding. The field from an individual tron is attractive for unlike trons and repulsive for like trons. Having no mass these trons move at the velocity of the net forces acting on them, like a surfer on one or more waves or a water skier being pulled by a boat and pushed about by wind produced waves and by wakes from the boat. In preferred embodiments each tron is always being pushed away by its own force field and therefore its velocity is never less than the speed of its own force field (i.e., c, the speed of light, in most of my preferred embodiments). These then are truly the elementary particles that are the building blocks of the universe. However, since they have no mass and no volume, its seems illogical to call them particles, therefore, I have developed a new term to describe trons. It is “pointicle”

With this basic model, all of the elements of the universe (including photons, electrons, protons, atoms, molecules, memories and galaxies) and forces (including magnetism and gravity) can be described and explained. Questions such as the ones raised by Dr. Feymnan quoted in the background section can now be simply answered. Models of exotic things we know very little about such as neutrinos can be described with this basic model. This basic model proposed and claimed in this application also seems to be consistent with all known and accepted physics principals and the results of experiments relating to particle physics, magnetism, optics, various forms of energy, fusion and fission. In many cases, however, this model provides explanations for particular results which are substantially different from the prior art explanations. Some physics principals which in the past have been shown to give good results but do not seem logical (such as the uncertainty principal [which, by the way, Dr. Einstein did not accept]) may be explained based on or may be derivable from this extremely simple basic model. (Most of these tasks—such as deriving Dr. Schrodinger's uncertainty principal from models described herein—have been left by the inventor for others to have fun with.)

### Photons

In preferred embodiments of this invention photons are modeled as a single plus tron and a single minus tron orbiting helically at the photon frequency in an orbit plane and being driven in the photon direction, at a speed of light, by the repulsive Coulomb forces of each of the charges on itself with each tron held in its helical orbit by the attractive force of the other tron. The two trons having zero mass are traveling in their helical paths substantially faster than the speed of light. I have not figured out for certain the orbit diameter of the photon, but in preferred models it is assumed to be equal to one half the wavelength of the light beam the photon is a part of. And the speed of the expanding force field is assumed to be c, the speed of light. Various other similar photon models may be possible and some other models are proposed.

In one embodiment a polarized photon is modeled as a plus and minus tron traveling in a plane parallel to the photon direction and mapping out a crisscrossing sin function. In preferred embodiments neutrinos are very high-energy photons.

### Electrons—Positrons and Negatrons

In preferred embodiments six trons, three plus and three minus (such as the trons making up three photons [remember, each photon is comprised of a single plus tron and a single minus tron]) combine (in a process called “pair production”) to produce a single positron (one minus tron and two plus trons) and a single negatron (one plus tron and two minus trons). The positron is modeled as a minus tron orbited by two plus trons and a negatron (the negative electron, normally referred to merely as an electron) is modeled as a single plus tron orbited by two minus trons. In a model of the positron and the negatron disclosed in a parent application, the tron Coulomb forces propel the two orbiting trons (having the same sign) in two perfect circles on the surface of a perfect sphere surrounding the inner tron. This application describes a new electron model in which, for the negatron, the plus tron path is a circle and the two minus trons orbit the path of the plus tron at positions one forth period behind the plus tron. The minus trons orbit is in synchronization with the plus tron so that each of the trons completes its cycle in the same time period. For the positron, the positions of the plus and minus trons are reversed. I call this electron configuration the “triple tron twirl”. Since the plus tron in the negatron follows a circular path and each of the minus trons pass through the center of the circle once each period, the electron cannot be a point. However, I believe the orbits of each of the trons immediately after the electron is formed in pair production collapses into extremely small orbits with diameters smaller than 10⁻¹⁸ m so that the electron appears to be a spinning point. Thus, this model can provide an explanation for the electron's very small but finite size and spin. This model suggests an explanation for the enormous stability of negatrons and positrons in all situations except when one meets the other. When a positron and a negatron meet each other they annihilate each other releasing the trons which pair up to produce photons that shoot off at the speed of light; otherwise, positrons and negatrons are probably indestructible. Remember, Dr. Feynman could not understand why electrons do not “fly apart”. Read on to find out why they don't.

### Protons and Neutrons

Protons and neutrons, like everything else in the universe are modeled according to the present invention as comprised of trons. In a proton model proposed in a parent application the proton is comprised of three positrons and two negatrons. (In some models the electrons are propelled by captured neutrinos.) A positron is orbited by two negatrons in orbits so tight that the orbit speeds of the negatrons is very very close to the speed of light (i.e., about 0.9999994c) causing increases in the mass of each of the electrons (about 900 times) sufficient to approximately match the known mass of the proton of about 1.67×10⁻²⁷ kg. Two more positrons orbit the center three-some farther out at radii corresponding to the known proton radius. Thus, the three positrons and the two negatrons give the proton its mass of 1.67×10⁻²⁷ kg and its charge of plus one. The plus one charge is also produced by adding up the eight plus trons and the seven minus trons contained in the three positron and two electrons which make up the proton. In another embodiment the proton is modeled with a plus tron in the middle, so that the proton is comprised of a plus tron in the middle with two negatrons and two positrons in orbit. The neutron in this model is simply a proton with a negatron in very close orbit.

A new proton model proposed herein has a dynamic shape similar to the positron model in which a negatron follows a circular path and two positrons orbit the path one forth period behind the negatron. The proton mass results either from the velocity of the positron and the negatrons close to the speed of light, or the extra mass might be the result of captured high frequency photons which are driving the positrons and negatrons along their paths as explained below. In this model the neutron is a proton with a second negatron positioned at 180 degrees on the path of the first negatron. So the two negatrons orbit on the same path with the two positrons making helical orbits around the path of the two negatrons.

Anti-protons and anti-neutrons would be the same as the protons and neutrons with the roles of the positrons and the negatrons reversed.

### Captured Neutrinos May Propel Electrons

A possible explanation of the proton mass relates to the possibility that electron speed is the result of captured photons (tron pairs) all or part of which orbit behind the electron and propel it forward with Coulomb forces. The tron pairs propelling the innermost orbiting electrons in the 5-electron proton model would be very high-energy photons (i.e., captured neutrinos). A very high frequency photon driving these close-in electrons would represent substantial energy/mass according to E=hv. A high energy photon with enough energy to correspond to about one-half the proton mass would have a frequency of about 10²³/sec. The corresponding wavelength would be about 3×10⁻¹⁵ m. This would make the orbit of the driving photons (at orbit diameter=1/2λ) about the same size as the protons. This seems a little too large. (This is not a problem with the 3-electron proton model.)

The question is, can we explain the proton mass as being mostly due to high-energy photons (E=hv) that are driving the proton's close-in electrons at velocities close to the speed of light? A possible explanation is that when a photon is captured by a negatron (for example) the photon's plus tron is trapped inside the helical orbits of the negatron's minus trons at 180 degrees behind the negatron's plus tron. The photon's minus tron then orbits the negatron at a distance behind the negatron on the trail of the negatron. When the negatron moves with a velocity v the minus tron follows in a helical orbit applying a Coulomb force to the negatron keeping it moving at a constant velocity; the smaller the helical diameter of the following minus tron, the greater the force on the negatron. This may provide an explanation for momentum! It may also provide an explanation for high voltage electrons.

### Atomic Nuclei

Preferred models of the present invention model atomic nuclei as protons and neutrons held together at nuclear distances in Coulomb force wells. In preferred models, the proton plus one charge and the neutron zero charge are actually several separate discrete charges (such as for the proton: 15, 13, 9 or 27) grouped into separate discrete unit charge units (such as for the proton: three plus and two minus or two plus and one minus). Therefore, protons and neutrons can orient themselves so that they attract each other and repel each other (depending on orientation and distance of separation) producing force wells with strong Coulomb forces (not “the strong force”). On both sides of the wells, the protons repel each other. The neutron is indifferent (neither attracted or repelled from charged particles) at distances longer than nuclear distances, but is attracted to protons and other neutrons in specific configurations at atomic distances and is again repelled from both protons and other neutrons if it gets too close.

### Atoms and Molecules

The present invention proposes in accord with prior art thinking that atoms and molecules are made up of protons and neutrons in the nuclei with electrons in orbits. Larger atoms are produced by the fusion of nuclei of smaller atoms or the capture of neutrons, again, in accordance with prior art thinking. However, electrons are not clouds of charges as contemplated in the prior art but are comprised of at least three discrete charges as explained above, i.e., two negative trons and one positive tron. In addition in preferred models electrons also have one or more captured photons (tron pairs) associated with them and driving them forward.

### Electric Current

The present invention proposes that the flow of electric current in both direct-current circuits and in alternating current circuits is for the most part the flow of plus trons and minus trons, not electrons and holes. Because of their zero mass and point volume trons can travel through a copper wire at a large fraction of the vacuum speed of light. However, when they arrive at their destination each one contributes a charge equal to a negative electron or an opposite positive charge. In preferred embodiments high voltage results from cramped trons circling in orbits which become smaller as voltage increases. The circling trons pick up an oppositely charged “dance” partner and each of the partners attach themselves to a conduction electron pushing it forward at a velocity corresponding to the high voltage.

### Thermal Energy

In preferred models of the present invention thermal processes are for the most part produced by action of plus and minus tron pairs (trapped photons are sometimes referred to as tron pairs) that are temporally captured within atomic and molecular structures. However, according to this model trons pairs are good at escaping and do so in processes we know as conduction, convection and radiation. It is the flow of tron pairs (either as radiant heat flow [thermal photons] or as conduction and convection) that we perceive as heat energy flow.

### Chemical Energy

In preferred models tron pairs circle all molecules and atoms. When atoms combine to form molecules or when atoms and molecules or molecules combine to form larger molecules, the number of tron pairs in the resulting combination is typically different from the number of tron pairs in the constituent parts. If the tron pairs are fewer in the combination, tron pairs are released as photons (representing a release of heat), and if the tron pairs in the combination are more than in the parts, then tron pairs (i.e., heat) must be added to make the reaction go.

### Nuclear Energy—Fission and Fusion

According to preferred embodiments tron pairs also circle the nuclei of atoms and the parts of the nuclei. Each atom is configured in such a manner as to prefer a specific set of tron pairs representing its ground (or normal) state. When atoms fuse or fission, as above, we compare to resulting product or products with the pre-existing product or products. If the pre-existing product or products had more tron pairs than the resulting product or products, then energy is released. The energy release may be in the form of tron pairs (i.e., photons or neutrinos) or some of the energy may be in the form of recoil energy. For example, the nuclei of two deuterium atoms have more tron pairs than a helium nucleus. The excess tron pairs are released in the fusion process.

### Temperature

In preferred models temperature for a particular atomic or molecular composition is a measure of the number of trons then circulating in the composition. The number of tron pairs is responsible for changes of phase of matter (e.g., from solid to liquid to gas).

### Neutrinos

Neutrinos travel at the speed of light, have no charge and a very small or zero mass. Thus, they thus could be modeled as a plus tron and a minus tron orbiting each other in a double helix like the photon but with a much smaller orbit. These photon-like neutrinos would have a very large frequencies, i.e., frequencies in the range of 10²³/sec. Their wavelength would be about 1.8×10⁻¹⁵ m or smaller. Thus, their size would be about the size of a proton, smaller than the nucleus of an atom and much smaller than an atom. The energy of such a neutrino would be about 10³ Mev. In a preferred model a lower energy electron may capture a neutrino to form a heavy (high-energy) electron which can be captured by a proton to form a neutron. The neutron can be stable if it can get inside of a nucleus within a very few minutes. Otherwise it decays within a few minutes into a proton releasing the heavy electron, which in turn decays to an electron releasing the neutrino which then goes on its way at the speed of light. In other models each electron (plus and minus) in atomic nuclei has captured a neutrino. And in some models this neutrino provides a force that propels the electron forward. As described in some detail below, the neutrino may also be the carrier of the gravitational force.

### Magnetism

Applicant speculates that the magnetic forces we experience are the result of the flow of trons along what we have called magnetic lines of force inside of and beyond magnetic materials at speeds equal to or in excess of the speed of light. According to this model the magnetic fields of the earth results from the flow of these trons through the earth, exiting near one of our earth's poles and entering at the other. The round trip may require less than one second at tron speed, estimated at c.

### Gravity, Black Holes and the Expanding Universe

Applicant believes that the gravitation force must be derived from the Coulomb electrostatic forces. In a parent application I stated that I believed that gravity is a manifestation of these electrostatic tron forces that are not quite perfectly balanced resulting in the mutual attraction of matter (according to the laws of gravity) at a range of distances larger than molecular distances and smaller than galactic distances, and that at smaller or larger distances, gravitation rules may not apply.

Explaining gravity in terms of the Coulomb force from trons is important, because a central idea of the present invention is to try to explain all of physics in terms of trons and the Coulomb force that exudes from them. In a new gravity model matter-penetrating photons (such as neutrinos) are carriers of the gravitation force and gravity is the result of Coulomb forces pushing on charges in the matter through which the matter-penetrating photons (such as neutrinos) are passing. The force is in the direction opposite the direction of travel of the matter penetrating photon. This is because a charged particle (such as an electron) near the path of a photon does not feel the effects of a photon until the photon passes the charged particle. Once the photon passes, the charged particle feels the expanding Coulomb force for a relatively long period. The force from the photon will be expanding toward to source of the photon.

The sun produces very large quantities of neutrinos, which in accordance with this theory helps keep the planets in orbit. I suspect that the gravity of the earth results mostly from neutrinos from the sun temporarily captured in electrons or protons in the earth and then released in random directions. As suggested above a neutron may be a proton that has captured a high-energy electron (i.e., one driven by a captured neutrino). A neutron half-life is only a few minutes and its decay results in the emission of a neutrino (presumably in a random direction. If electrons capture neutrinos as I suspect they do, then they probably release them in random directions.

Black holes are the seat of enormous gravity. I suspect that this gravity results from the conversion of mass into neutrinos in the black holes. This may help explain what happens to much of the matter than gets sucked into a black hole. Although, I recognize this a speculation on speculation, I would guess that the matter being converted is protons and neutrons. These elements according to embodiments of this invention contain lots of trapped neutrinos. This theory may also help explain why far away galaxies are drifting apart. My understanding is that the space between galaxies contains lots of hydrogen. I suggest that hydrogen has a cross section for neutrino capture that is greater than its cross section for capture of longer wavelength photons such as visible light, which does not penetrate matter very well. Thus, at extremely long distances between far-apart galaxies the neutrino flux is greatly reduced relative to the non-penetrating photons. Non-penetrating photons apply a repulsive force pushing apart the far-apart galaxies. Black holes do not emit visible light. If they emit very large amounts of neutrinos and if the neutrinos are the carriers of the gravitational force, all as suggested here, a possible consequence of the universe being dominated by black holes is that the far-apart galaxies will begin to come together. When and if that happens, all of the galaxies of the universe may be drawn together into one massive black hole. Whoever is watching at that time may be looking at the beginning of another big bang.

### Antimatter

The models of the present invention easily accommodate antimatter particles of all types. The modeling of the antimatter particle corresponding to any of the above described particles or atoms is done by merely switching the plus trons in the particle with the minus trons. The electron and the positron have already been described. The anti proton in the five-electron model has an electron (or a minus tron) in the center orbited closely by two positrons and further out by two more electrons. The anti neutrino is just the opposite of the neutrino. In the three-electron proton model, the anti-proton has positron in a circular orbit, and two negatrons orbit the path of the negatron. The anti-neutron in this model has a second positron orbiting in the circular path of the first positron at 180 degrees relative to the first negatron.

### Models

The present invention provides physical and computer models representing trons, photons, electrons, nuclei atoms and molecules. These models can be combined to describe anything in the universe and the universe itself.

### Analytical Process

Preferred embodiments of the present invention include processes for analyzing forces acting in atomic nuclei. Embodiments of the present invention can be utilized to analyze hydrogen thermonuclear reactions. The present invention also provides a process for attempting to create protons is in a particle accelerator. The present invention also provides models for analyzing electric current flow, heat flow and electromagnetic radiation. Computer models based on embodiments of the present invention may be extremely valuable for examining a wide range of natural and unnatural phenomenon from the interaction of subatomic particles to nuclear reactions to the big bang to the evolution of the universe. In fact, if the models and processes of the present invention turn out to be a correct representation of these subatomic particles and charges, all physics and chemistry books and all methods and processes for examining structures, electric currents and forces at atomic and molecular distances will need to be revised in accordance with the teachings of the present invention.

### “Beam Me Up Scotty”

A preferred utilization of this model is to provide a far-fetched explanation of the operation of a Star Trek transporter. An entire person at a first location (including his clothes and his memories) is analyzed and the person along with his clothes and memories are broken down into trons and the trons are transported as photons to or from the transporter machine and reassembled into the same person at a second location. The reader should understand that the Applicant does not believe that a Star Trek transporter will ever be built; he is merely suggesting that this model could be used to explain how such a machine may be possible in the distant future.

### The Force (The One and Only Force)

An importance consequence of the present invention is that there could be only one force in the universe. That is the Coulomb force that exudes from each and every tron. As all matter, radiation and everything else in the universe (in preferred embodiments) are comprised only of trons, all forces are merely various manifestations of the trons' Coulomb forces. I leave it to smarter people than I to prove with their fancy math that this is true. I encourage this effort and look forward to seeing the proofs. I suspect that another consequence of the present invention is that all “fundamental” constants should be derivable from the tron charge, π, and the speed of light. This is because (in most of these embodiments) the tron force depends on the tron charge and expands out as an expanding sphere at the speed of light. For speed we need a time unit and a distance unit. I throw this out as a challenge to smart people all over the world.

### New Models for the Electron, the Proton and Gravity

As stated above, this specification discloses new models for the electron, the proton and gravity not disclosed in the parent applications listed in the first sentence of this application. In the electron model all trons are moving faster than the speed of light. All electrons except electrons “at rest” are driven by captured photons. The proton of the new model is comprised of one negatron and two positrons each driven by high energy/mass photons which in this model are neutrinos. Gravity in the new model results from the backward Coulomb forces from matter penetrating photons (such as neutrinos) passing through matter pushing the matter backward toward the source of the photons.

The new model has the ultimate symmetry. In preferred models there is in the universe the exact same number of plus trons as minus trons. Trons have no mass and no volume. They are exactly opposite. If we were able to bring them together, they would completely cancel each other, leaving the universe with absolutely nothing, no mass, no energy, no nothing! If adding two things together produces nothing, then maybe it would be possible to make those two things from nothing. Thus, this model suggests a technique that God may have used to make the universe from nothing.

It would seem that bringing all the trons together in opposite pairs should not be too difficult since they attract each other with huge forces when they get close. However, as I explain below, this apparently does not happen because each of the trons is always being pushed from behind by its own force field at a speed of 186,000 miles per second and exerts no attractive force in front of itself.

### Unanswered Questions

The present invention provides new methods for analyzing the universe and everything in it. The model provides simple explanations for many known phenomenon for which previous explanations were unsatisfactory. These models for the most part are based on thought experiments not actual experiments and Applicant does not have absolute proof of the correctness of the models and recognizes that many of the proposed models are not precise and some proposed models are inconsistent with other models. The Applicant recognizes that people skilled in this art may be able to show immediately that some (or all) embodiments of this invention proposed herein are partly or completely erroneous. Applicant encourages criticism of and refinements to the models. However, if the basic concept of the universe being made from plus and minus trons and nothing else turns out to be correct, it could be an important advancement in human knowledge about the universe we live in. This specification does not explain the origin of the trons. This huge question is left unanswered. And even if I am wrong about the existence of trons, the models could be useful as a very simple explanation of how the universe could be put together.

### BRIEF DESCRIPTION OF THE DRAWINGS

FIG. 1 is a representation of a proton.

FIG. 2 is a representation of a neutron.

FIG. 3A is a representation of an alpha particle minus two negatrons.

FIG. 3B is a representation of an alpha particle.

FIG. 4 is a representation of a portion of an alpha particle.

FIG. 5 is a graph of forces between particles in a nucleus based on a preferred model.

FIG. 5A shows net forces between two protons.

FIGS. 6A, B, C, D and E are drawings showing features of trons.

FIG. 7 shows a photon in flight.

FIGS. 7A, 7B, 7C and 7C show features of a photon.

FIG. 8 shows a pair production from three photons (6 trons).

FIGS. 9, 10 and 11 show electron models.

FIG. 12 shows a technique for providing a possible explanation of magnetism.

FIG. 12A shows the magnetic field surrounding the earth.

FIG. 13 shows a technique for providing a possible explanation of gravity.

FIG. 14 shows a tron pair.

FIGS. 14A, B and C show a version of pair production.

FIGS. 15A through 15L show examples of uses of embodiments of the present invention to describe various natural processes.

FIG. 16 is a proposed model of an electron.

FIGS. 17A(1) through 17B(4) show four positions of trons in a single electron cycle.

FIG. 18 is a proposed model of a proton.

FIG. 19 is a drawing showing how a neutrino passing through matter may produce gravitational effects

### DETAILED DESCRIPTION OF PREFERRED EMBODIMENTS

### The Universe may be Modeled as Nothing but a very Large Number of Plus and Minus Trons

Preferred embodiments of the present invention are based on Applicant's discovery that the universe may be modeled as completely made of nothing but a very large number of point charges each having zero mass, zero volume and a charge of about +1.6×10⁻¹⁹ Coulomb or about −1.6×10⁻¹⁹ Coulomb. Applicant calls the charges “trons.

### Trons

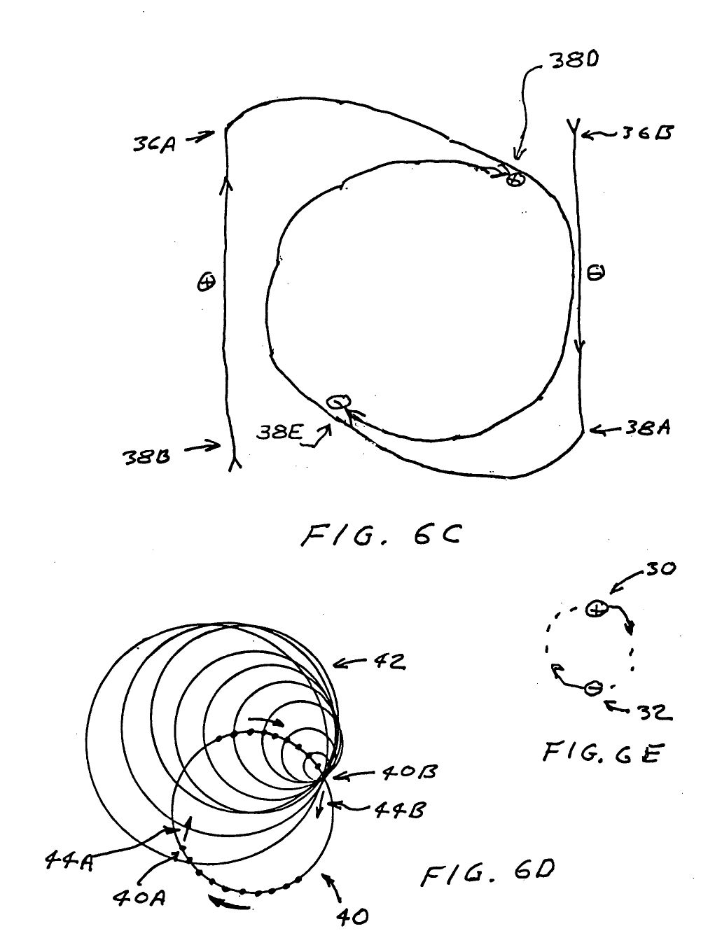

FIG. 6A is a representation of a tron according to a preferred embodiment of the present invention. The tron is designated 20. Each tron exerts attractive and repulsive force on all other trons in the universe. However, these forces do not act instantly at a distance. In this model the forces, both attractive and repulsive, travel out together from the tron at a velocity that is, in preferred models, equal to the speed of light. It is this velocity of the expanding force field that determines the speed of light which we measure. In preferred models the force field travels out from each tron in the shape of the surface of an expanding sphere which expands at a velocity of c, the vacuum speed of light. Thus, concentric circles 22 represent these force effects and each circle represents a time increment. They are shown in two dimensions but the reader should understand that the forces travel spherically. The reader should note that the tron originating this force field shown in FIG. 6A does not remain at the center of the expanding field but instead is pushed out by it. The forces exerted between two trons obey the Coulomb Law, F=q²/r², where q is the charge and r is the separation between the trons. The force is attractive if the trons have opposite signs and repulsive if they have the same sign. Trons are always in motion, each tron being pushed about by the net forces on it, including its own repulsive force and in these preferred embodiments the trons always (or almost always) travel faster than their own force field although in many cases (such as trons making up matter) they don't go very far because they travel in very, very small circles. FIG. 6B shows a tron moving at a speed of c being pushed in a straight line by its own force field. The tron at time zero (now) is shown at 24. The distance between spots on the drawing represents distance traveled in a time interval Δt. The spot 26 represents the position of the tron at t=−9Δt and the largest circle 28 represents the expanding force at t=0 resulting from forces (repulsive and attractive) emanating from the tron at t=−9. As indicated by arrows 30 the force is repelling for like trons and attractive for opposite trons. The reader should note that only nine circles are shown but the number of circles could be continued infinitely. The reader should also note that the tron being pushed by its own repulsive force exerts no force, attractive or repulsive on the upstream side of plane 34. Because it is pushed by its own force field expanding from behind, the tron normally has a large turning radius. However, when it pairs up with an opposite, it can move in extremely tight orbits as described in detail below.

### Photons

### What Happens when Opposite Trons Meet

According to this preferred model, an intersection of two opposite trons often results in the two trons circling each other. FIG. 6C is a rough depiction of two opposite trons initially traveling in approximately opposite directions, each with a speed of at least c, both travel directions being slightly inclined out of the page. The minus tron first feels the attraction of the plus tron when the plus tron is at location 36A and when the negative tron in located at 38A but the attractive force of the plus tron which the minus tron feels emanated from the plus tron when it was located at 36B. The two trons rapidly form into an approximate circle each being attracted to the other at a point back on the trail of the other. FIG. 6D depicts two trons in orbit in a circle 40 around a common center. The dots on the circle represent the trail of the two trons at nine time intervals. The position of each tron at t=0 is shown at 40A and 40B. Circles 42 show the cross section of the spherical force surfaces of the 40B tron emanating from the t=−9 position of tron 40B, and arrow 44A shows the 40A tron being attracted to the point where the tron 40 B was located at t=−9.

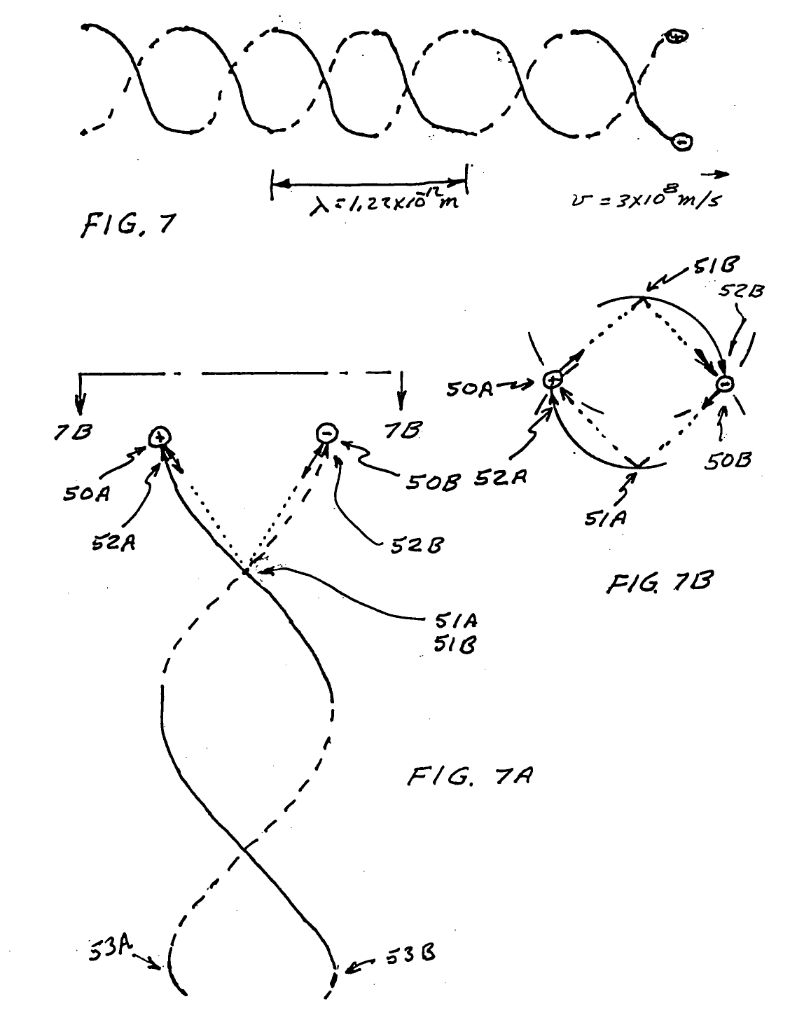

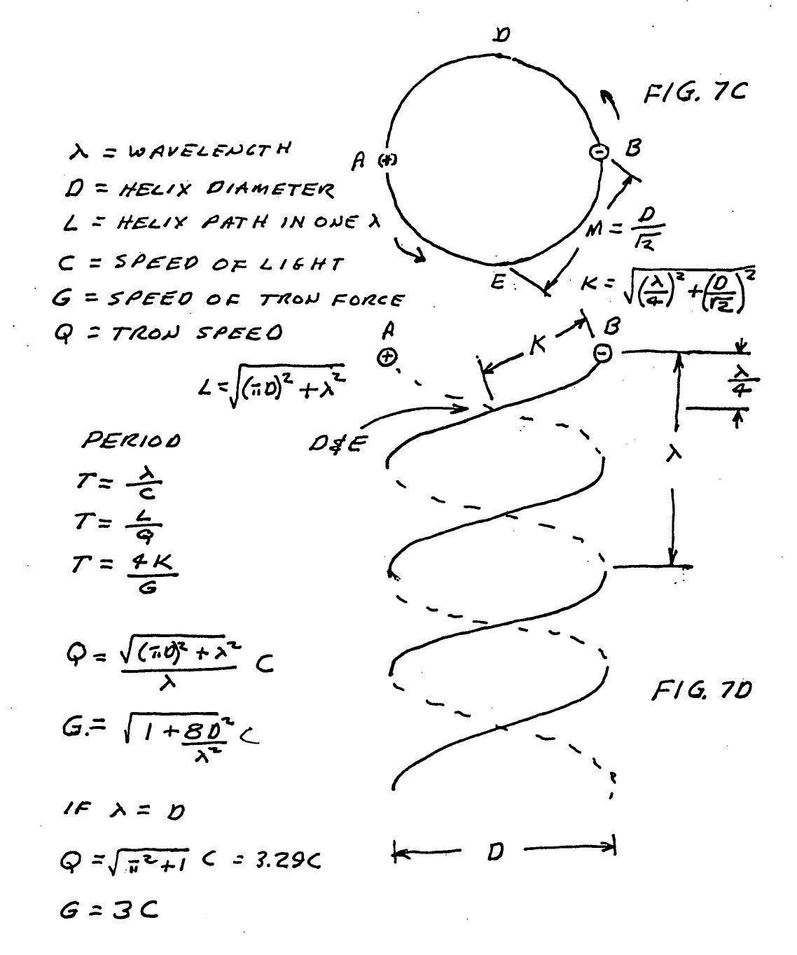

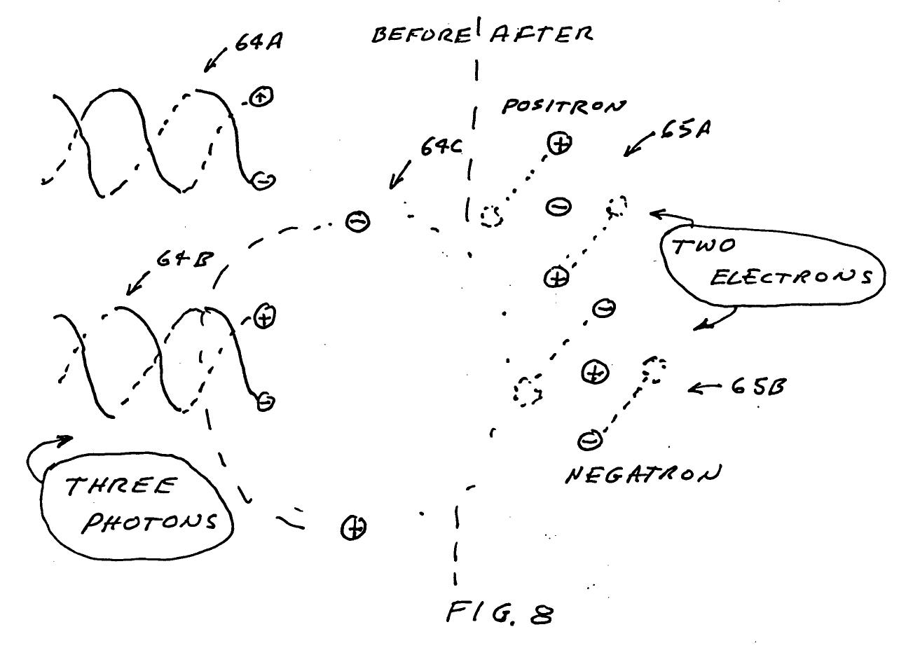

The two trons do not meet. The reason, referring back to FIG. 6C is that at location 38D the plus tron intersected its own repulsive force that flowed out from itself when it was at location 38B. This restricts the plus tron from approaching closer to the negative tron. It also applies a new force pushing the plus tron in a direction out of the page. Similarly, the minus tron at location 38E feels a repulsive force from itself forcing it to keep its distance from the plus tron and also pushing it in a direction out of the page. Thus, in this case a photon is formed. FIG. 6E is a cross section view of the photon in the plane of obit which is moving at a velocity of c. FIG. 7 shows a side view of the two trons which have just joined together to create this photon. Applicant has depicted the photon with a wavelength of λ=1.22×10⁻¹² m. Like all photons, it is moving with the speed of light, c=3×10⁸ m/s. The reader should note that if the orbit plane of the two trons has a velocity c (as it must) then each tron must be moving substantially faster than c along their helical paths. (Applicant believes but has not proven that photon formation requires force contribution from other trons in addition to the forces of the two forming trons.)

### Trons Don't Annihilate Each Other

When a positron combines with a negatron, they annihilate each other releasing photons. Plus trons and minus trons do not combine to annihilate each other. Why not? I don't know; however, here are some possible reasons: Trons are point charges with zero mass and volume and are always moving as fast or faster than the speed of light. Thus, each represents a difficult target to hit. Attractive force fields at any distance from a tron will direct an incoming tron to a point on the attracting tron's trail, and a tron does not exert an attractive force ahead of himself in his forward direction. This is because the tron is always in front of his own force field.

### The Helical Path—Old Fashion Geometry

Now we have an interesting geometry problem. This model assumes a double helical path of the two trons making up this photon. Plus, we know the speed of the orbit plane. It is c. And we are assuming for this example that we know the wavelength (e.g., λ=1.22×10⁻¹² m). However, we do not know the orbit diameter and we do not know the speed of the force field of the tron. If we knew either we could calculate the other. For example, lets refer to FIG. 7C that is a view facing an on-coming photon of wavelength λ and speed c, and FIG. 7D that is a side view of the photon showing its path for two wavelengths. Plus tron A is attracted toward location E on the trail of minus tron B and plus tron A is repelled away from location D on its own trail. Minus tron B is attracted toward location D on the trail of minus tron A and minus tron B is repelled away from location E on its own trail. Therefore, the period of the photon must be:

$$\begin{matrix}T = L / Q = \sqrt{{( π D )}^{2} + {λ}^{2}} / Q \\ T = 4 K / G = 4 \sqrt{{( \frac{λ}{4} )}^{2} + {( \frac{D}{\sqrt{2}} )}^{2}} / G \\ T = λ / c\end{matrix}$$

where: c is the speed of light, L is the distance traveled by each tron on its helical path in one period, Q is the tron speed, K is the distance between points E and B, between E and A, between D and B and between D and A, and G is the speed of the force fields expanding out from the trons. Therefore, solving for Q and G we find:

$$\begin{matrix}Q = ( \frac{\sqrt{{( π D )}^{2} + {λ}^{2}}}{λ} ) ( c ) \\ G = \sqrt{1 + \frac{8 {D}^{2}}{{λ}^{2}}} ( c )\end{matrix}$$

If we assume that D=λ, we have:

Q=\sqrt{λ²+1}(c)=3.29 c

G=3c=9×10⁸ m/s.

If D=1/2λ,

$$G = ( \sqrt{1 + \frac{2 {λ}^{2}}{{λ}^{2}}} ) C$$

G=\sqrt{3}C=1.732C

$$\begin{matrix}Q = ( \frac{\sqrt{\frac{{π}^{2}}{4}} + {λ}^{2}}{λ} ) C \\ Q = ( \sqrt{\frac{π}{4}} + 1 ) C\end{matrix}$$

Q=1.336C

Both of these calculations indicate that for this model to be correct, the tron Coulomb force must travel faster than the speed of light. The model is based on an attraction on Tron A toward location E. If the Coulomb force travels at a speed of c, then the force from E would not have arrived at Tron A's position when A got there.

### If Tron Forces Move at Speed of Light

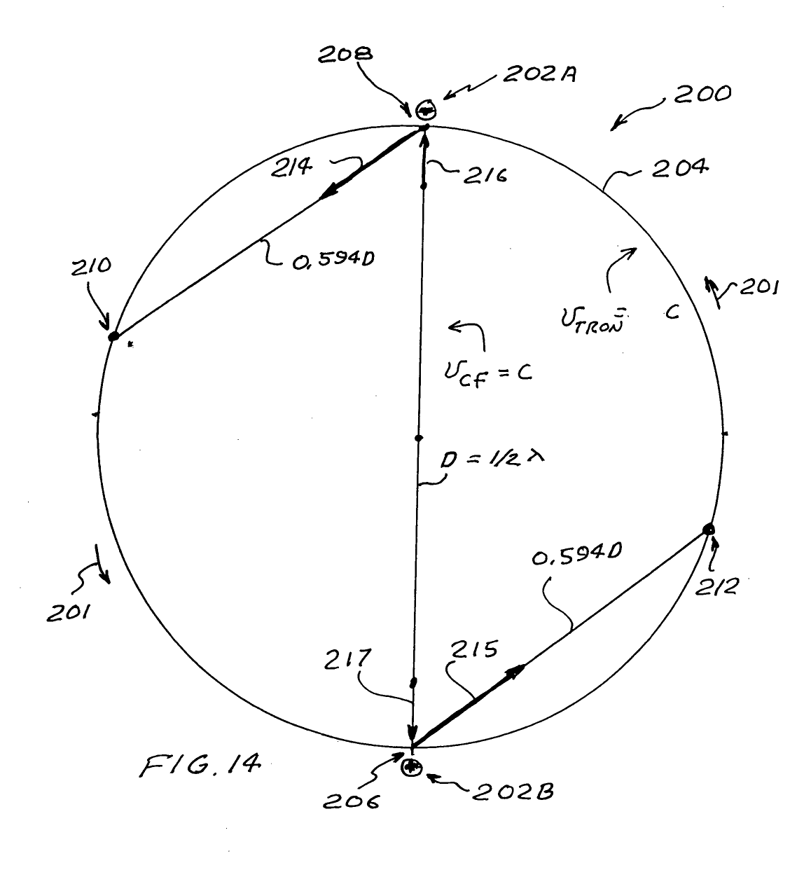

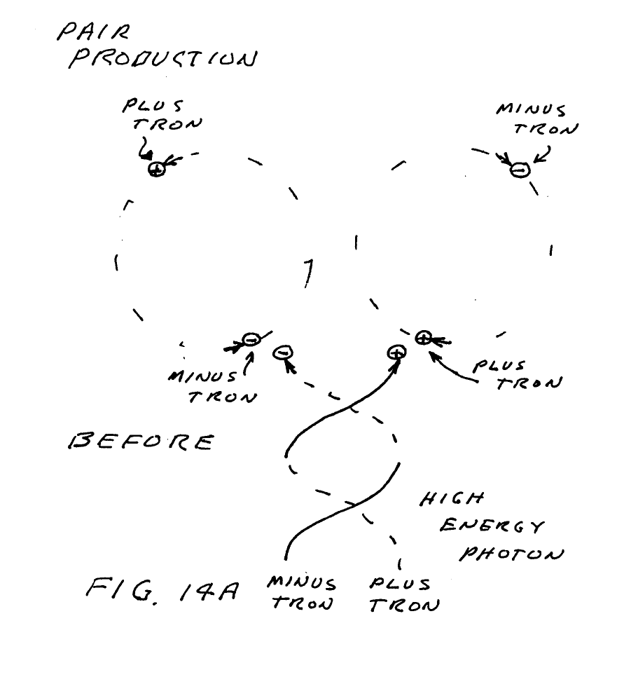

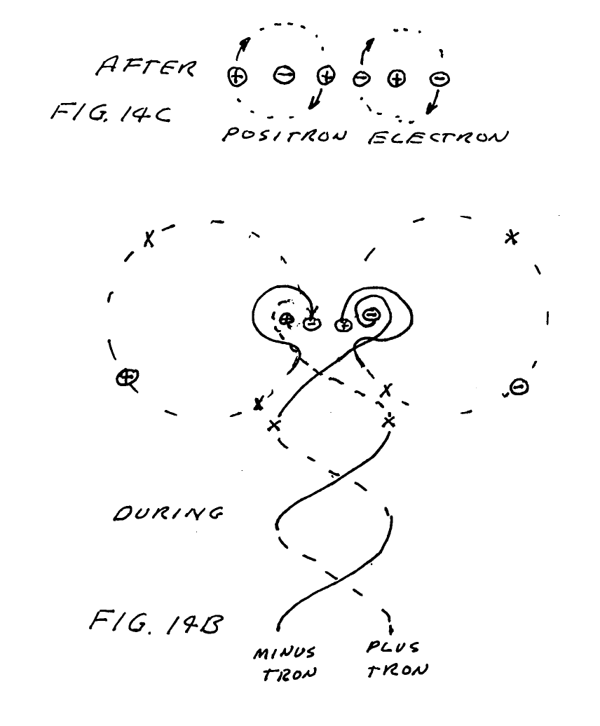

I do not know the speed of the tron force. I would like for it to be c, the speed of light. We can monitor the two trons in two frames of reference. One frame would be a reference frame moving at the speed of light with the orbit plane of the two trons. In this frame the trons circle a mid point between them which is also moving at a speed of c. The other reference frame would be in a stationary frame where we would be watching the trons pass by at the speed of light. If the trons are orbiting in a plane perpendicular to the photon direction, we would see them moving in a double helix path. FIG. 14 is a representation of a photon 200 comprised of minus tron 202A and plus tron 202B. They are traveling in a circle 204 which defines an orbit plane moving in the photon direction at the speed of light. These two trons are viewed from a reference frame moving with the photon. The diameter of the circle is D as shown in FIG. 14 that has a wavelength:

λ=2D,

where λ is the wavelength of the photon. The orbit directions of both trons are shown by arrows 201. Tron 202A is located at location 208 at time t=0. Each tron completes an orbit in time T equal to the period of the photon. Here we are assuming that the tron force travels at a speed of c; therefore, the tron repulsive force originating from tron 202A at t=−1/2T (when it was at location 206) has just reached tron 202A when tron 202A reaches location 208. Similarly, the repulsive force originating from tron 202B, at t=−1/2 T, when it was at location 208 has just reached Tron 202B when Tron 202B arrives at 206. These repulsive forces prevent the trons from coming any closer to each other than the distance D=1/2λ. At time −0.297T, tron 202B was located at location 210 and tron 202A was located at location 212. The attractive forces leaving from tron 202B at t=−0.297 arrives at location 208 at the same time tron 202A arrives at that location and at the same time its own repulsive force from position 206 arrives at location 206. That force 214 from tron 202B together with the repulsive force 216 from itself keeps tron 202A in its circular orbit. Similarly, the attractive forces leaving from tron 202A at t=−0.297 arrives at location 206 at the same time tron 202B arrives at that location. That force 215 from tron 202A together with the repulsive force 217 from itself keeps tron 202B in its circular orbit.

We are aware that our space ship is traveling at the speed of light in the photon direction. We are also aware that repulsive forces of each of the trons travel at the speed of light. Therefore, we are able to understand that the two trons are traveling in a double helix path and that the repulsive force of each tron from time −T (one period, see side view FIG. 7) pushes each of the trons forward in the direction of the space ship at the speed of c.

We recognize that this photon model could be challenged on at least two points. First the Coulomb attractive force 214 on tron 202A from tron 202B at location 210 is much stronger than the repulsive force 216 from itself at location 206; therefore, one might draw the conclusion that the two trons should spiral in toward each other. However, if 202A were to spiral closer it would be out of synchronization with its partner 202B and would feel no attractive force from from it. Since the attractive force from tron 202B is expanding outward at the speed of light, tron 202A must stay in precisely the correct position to remain attracted. Thus, the equilibrium direction for tron 202A is tangent to circle 204.

A second potential discrepancy is this: If minus tron 202A's own repulsive force from a position on its trail one wavelength back is pushing tron 202A forward at the speed of light, why isn't the attractive force from tron 202B one-half wavelength back pulling tron 202A backward toward the minus ½T position of tron 202B? The answer may be like the above answer. There would be no attractive force if tron 202A were pulled back out of synchronization. Another way to look at this problem is to realize that both attractive and repulsive forces are flowing away from these earlier tron positions; therefore, for the forces to be effective on a thing that thing needs to stay with the flow. This does not sound very scientific and I'm sure that if I am generally correct with this model, others will develop better explanations.

As suggested by the above I am not certain of the speed of the tron force. I think it is c but it may be somewhat greater than c. It must be at least c. A possible configuration may be that shown in FIGS. 7E and 7F. Here I am assuming that the force travels out from the trons at a velocity somewhat greater than the speed of light. Thus, the force from tron 202B travels from point 208 to apply a repulsive force 209 on itself (tron 202B). The force's spherical surface is shown at 209A. This shows that the force is traveling slightly faster than the photon in its double helical path. Tron 202A applies an attractive force 211 on tron 202B from its position at 210.

### How Can Photons Stop on a Dime? and Reverse Directions in an Instant?

The two attractive forces which I referred to in the previous section sort of disrupts the logic of my explanation as to how the photon pushes itself through the universe. And I admitted that my explanation seems a little weak. However, these two attractive forces one half wave-length back of the two trons may be the reason the photon can fly through space for a billion years at the speed of light then stop on a dime when it encounters matter (as when absorbed) or reverse directions in an instant when it is reflected (such as from a mirror) and head back across the universe.

### Absorption, Transmission and Reflection

When photons intersect with an object they either pass through, get absorbed in it or are reflected. In case of transmission and reflection the wavelength is the same out as in; therefore, there can be no loss of energy. Often the photon is absorbed in the object. In prior art analyses the photon is considered to be a bundle of energy with no charge and in the case of absorption the energy of the photon is assumed to have raised an electron in an atom to an excited state. The prior art explains that when the electron returns to its ground state through one or more jumps it creates photons and they fly out at the speed of light. The prior art does not have a good explanation as to how the atom or the electron is able to create these photons. In the present model a photon (i.e., the two orbiting charges) may be captured by an electron, an atom or a molecule. The photon's forward motion is stopped but the two charges continue to orbit at the same frequency while at the same time being held in a dynamic Coulomb force well in or around the electron, the atom or the molecule. This would represent an excited state of the atom. The lifetimes of these excited states are normally very short. In many cases of absorption, the photon loses it shape (i.e. its frequency) but the two trons remain temporally attached to the atom making the atom more excited than it was, raising the temperature of the absorbing thing.

In fact (as explained above) the model contemplates that in atomic and molecular structures a very large number of trons are temporally captured and that they represent heat; and the trons may creep out as conducting heat or they may form into thermal photons that radiate out as thermal radiation. Normally, this thermal radiation is at a lower frequency.

### Photon Models

Applicant has constructed photon models such as described in FIGS. 7A, 7B and FIG. 14 using cardboard toilet paper mandrels and also with Plexiglas tubes, string and rods. Persons skilled in computer programming could easily create 3-dimensional computer models of the photon including dynamic models in which the tron charges propel themselves (in very slow motion) at a speed representing their actual speed in excess of the speed of light. In these 3-dimensional models the trons could be simulated with the tron specifications given above and initially given random or other forms of motion and allowed to form themselves into photons, electrons or more complicated particles.

### The Shape of the Orbits—Polarized Light

In the preferred model discussed above, the orbit of the two-tron photon is circular, but the shape of the orbit might possibly also be modeled as elliptical with the circular orbit as a special case. Potential shapes could possibly include an extremely elliptical orbit, almost linear or linear. In a new model polarized light is modeled as two trons moving in a plane parallel to the photon direction and oscillating along a line moving perpendicular to the photon direction. A side view of this polarized photon would show each of the trons following a sin shaped path which cross twice each cycle. This may be what perfectly polarized light looks like, but Applicant thinks all photons normally have circular orbits. The present invention on this issue is flexible. Perhaps some smart reader of this specification will be able to determine whether the orbits must be circular or that the circular orbits are merely a special case.

### Creation of Mass (Energy)

In preferred embodiments of the present invention, the entire universe is built up with building blocks consisting of only plus and minus trons, neither of which has any mass. So, where does the mass come from? Mass is a measure of inertia of a thing; i.e., its ability to resist forces. A tron exerts forces on other trons (the Coulomb force attracts or repulses) but a tron provides no resistance to forces exerted on it so long as the forces are not in conflict. It has no mass so it is pushed or pulled at the speed and in the direction of any forces applied to it. A tron can move freely in three directions totally without resistance no matter how small or large the force; however, the tron may acquire mass once it is subjected to forces on it directed in more than three directions. Thus, when three forces are applied to a tron in different directions it can merely move in a three dimensional space in response to all three forces without providing any resistance to any of these forces. If a fourth force is exerted on the tron it must resist at least one of the four forces. Thus, the mass-less tron suddenly has a mass! And therefore energy! The two mass-less trons comprising a photon are each subjected to at least two continuous forces according to the model shown in FIGS. 7A, 7B, 7C, 7D and 14. Thus, a photon traveling through space has no mass; however, when a photon encounters matter with its many Coulomb forces the photon displays mass. This mass may also be analyzed as energy. When the photon is absorbed its “mass/energy” is added to the thing that absorbed it and the photon thus increases the mass of the absorbing thing.

### Forces between Trons

If the models described herein are basically correct, they infer enormous forces between trons in the various configurations discussed. We know that a proton has an effective size of about 10⁻¹⁵ m. One model proposes that a proton is comprised of five electrons. As described in detail later I have estimated the radius of the orbits of two of the proton's electrons at 3×10⁻¹⁸ m. Therefore, the size of electrons must be much smaller than 3×10⁻¹⁸ m. If we assume that the three trons making up an electron are spaced apart by 10⁻¹⁸ m then the forces between them are in the range of 2.3×10⁸ N. If they are spaced apart by 10⁻¹⁹ m, then the forces between them are in the range of 2.3×10¹⁰ N. A force of 10⁹ N is equivalent to about 2.2×10⁸ pounds or 220 million pounds!

Similarly, the two trons in a high energy photon such as the highest energy gamma rays may be spaced at 10⁻¹⁶ m in the double helix model of the photon so the forces between them would be in the range of a few thousand pounds. A gamma ray with the minimum energy needed to make a pair of electrons has its two trons spaced at about 1.2×10⁻¹² m, so the forces here are about 2×10⁻⁶ N or less than one millionth of a pound. The trons of a mid-range X-ray are spaced apart by about 10⁻¹⁰ m, so the forces between then are in the range of about 2×10⁻⁹ N. The trons of visible light are spaced at about 0.6×10⁻⁶ m, so the forces between them are only about 6.4×10⁻¹⁶ N and thermal radiation photons at about 20 degrees C. have wavelengths of about 10×10⁻⁶ m so the forces here are somewhat smaller than for visible light. OK, but what about much longer wavelengths. The photons of radio waves have wavelengths in the range of meters to hundreds of meters. I am not certain that radio waves fit my models of photons, but I believe they do. For a photon with a 10 m wavelength, the force acting between the trons would be about 2×10⁻³⁰ N in the double helix model. With this small force it seems hard to believe that the photon would hold together. However, we should keep in mind that the photon is moving very fast and each tron of this 10-m photon is moving faster than the speed of light and completes a cycle several million times per second! It may be that these extremely weak forces between the two trons in synchronization with each other are more important in controlling their speed and direction as they whip through the universe than all of the other forces in the universe that act upon them. Man-made radio waves are generally polarized. Therefore, these radio wave photons may map out crisscrossing sin paths as they travel through space

### Is Our Model Consistent with Our Knowledge about Photons?

Since it represents the most basic concepts of nature, all presently known accurate physics principals must be derivable from it. We know that some things we know about photons are consistent with the model because the model was developed based on the knowledge. These include:

1) The size of the photon of the preferred models (for example an orbit diameter of one half the wavelength of the light the photon is part of) seems consistent with how closely we can focus light of various wavelengths.

2) We know that photons have no apparent charge, but photons are known to interact with matter having charges. These features are consistent with the present model where each photon has two charges of opposite sign and at distances substantially greater than the orbit diameters will cancel each other so that the photon appears to have no charge.

3) The photon has energy equal to a constant (Plank's constant) times the frequency. If a photon had a length how long would it be? One wavelength? Six wavelengths?) This model avoids the problem by saying that the photon does not have a length. It travels in a plane perpendicular to the photon direction. The only thing it has is charge and frequency (and a corresponding wavelength) and a speed. Its frequency determines its energy.

4) Each photon has an equivalent mass (or energy) that is proportional to its frequency. If the photon is moving at the speed of light and vibrating with a frequency, then parts of it must be moving faster than the speed of light which is suppose to be impossible. How can that be? This model provides an answer. It says the trons have no mass and so they may move faster than the speed of light. Our orbiting or oscillating trons create the photon's mass! Therefore, our model is consistent with known fact that the photon energy (or mass) is proportional to its frequency.

5) There never has been a good explanation as to how electricity could travel in a copper wire at a large fraction of the speed of light when it is known that the electrons travel in conductors at speeds of only a few meters or centimeters per second. Holes (whatever they are supposed to be) are thought to travel even more slowly. This model says the trons are what travel at a substantial fraction of 3×10⁸ m/s. The trons with zero mass can carry a charge at almost light speed through a copper wire. Thus, this model is consistent with our knowledge of electric current flow.

6) In a laser, a gain medium is created in excited atoms or molecules. This model explains that the gain medium is comprised of temporally captured photons (i.e., the two oppositely charged trons continue to orbit each other but instead of being pushed forward by their own charges, they are both held in orbit (around an electron or around or inside an atom or molecule) by the forces there which overcome the photon's own driving forces). The stream of laser photons passing by applies forces which tend to orient the orbits of the two trons in the direction of the laser beam. A slight hiccup in the “excited” atom or molecule releases the photon to join the laser beam.

7) These captured photons or tron pairs are responsible for spectral lines. Each atom and molecule due to its own basic configuration of protons neutrons and electrons with their combined huge number of rotating coulomb forces invite photons orbiting at specific frequencies to become associated. This is why photons of specific frequencies (or wavelengths) are resonantly captured. The photon may remain associated with the atom or molecule for microseconds, years or centuries but may at any time be ejected (especially if the atom or molecule is heated) as a photon resulting in spectral lines, which we can measure.

8) Pursuant to preferred Ross photon models, trons orbit is planes perpendicular to the photon direction of travel. This is consistent experimental evidence that the rotation axis of each photon is parallel to the photon direction of travel. This is also true for neutrinos, which in preferred models is nothing but a high energy photon.

All of the hundreds of well established physics and optical features of photons will need to be successfully tested against this model of the photon if the model is to have general acceptance. It may be that photons can move in many patterns and modes similar to the many modes in which microwave light can travel in a waveguide.

### Electrons

### Electron Models

Continuing my effort to describe a simple universe, I have developed an electron (positron and negatron) models similar to the photon model described above and similar to the proton-neutron model described in the original parent application (to this continuation-in-part) i.e., Ser. No. 09/908,297, submitted Jul. 17, 2001. My first electron model was described in an application filed Jun. 3, 2002. Whereas, protons and neutrons were made of positrons and negatrons, I developed a model for the construction of electrons (positrons and negatrons) from the same things that make up photons, i.e., trons. Therefore, as described in the summary to this specification, everything in the universe is made of trons—and I mean everything! Everything from the light we see, the warmth we feel, our thoughts and our memories, the nuclei and electrons of all of the atoms in our bodies and in our galaxy and in all of the galaxies in the universe and the universe itself—all made from combinations of two tiny massless charges—amazing! But back to electrons.

For many years scientists have known that high-energy photons interacting with matter can produce positrons and negatrons. This is called pair production. Also, it is well known that positrons and negatrons will annihilate each other producing “two” high-energy photons. Thus, photons make positrons and electrons, and positrons and electrons make photons. After reading this specification, one might think that it should have been obvious that given pair production and positron-negatron annihilation that electrons and photons must be comprised of the same ingredients. However, I have not seen that simple concept suggested in any of the 20 to 30 physics books that I have studied recently.

FIG. 8 shows three photons 64A, 64B and 64C combining to form a positron 65A and a negatron 65B. The vertical dashed line separates the before and after. The Applicant is far from certain exactly how these combinations takes place. According to these preferred models of electron formation all of the trons are moving faster than the speed of light before and after the formation of the electrons. Electron models are shown in FIGS. 8, 9, 10, 16 and 17A(1) through 17B(4). My first electron model is described below with reference to FIGS. 8, 9 and 10.

### Descriptive Models

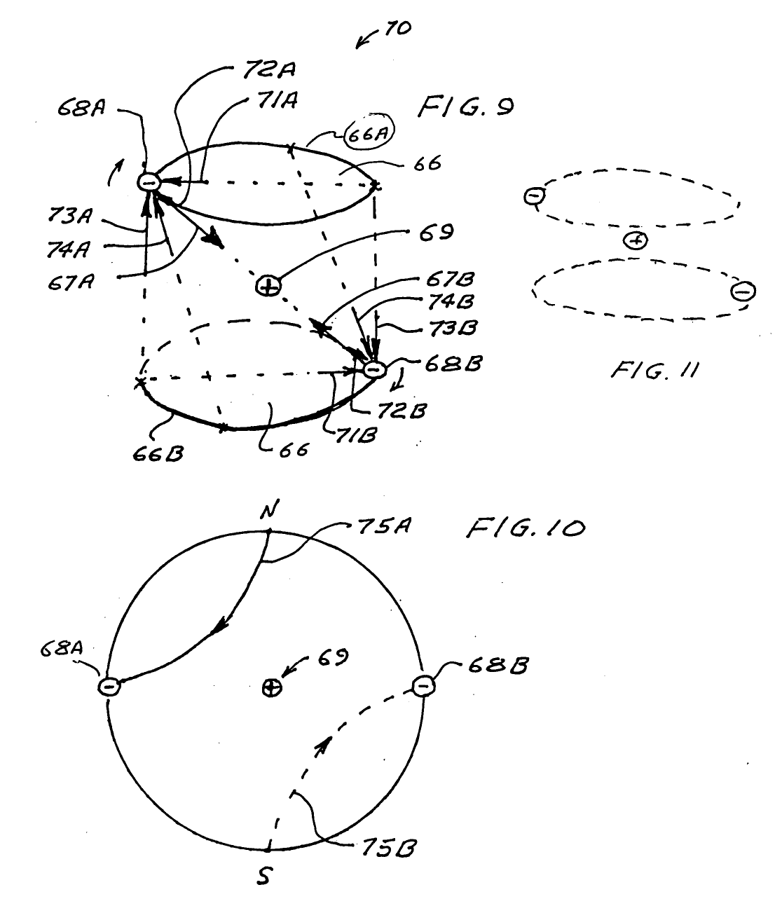

FIG. 9 is a drawing of an electron according to my first electron model. It is a drawing of a model of a negative electron 70 made by Applicant out of Plexiglas, tape and cord and 3/16 inch diameter wooden dowel rods. The cord was glued to two Plexiglas sheets 66 to represent tron orbits 66A and 66B. The dowel rods were used to represent Coulomb forces and their directions. Colored tape wound in the shape of balls was used to represent the trons. The forces are as follows: Attractive forces 67A and B are pulling the two orbiting negative trons 68A and 68B toward positive tron 69 in the center of the electron 70. Repulsive forces 71A, 71B, 73A, 73B, 74A and 74B combine to counteract attractive forces 67A and 67B and to push the negative trons in their orbits. Forces 72A and 72B (each negative tron's own repulsive force, pushing at the speed of light and coming from immediately behind) prevent the orbiting trons from moving at less than the speed of light. Since both negative trons are traveling faster in their orbits than the speed of their expanding force fields, they are affected by their own repulsive forces from various points in their past where the repulsive forces moving more slowly (at an estimated speed of c) intersect them on their circular orbits. Each orbiting tron is also affected by the repulsive forces of the other orbiting tron also moving at the same speed in synchrony on the opposite side of electron 70. These forces are also moving at c and so the forces felt appear to come from the trail of the other orbiting tron rather than the tron itself. The resulting forces push the orbiting trons endlessly along their path about the center tron. The paths in this model form perfect circles on an imaginary surface of an imaginary sphere. But the diameters of the circles are smaller than the diameter of the imaginary sphere. For example, if you think of the electron as a small Earth, and the two orbiting trons were orbiting along the equator; the subsequent path of one of the trons would follow a circular great circle route 75A over the north-pole and the other tron would follow a circular great circle route 75B over the south-pole. These routes are shown in FIG. 10. The two arcs show the immediately preceding half circle for each Tron. The path of tron 68A was on the front of the sphere and the path of tron 68B (shown dashed) was on the back half of the sphere. The central tron 69 is located approximately in the center of the sphere being attracted by equal and opposite attractive forces from the trails of the orbiting trons. In one model the central tron is virtually stationary in the center of the electron. In another model the central tron is allowed to orbit in an extremely tight orbit at speeds equal to or greater than c being pushed by its own repulsive force and pulled by forces coming from the trails of the two orbiting trons.

This model of the electron provides an explanation as to why the electron is so stable. I have not yet been able to figure out the radius of the electron, but I believe its radius should be easy to figure out by people with a little better grasp of geometry and forces in motion than I have. My model tells us, however, that it must be much smaller than the proton that has a diameter of about 10⁻¹⁵ m and I understand experiments indicate that the electron is smaller than 10⁻¹⁶ m. My guess is that the radius is less than 5×10⁻¹⁹ m. This means that the forces holding the electron together and keeping it from collapsing may be millions or billions of Newtons! This is the answer to Professor Feynman's question referred to in the Background section relating to why the electron does not tear itself apart. Coulomb forces hold the electron together. They also prevent it from closing in on itself. As stable as an electron is, it is easily annihilated and converted into photons by combining with an opposite electron. My models thus provides a good explanation for the stability of electrons and the ease of their annihilation.

### New Electron Model

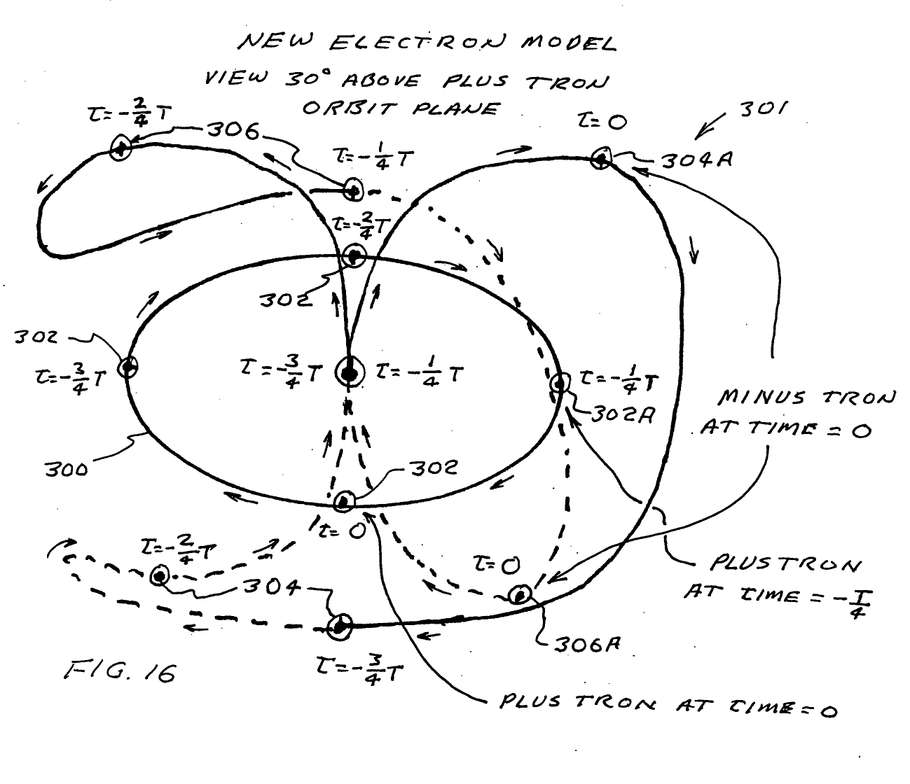

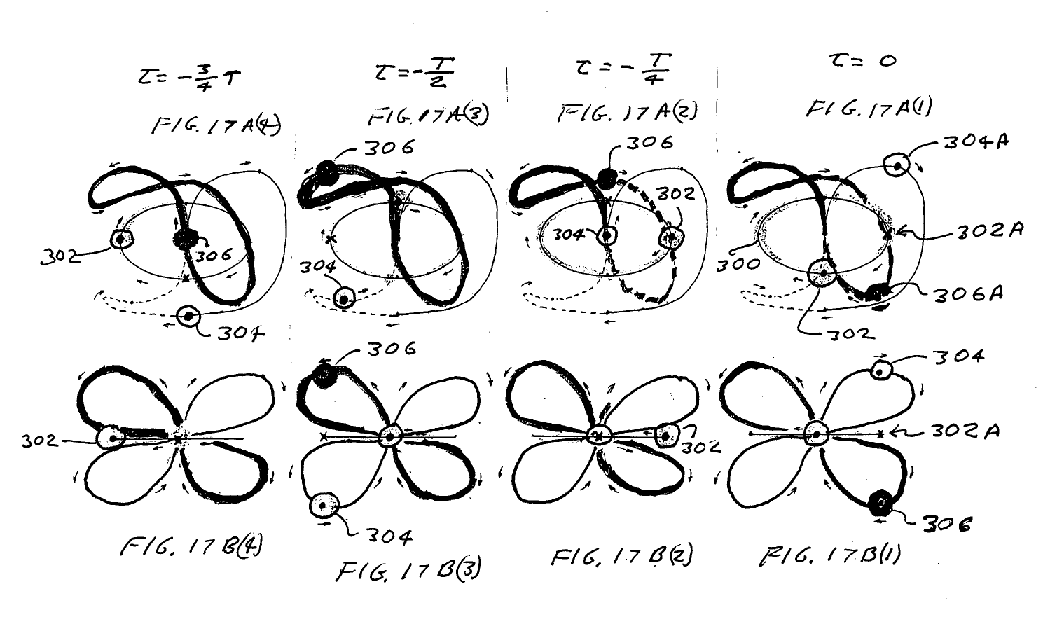

One problem with the electron model shown in FIGS. 9 and 10 and 15A and B is that the tron in the center appears to be at rest or is required to move at speeds of c in an extremely small space. A new electron model therefore is proposed and is described by reference to FIGS. 16 and 17A(1) through 17B(4). I will describe a negatron but the reader should understand that the explanation will also apply to the positron if the charge of the trons are reversed.

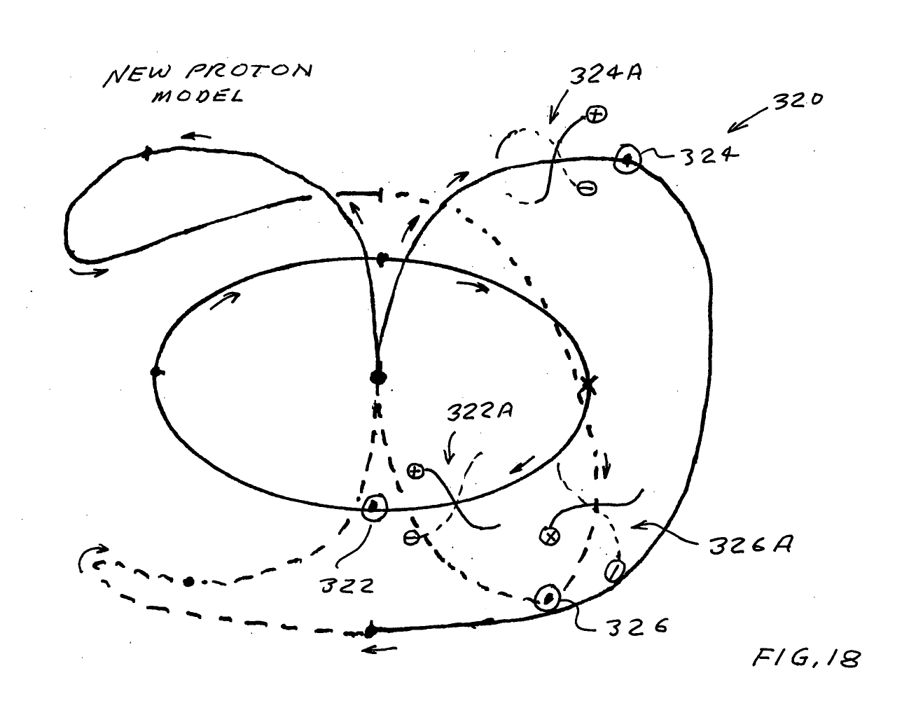

The at rest negatron like the ones in the parent applications are comprised of one plus tron 302 which follows a circular path 300 as shown in FIG. 16. The diameter of the path is D and the magnitude of D is not known but is very very small. The velocity of the plus tron in its circular path is 7 cc/2, or about 1.57c, where c is the speed of light. The trons each make a complete loop in time t=T, the period which is one frequency of the negatron. The positions of plus tron 302 at t=0, T/4, 2T/4, and 3T/4 are shown in FIG. 18. FIG. 16 is a prospective view of the negatron viewed at 30 degrees above the plane of the plus tron circular path. Two minus trons 304 and 306 orbit around the −T/4 position of plus tron 302 on the trail of plus tron 302. This −T/4 position of plus tron 302 is shown on FIGS. 16, 17A(1) and 17B(2) at 302A. The position of trons 304 and 306 at time t=0 are shown at 304A and 306A, respectively in the same figures. Earlier positions at t=−T/4, −2T/4 and −3T/4 are also shown in FIG. 16. Minus trons 304 and 306 complete a loop in the same time period T as plus tron 302 but travel farther and faster than plus tron 302. Their path is at a distance of ½D from the position on the path of tron 302 that is T/4 behind tron 302, and a straight line between them at any time makes a perpendicular intersection with the path of tron 302 at the −¼T position of Tron 302. I have not figured out exactly the path length of trons 304 and 306 relative to the path of tron 302 but I did measure it from a crude model I constructed and my measurements indicate a one period loop distance of about 5D for each of trons 304 and 306 compared to a one loop path distance for tron 302 of πD, where D is the diameter of the 302 loop. So trons 304 and 306 travel resonantly with tron 302 and must travel about 1.6 times faster and farther than tron 302.

FIGS. 17A(4), A(3), A(2) and A(1) show additional prospective views of the FIG. 16 negatron at t=−3T/4, −2T/4, −T/4 and 0, respectively. FIGS. 17A(4), B(3), C(2) and D(1) show a front view of the negatron at these same times. As indicated above the position description is exactly the same as the negatron description except tron 302 would be a minus tron and trons 304 and 306 would be plus trons.

### Electron Mass

According to Professor Einstein mass and energy are equivalent and the energy/mass of an object such as an electron is:

$$E = \frac{{m}_{0} {c}^{2}}{\sqrt{1 - {( \frac{v}{c} )}^{2}}}$$

Where E is an objects total energy, v is its relative velocity, m₀ is its rest mass and c is the speed of light. The numerator m₀c² is referred to as the object's rest energy and the denominator demonstrtes how the energy increases with the object's velocity. As explained above a tron has no mass and prvides no resistance to Coulomb forces; however, when three trons join together in a negatron or a positron the combination does display a mass equal to 9.11×10⁻³¹ kg if the combination is at rest. The trons making up the electron can no longer move away with an expanding Coulomb force field at the speed of light or greater because each tron is bound tightly with tremendous forces to the other two trons in the electron. Thus, the electron responds to outside Coulomb forces as a unit in accordance with F=ma.

### Massive Electrons

As indicated by the first equation in the above section, the mass of an object such as an electron approaches infinity as v approaches c. As described below Applicant has used this relationship as an explanation as to how a proton made from only five electrons can have a mass which is heaver by a factor of 1,836 than a single electron at rest. He did it be using Einstein's formula to show that at a velocity of 0.9999994c the mass of an electron increases about 900 times.

### Can Captured Photons Explain Increased Mass of High Speed Things?

In some preferred models described in this specification, photons can be captured by an electron. These models propose that the captured photons produce a driving force that propels the electron. This captured photon represents mass according to E=hc/λ. (The shorter the wavelength of the photon the greater the energy/mass. A photon having a mass/energy equal to 900 times the mass of an electron at rest would have a wavelength of about 2.7×10⁻¹⁵ m. This would be a very energetic photon. (Interestingly, its orbit diameter [at ½ the photon wavelength, which is Applicant's preferred photon orbit diameter] would be about the size of a proton.) On typical charts of the electromagnetic spectrum, gamma rays have wavelengths in the range of about 7×10⁻⁹ m to 1×10⁻¹⁴ m. My chart indicates that some cosmic rays have shorter wavelengths. The question that is raised by this example is the one which is posed as the title to this section. Can captured photons explain increased mass of things such as electrons as they approach the speed of light? The example is based on a single very high energy photon; however, two photons, B and C at half the frequency of photon A would represent the same mass/energy as photon A. Models proposed in this specifications suggest that an electron could capture and be propelled forward by several captured photons. If capture photons are the force that makes objects go fast, then according to models proposed herein, no object having mass could go faster than the speed of light, no matter how many photons were captured and no matter how short the wavelengths of the photons. (This is just another small example showing how the models described herein are consistant with prior experimental data.)

### Where Have All the Positrons Gone?

Positrons are rare birds. We do not see many of them. That is because on earth once produced they almost immediately are attracted to an electron and the two are annihilated. If electrons are produced in pairs in pair production by high-energy photons, and also annihilated in pairs, then there should be an equal number of negatrons and positrons in the universe. In my model there is. The missing positrons are contained in protons and neutrons. This leads us to my preferred model of the proton that was described fairly well by me in my patent application Ser. No. 09/908,297 filed in July 2001.

### Protons and Neutrons

### Protons and Neutrons are Made of Positrons and Negatrons

In the oldest parent to this Application (recently published as an application by the US Patent and Trademark Office), Applicant speculated that all the matter in the known universe can logically be described as being comprised of nothing more than electrons (i.e., positrons and negatrons), the negatron having a negative charge −e and the positron having a positive charge of +e, and that the only forces acting in the universe is the electrical forces described by Coulomb's Law, i.e.:

$$F \approx \frac{{q}_{1} {q}_{2}}{{r}^{2}}$$

In that parent case I speculated that, “[E]verything in the universe is comprised of combinations of these two simple point-like charges most of which were created in equal number at the time of the “Big Bang” from the electromagnetic energy released in that event.” (Now I speculate that electrons, along with everything else [including photons and neutrinos] are made of trons; therefore, everything is made of trons.) Protons and neutrons are comprised of positrons and negatrons (with possibly some neutrinos) but not quarks. Atomic nuclei are made up of protons and neutrons. There is no strong force other than the Coulomb force, which by the way is extremely strong at the distances we are talking about.

One possible model of a proton (my first attempt at a proton description) is a five-electron; i.e., a combination of three positrons and two negatrons in which two negatrons are orbiting a positron (or possibly merely a plus tron) at velocities very close to the speed of light and two additional positrons orbit the central three-some further out to define the size of the proton. The Coulomb force holds the positrons and negatrons of the nucleus together and the Coulomb force (possibly with the help of centripetal forces) kept the particles appropriately separated. My more recent model is a three-electron model where the negatron follows a circular path and two positrons orbit around the path.

### The Proton

### (Five-Electron Proton Model)

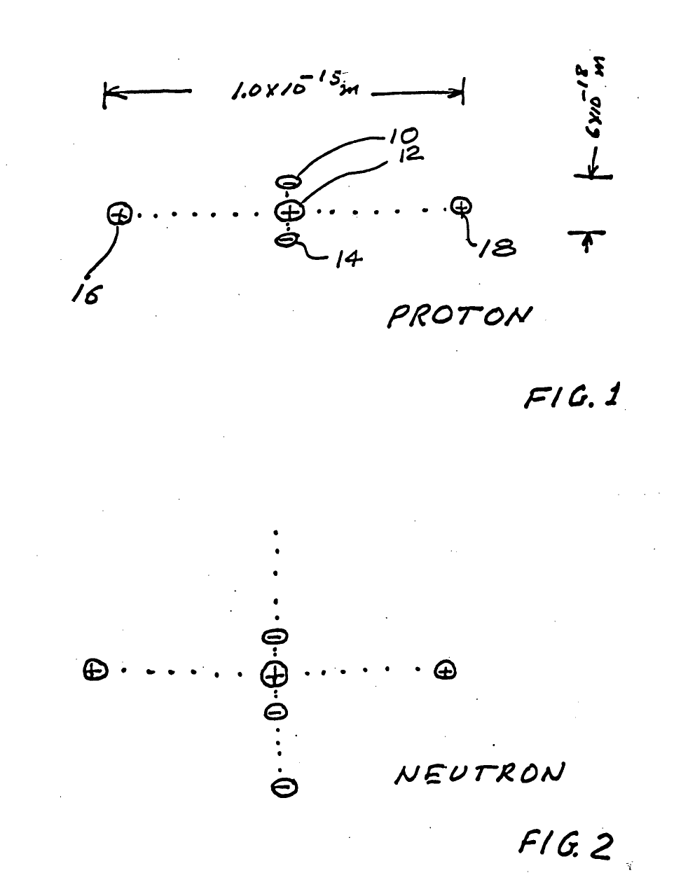

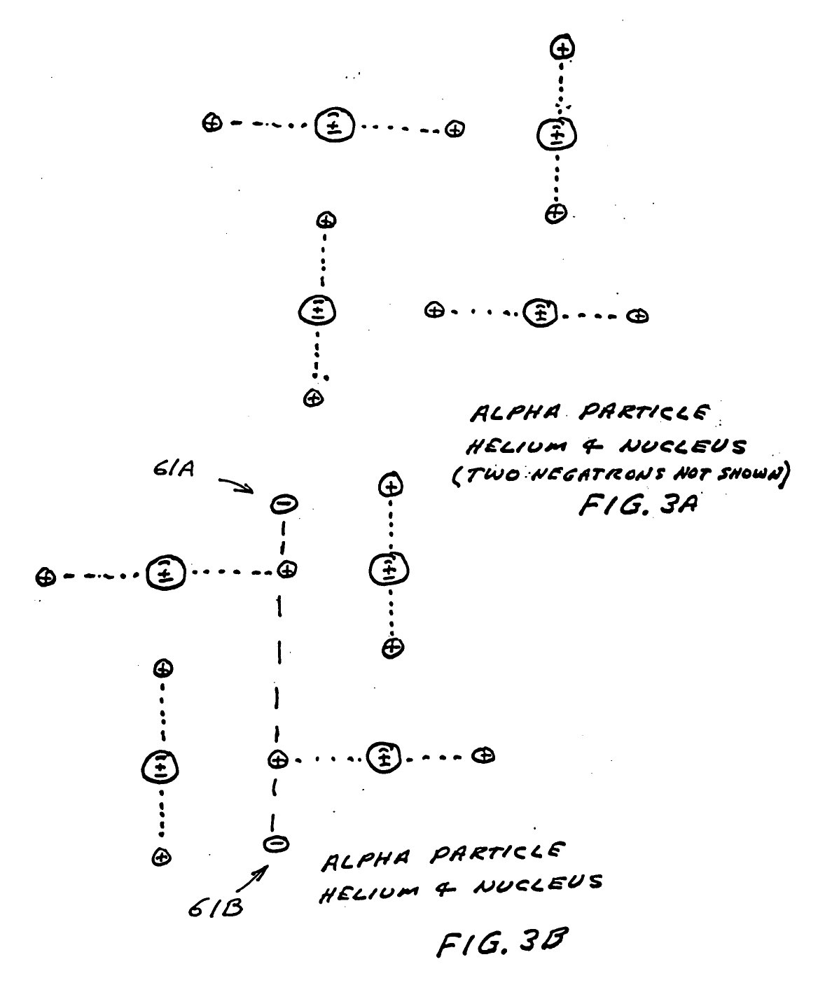

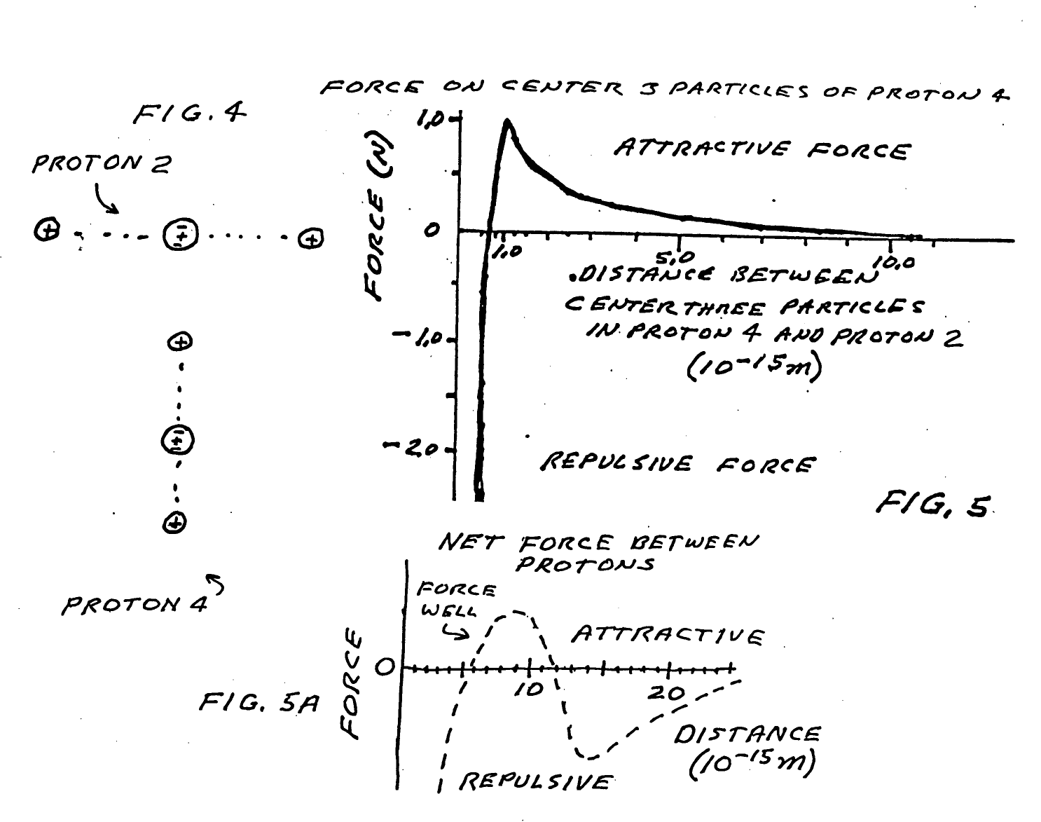

My first proton model was comprised of a central three-some consisting of a single positron orbited by two negatrons at extremely large velocities with two more positrons orbiting the central three-some, all as shown in FIG. 1. A neutron had the same general structure as a proton, but an additional electron (as shown in FIG. 2) orbits the two negatrons and three positrons. In the nucleus the neutron's extra electrons was probably shared so that protons and neutrons were probably not distinguishable in the nucleus. As stated in the Background section, it is known that the electron has a rest mass of about 9.1×10⁻³¹ kg and the reported mass of a proton is about 1.6731×10⁻²⁷ kg and the reported mass of a neutron is about 1.6754×10⁻²⁷ kg.

### Two Very Fast Moving Negatrons

Most of the apparent mass of the proton and the neutron would be accounted for by the two negatrons which are orbiting the center position at a radius of about 3×10⁻¹⁸ m and at a velocity almost equal to the speed of light, i.e., an orbit velocity of about 0.9999994 C which gives each of them an apparent mass of about one half the reported mass of a proton and about one half the mass of a neutron.

### Centripetal Force

To estimate the radius of the orbit of one of these two negatrons 10 orbiting positron 12 as shown in FIG. 1, we equate the electrostatic attractive force between the positron and the negatron which is:

$$F = \frac{{q}_{1} {q}_{2}}{4 π {ϵ}_{0} {r}^{2}}$$

and the centripetal force of the very fast orbiting negatron which is:

$$F = \frac{m {v}^{2}}{r}$$

Thus we obtain a rough estimate of r as:

$$r = \frac{{q}^{2}}{4 π {ϵ}_{0} m {v}^{2}}$$

Since m=½×1.67×10⁻²⁷ kg=0.835×10⁻²⁷ kg,

q=1.6×10⁻¹⁹C

v=0.9999994C, and

1/4πe₀=9.0×10⁹ Nm²/C²:

r=3×10⁻⁸ m.

At this radius the Coulomb attractive forces between the orbiting negatron and the central positron is enormous:

$$F = \frac{{q}_{1} {q}_{2}}{4 π {ϵ}_{0} {r}^{2}}$$

$$F = 2.5 \times {10}^{7} N$$

The centripetal force is the same:

$$F = \frac{m {v}^{2}}{r}$$

$$F = 2.5 \times {10}^{7} N$$

These calculations are very rough and only produce a general rough approximation of forces and distances. In the above calculations, I have neglected the Coulomb effects of the second negatron 14 also orbiting the center positron. It has the same velocity as negatron 10 and the forces on negatron are the same as the forces on negatron 14. Negatrons 10 and 14, as they are attracted to positron 12 are repelled by each other with a force of about:

$$F = \frac{{q}_{1} {q}_{2}}{4 π {ϵ}_{0} {r}_{2}^{2}}$$

where r₂ is effective separation of negatrons 10 and 14. A force calculation based of a separation between the two negatrons of about 6×10⁻¹⁸ m would produce a repelling force of about 0.64×10⁷ N. However, both are moving at almost the speed of light. Thus, the Coulomb force exerted by each negatron on each other should be somewhat greater than this since each negatron sees the other as being significantly closer than it really is. The faster the negatrons travel the closer the negatron on the opposite side of their orbit appears.

Thus, the two negatrons orbiting the center positron are repelled by each other with a force equal to at least 25 percent of the attractive force exerted by the positron on the two negatrons. It is this repelling force of the two negatrons acting on each other when added to the repelling centripetal force experienced by each that prevents either of them from spiraling into the positron and annihilating the positron and the first negatron to reach it. It may be that this repelling force creates force wells that established the stable orbits of the two negatrons so close but not too close to the central positron. Also, if my guess is correct about neutrinos (very high frequency tron pairs [captured photons]) being the driving force that makes electrons and positrons go, this may also help to explain why these three particles can be so close yet so stable.)

These three particles, the center positron 12 and fast orbiting negatrons 10 and 14 have a net charge of −1e and these three particles are orbited by two positrons 16 and 18 at a radius of about 0.5×10⁻¹⁵ m which establish the size of the proton. At this radius the Coulomb attractive force between each of the positrons and the three central electrons (with a net charge of −1.6×10⁻¹⁹C) is.

$$F = \frac{{q}_{1} {q}_{2}}{4 π {ϵ}_{0} {r}^{2}}$$

$$F = \frac{( 9.0 \times {10}^{9} N {m}^{2} / {C}^{2} ) {( 1.6 \times {10}^{- 19} C )}^{2}}{{( 0.5 \times {10}^{- 15} m )}^{2}}$$

$$F = 920 N$$

The positrons orbiting the center three-some must orbit fast enough so that their centripetal force approximately equals the Coulomb forces. Therefore, we can get a rough estimate of that velocity from:

$$F = \frac{m {v}^{2}}{r}$$

$$or : \\ v = \sqrt{\frac{F r}{m}}$$

If the velocity is much less than c, the mass of the positrons can be assumed to be equal to the positron rest mass, so:

v=2.2×10⁸ m/s.

This is about 73 percent of the speed of light and as a result the mass would be increased about 50 percent above the rest mass of 9.1×10⁻³¹ kg or to about 13.6×10⁻³¹ kg which means that the velocity is somewhat less than the above estimate, maybe about ½ the speed of light. This model of the proton has the two positrons 16 and 18 orbiting on substantially the opposite side of the center three-some but on different paths. As with the negatrons, the opposing positrons (along with the center positron) help prevent each other from spiraling into the lower orbiting electrons.

Therefore, to summarize, the proposed model of the proton shown in FIG. 1 consists of a positron at a center position with two negatrons orbiting at a radius of about 3×10⁻¹⁸ m so fast that their combined mass is increased to a mass almost equal to the known proton mass. The two positrons orbiting at about 0.5×10⁻¹⁵ account for the rest of the mass of the proton that totals about 1.7×10⁻²⁷ kg. The orbit of the two positrons also establishes the measured size of the proton. Note that FIG. 1 is not drawn to scale.

### Other Possible Orbits

Orbits other than the ones described above are possible. For example, the two close-in electrons may follow paths such as those described for the minus tron in the electron model of FIG. 9. In this case the separation distances and forces would be somewhat different. I hope readers who are much more mathematically inclined than 1 will figure out orbit paths that provides the extremely stable configuration of the proton. I will be extremely surprised if I got it right; however, I think I am close and I believe some math experts will prove that at least one stable configuration does using one of the basic models described in this specification. (In fact, as reported later in this specification my most preferred model of the proton is one comprised of one negatron and two positrons each driven by a neutrino, where the paths mapped out by the negatron and the positron are similar to the paths of like-charged trons making up the positron.) In other words I believe someone will show soon beyond the shadow of a doubt that protons are comprised of electrons and positrons which in turn are comprised of trons. I hope that these experts are also able to prove conclusively that the force driving some or all of the electrons in their orbits are neutrinos (high frequency/high energy photons) which like everything in the universe are also comprised of trons.

### The Middle Particle of a Proton May be a Plus Tron

As described in parent applications another slight alternative to the proton model described above is the same model except the middle positron is replaced by a plus tron. Thus, the proton would be made up of a plus tron, two negatrons and two positrons. (An anti-proton would be comprised of a minus tron, two positrons and two negatrons.) The plus tron has the same charge as the positron and in terms of the mass of the proton about the same mass (i.e., 9.1×10⁻³¹ kg as compared to 0 kg). One recently published physics book, (see Fundamentals of Physics, Extended, Halliday, Resnick and Walker, John Wiley & Sons, pages 1120-1123) described the residue of a proton and anti-proton annihilation as producing four positive pions and four negative pions. These pions ultimately (in fact, very quickly) decay first to muons which in turn decay into four negatrons and four positrons, with the release a total of 24 neutrinos. Therefore, in alternative models (to match these facts if they are true facts), I have permitted each orbiting positron and each orbiting electron in each proton and each anti-proton (a total of 8 orbiting electrons) to have captured three neutrinos each (for a total of 24 neutrinos being captured). How do I justify three neutrinos per electron? Easy, this is what I need to get to 24. Also, each electron has three trons and each tron could have a neutrino associated with it as it zips along its electron path. (Man we are really thinking small here! I think you call this type of reasoning phenomenological reasoning, and according to Macintosh, looks like I must have spelled it right.) The capture of a neutrino does not change the charge because the neutrino's net charge is zero. Arguably, it does not change the mass significantly because the neutrino is suppose to have zero mass or almost zero mass. However, captured neutrinos may have substantial masses and they may account for a lot of the mass of the proton and the neutron. Three captured neutrinos orbiting at near the speed of light may be an important factor in developing the effective mass of both the proton and the neutron. This would mean that the close-in orbiting electrons may not have to go so close to the speed of light as described above in order to produce the proton mass. It is also possible that the 12 neutrinos in a proton account for nearly all of the mass of the proton and the mass of a particle does not increase because its speed approaches the speed of light. Instead, the high energy photons or neutrinos are required to drive the particle to speeds approaching the speed of light and it is those neutrinos and/or photons that are responsible for the increase in mass.

### Three-Electron Proton Model

A new proton model 320 is shown in FIG. 18. This new proton model is very similar to the positron version of the new electron model shown in FIG. 16 except in the place of plus and minus trons we have a negatron 322 in the circular loop and the two positrons 324 and 326 orbiting the circular loop. These electrons are being pushed in their paths by trapped high-energy photons (i.e., neutrinos) 322A, 324A and 326A. The frequency of the high-energy photons is high enough so that the energy/mass of the proton is increased by a factor of about 1800 compared to the energy/mass of an electron. In a previous section, entitled “Can Captured Photons Explain Increased Mass of High Speed Things”, I concluded that a photon having a mass/energy equal to 900 times the electron mass would have a diameter roughly equal to the size of a proton. The reader should note therefore that the neutrinos 322A, 324A and 326A shown in FIG. 18 may be larger relative to the paths of the electrons than is indicated in the FIG. 18 drawing. I recognize that this model of the proton seems somewhat complicated, with one negatron, two positrons and three neutrinos pushing the negatron and the two positrons in their orbits. However, my understanding is that the ultimate products of a proton—anti-proton annihilation are positrons, negatrons and neutrinos. So maybe this model is correct. Each of the three electrons and their associated neutrino could be what some people are calling quarks. Also if the helical diameters of the neutrinos 322A, 324A and 326A are about the size of the proton, then they are going to feel the force of each other and each of the electrons in the proton. If my model is correct I suspect that the movements of all of these trons (in this model there are 15 of them: 7 minus and 8 plus) are precisely synchronized with enormous Coulomb forces holding them dynamically in place. I am looking forward to some smart computer person creating a 3-D computer model corresponding to this model so we can watch all the little trons loop around each other in very, very, very slow motion.

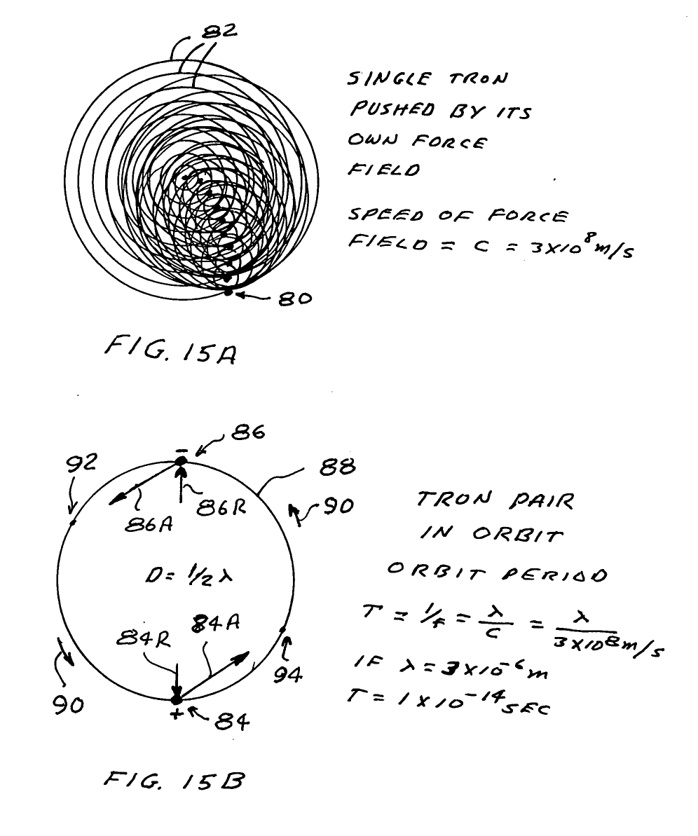

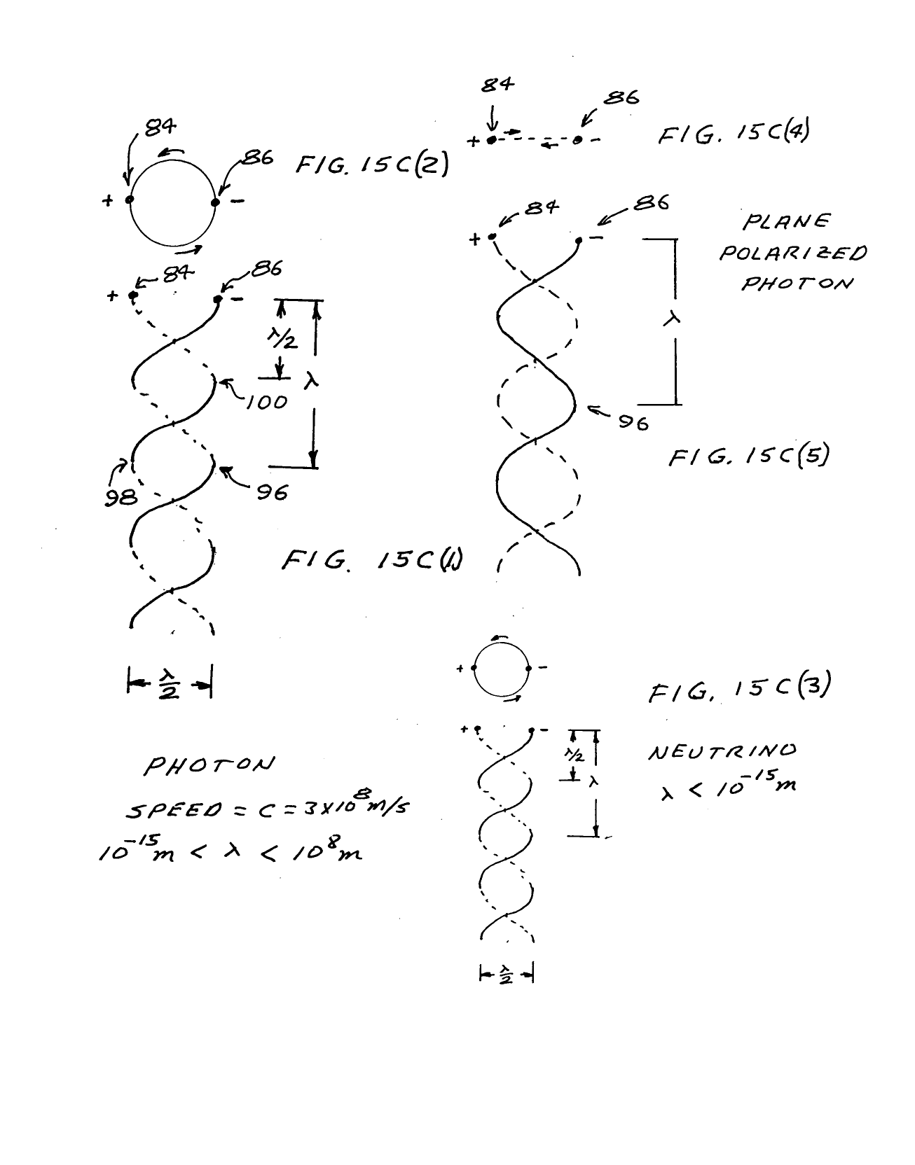

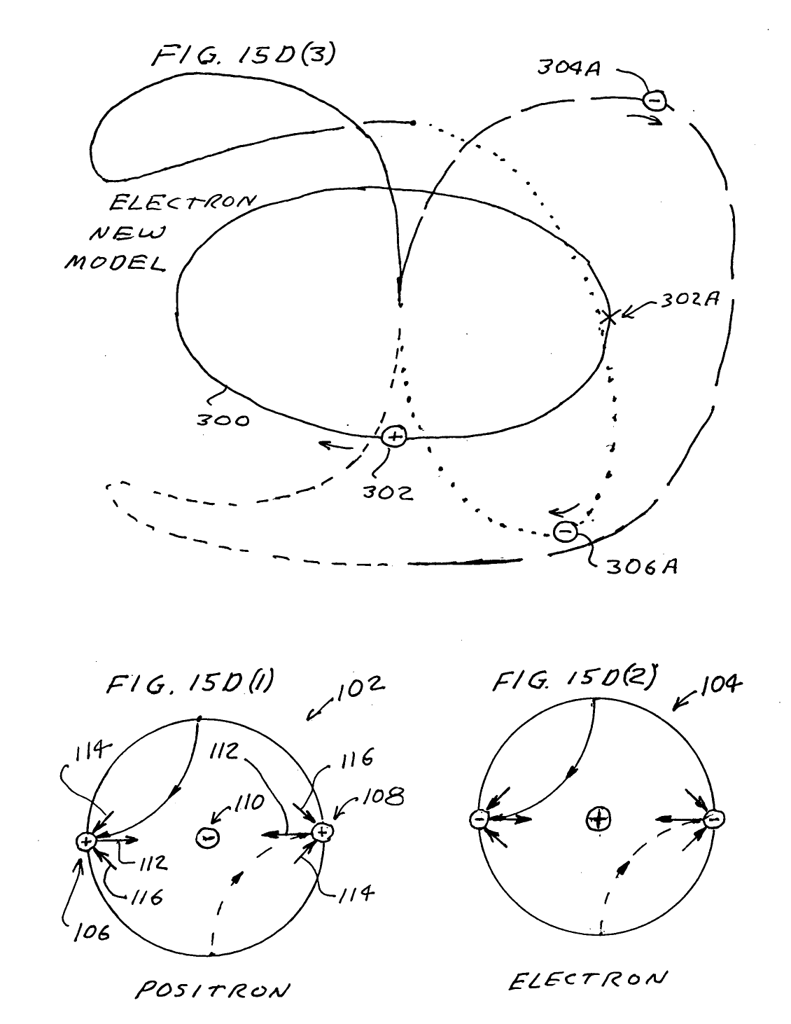

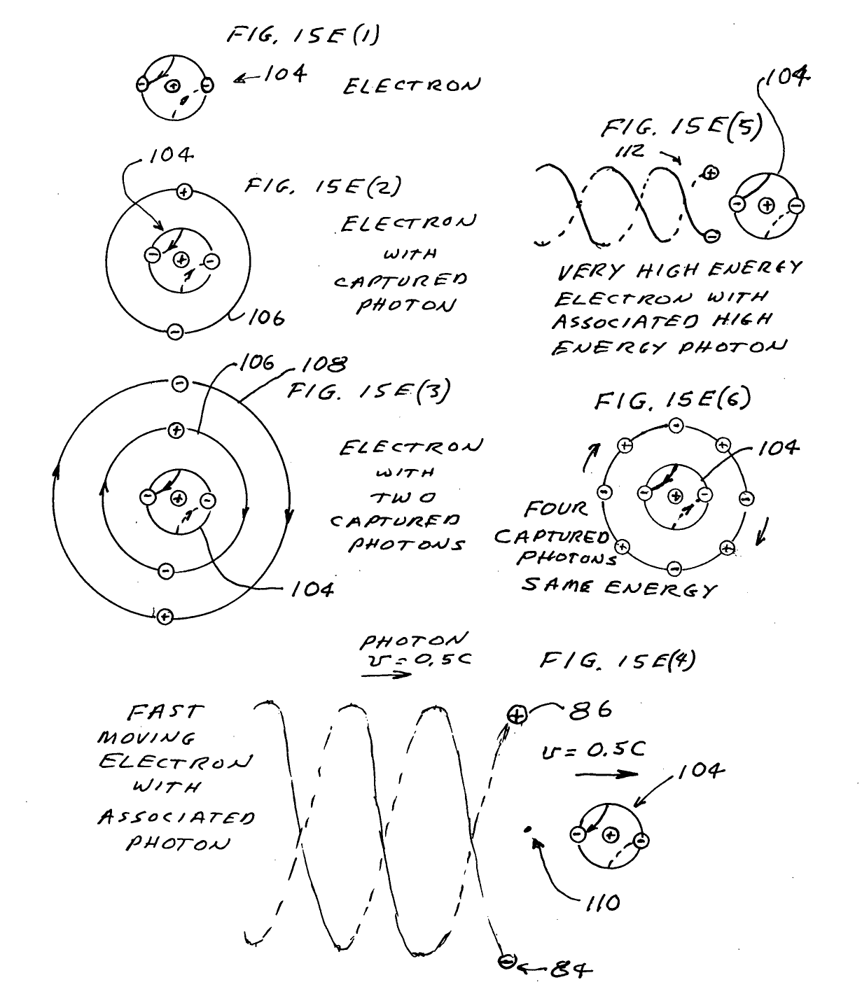

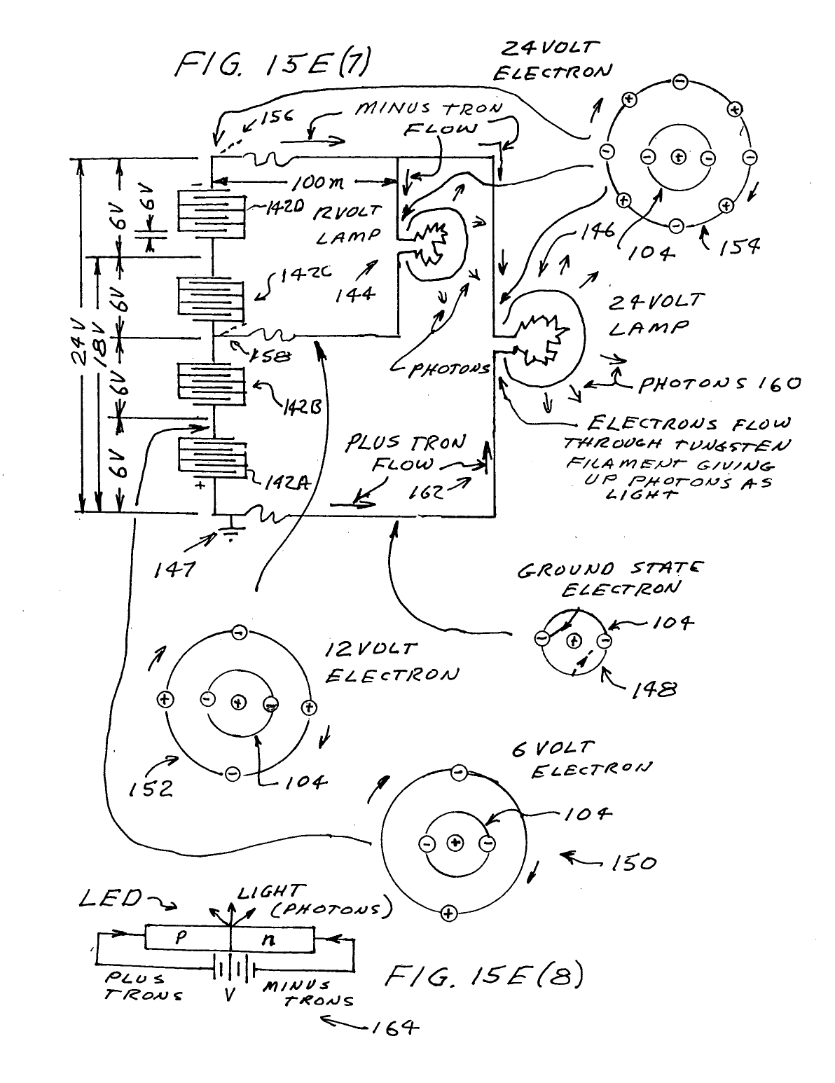

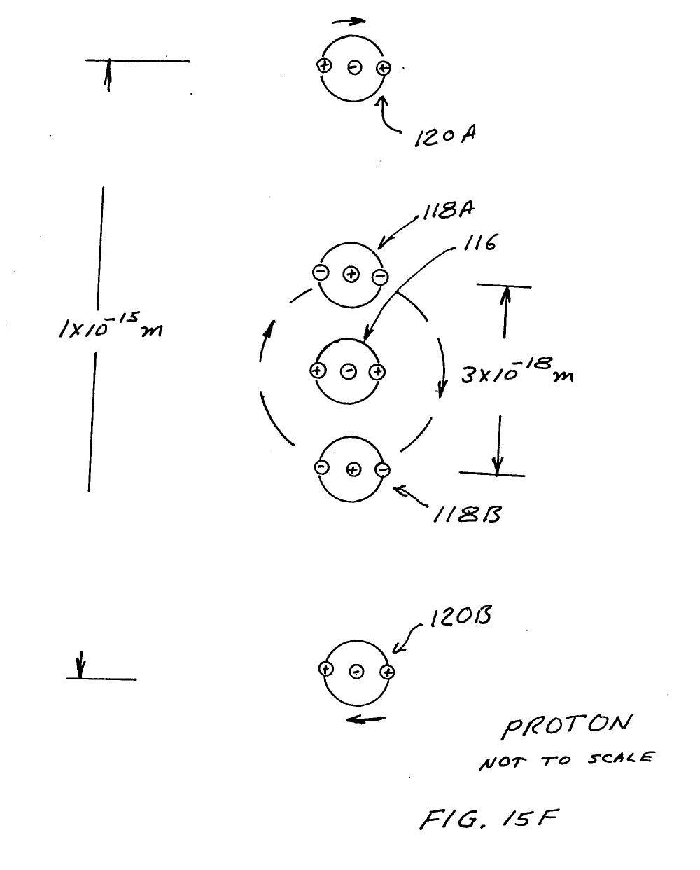

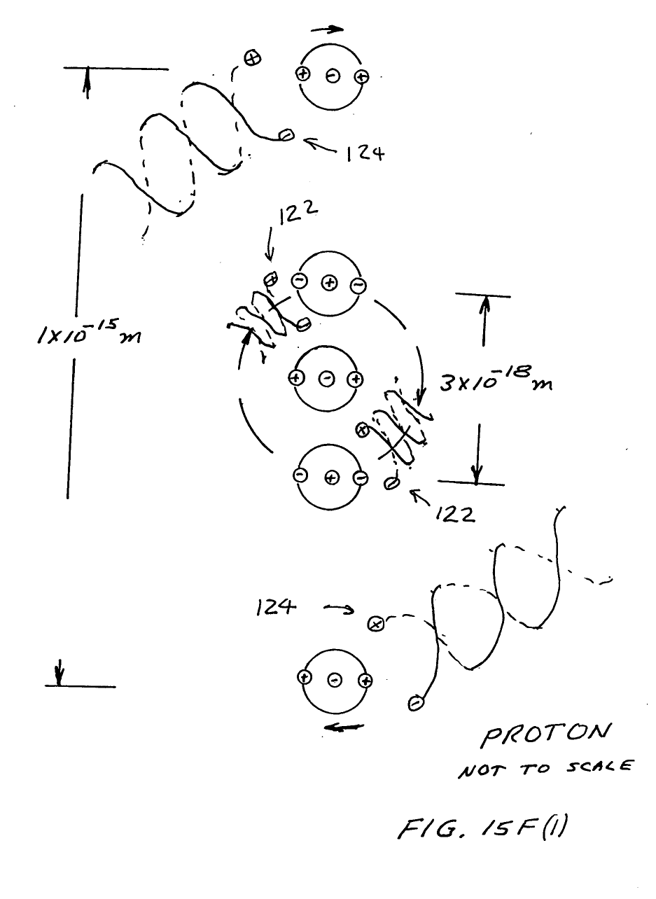

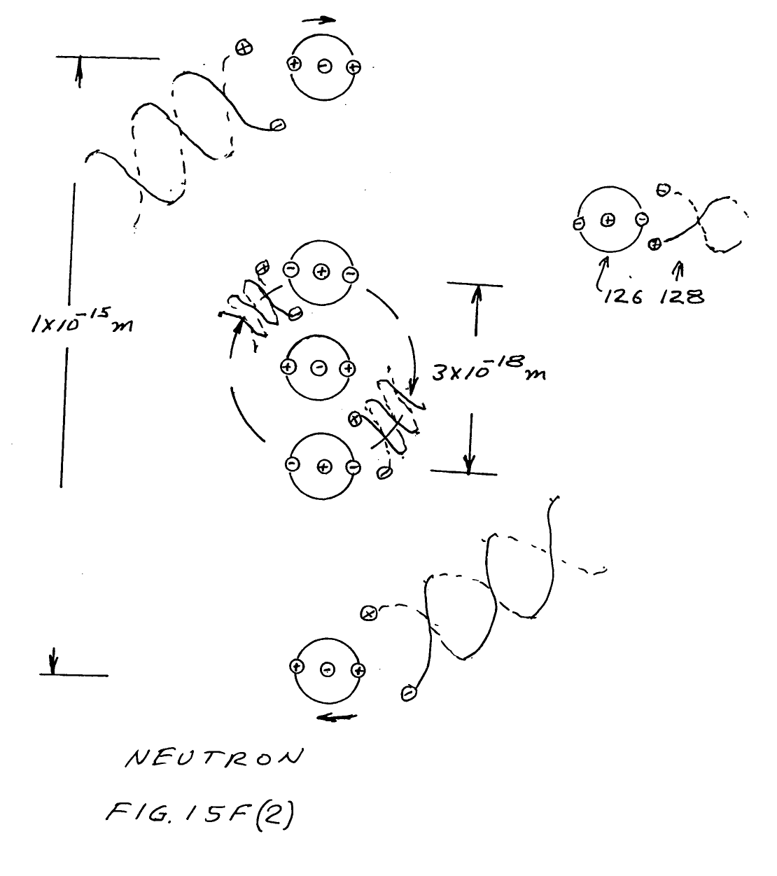

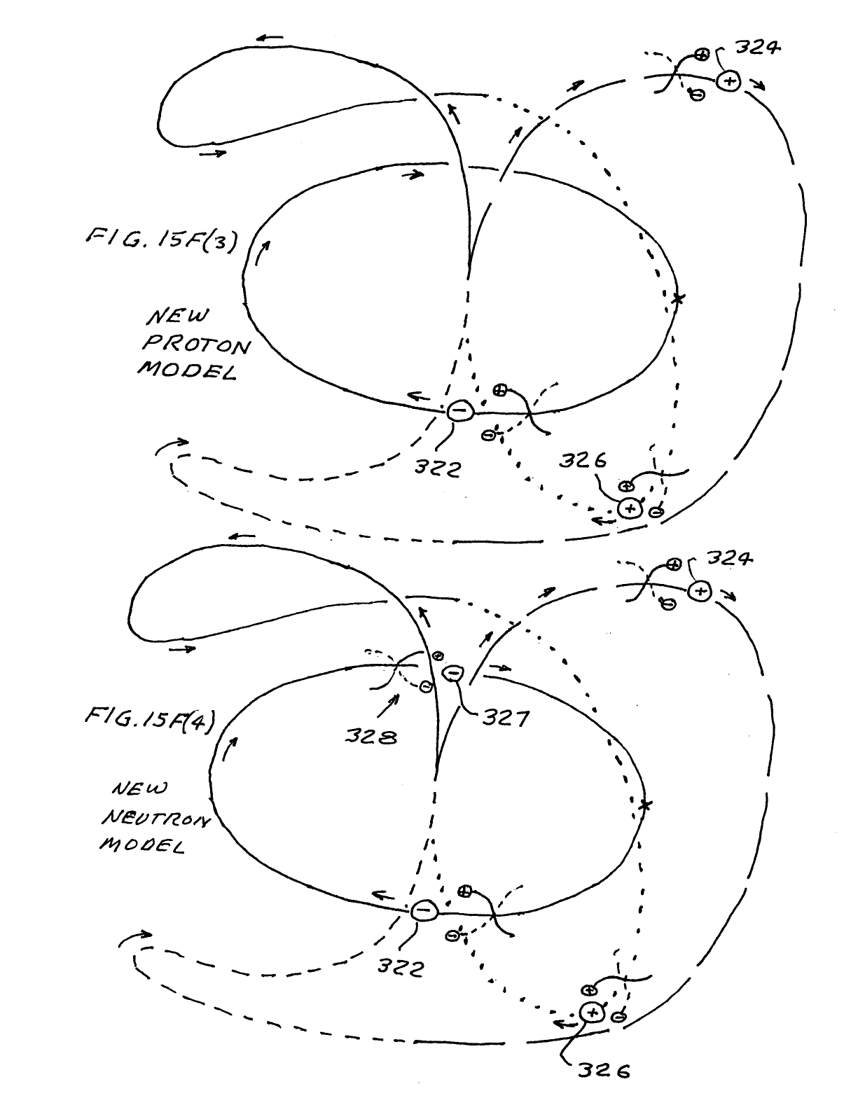

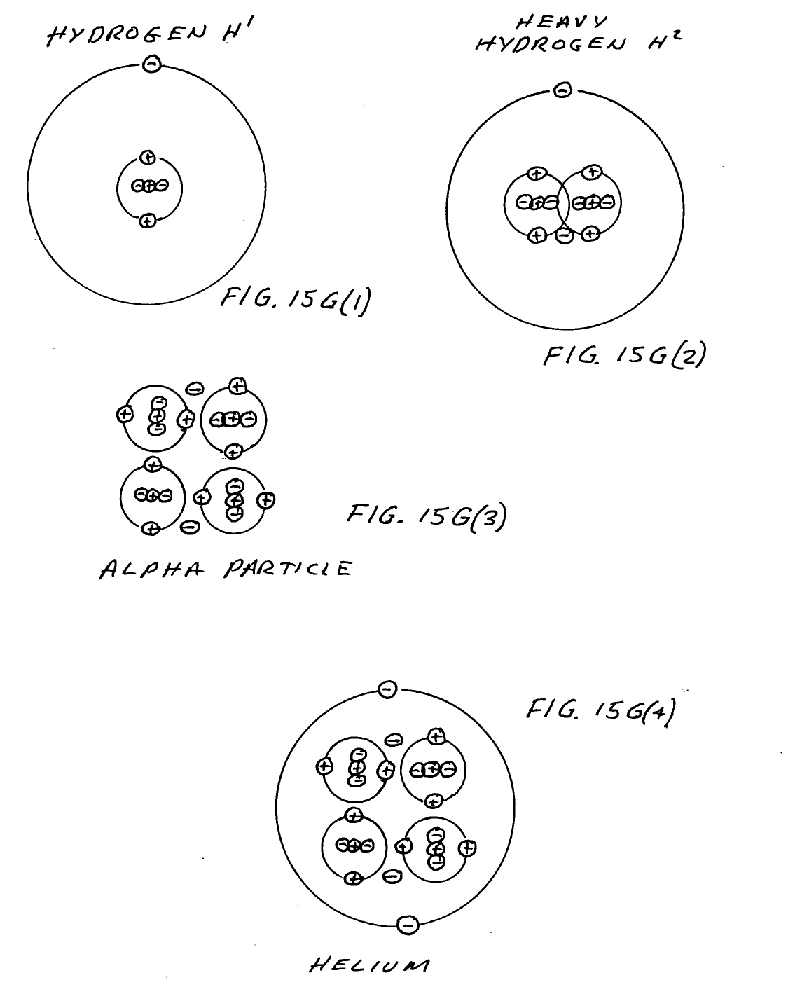

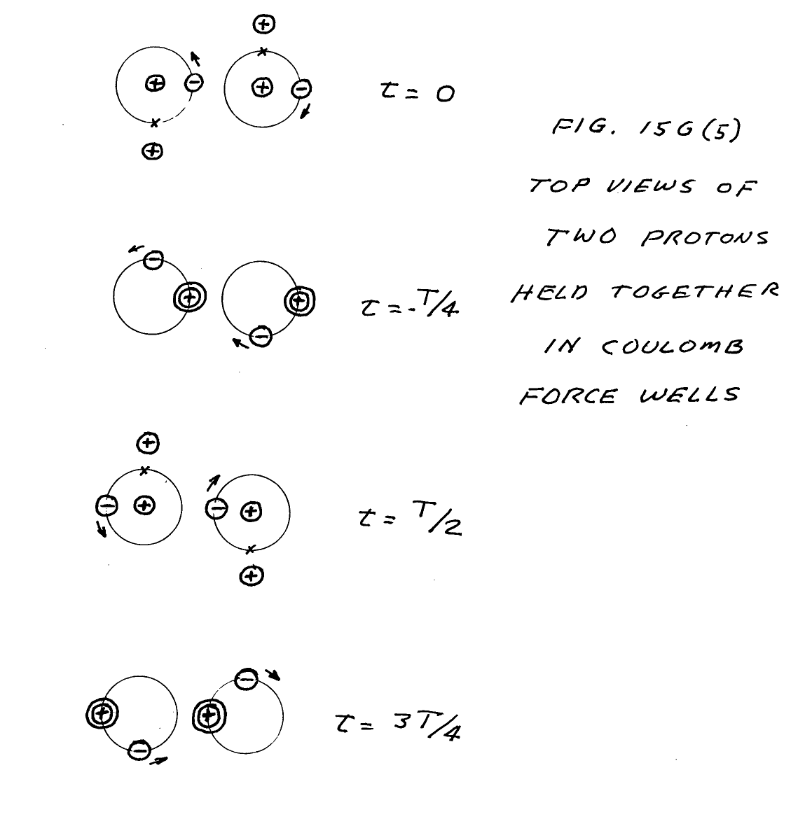

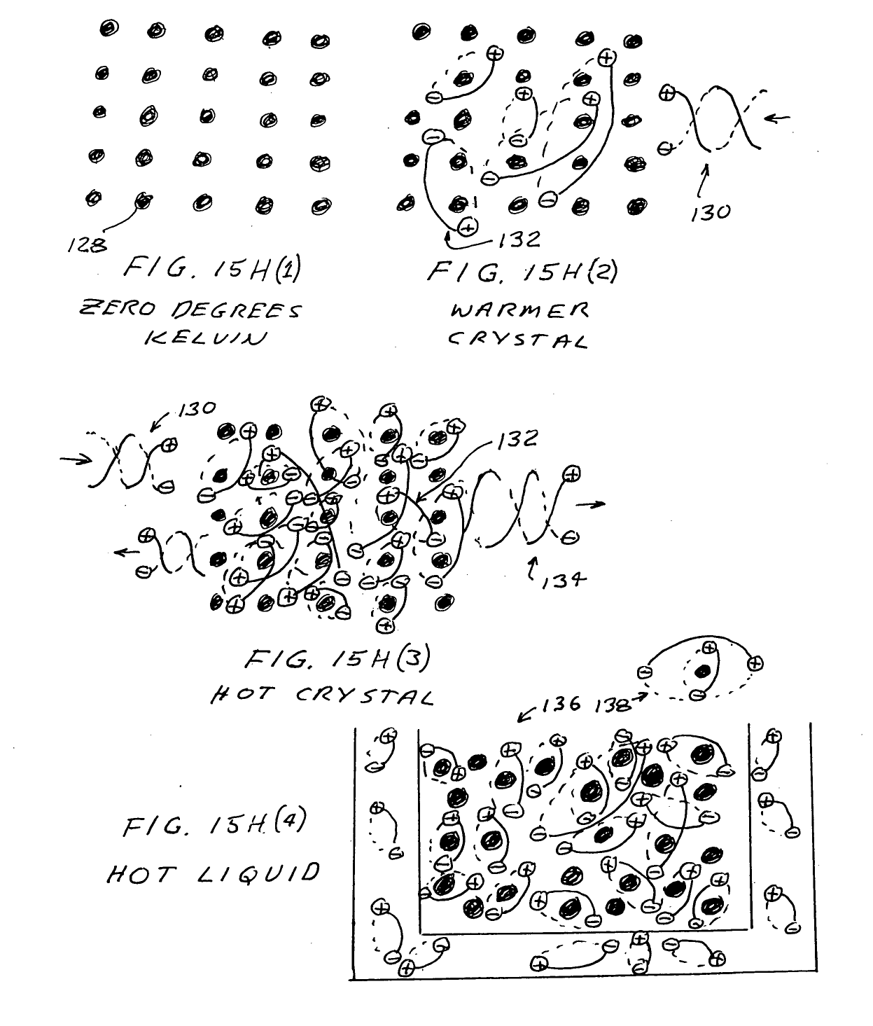

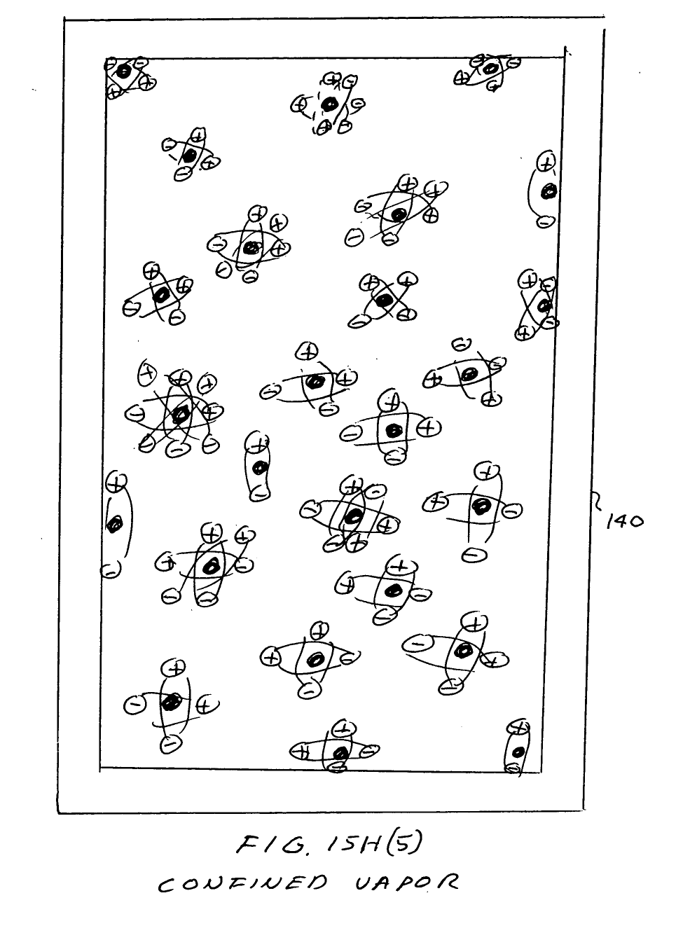

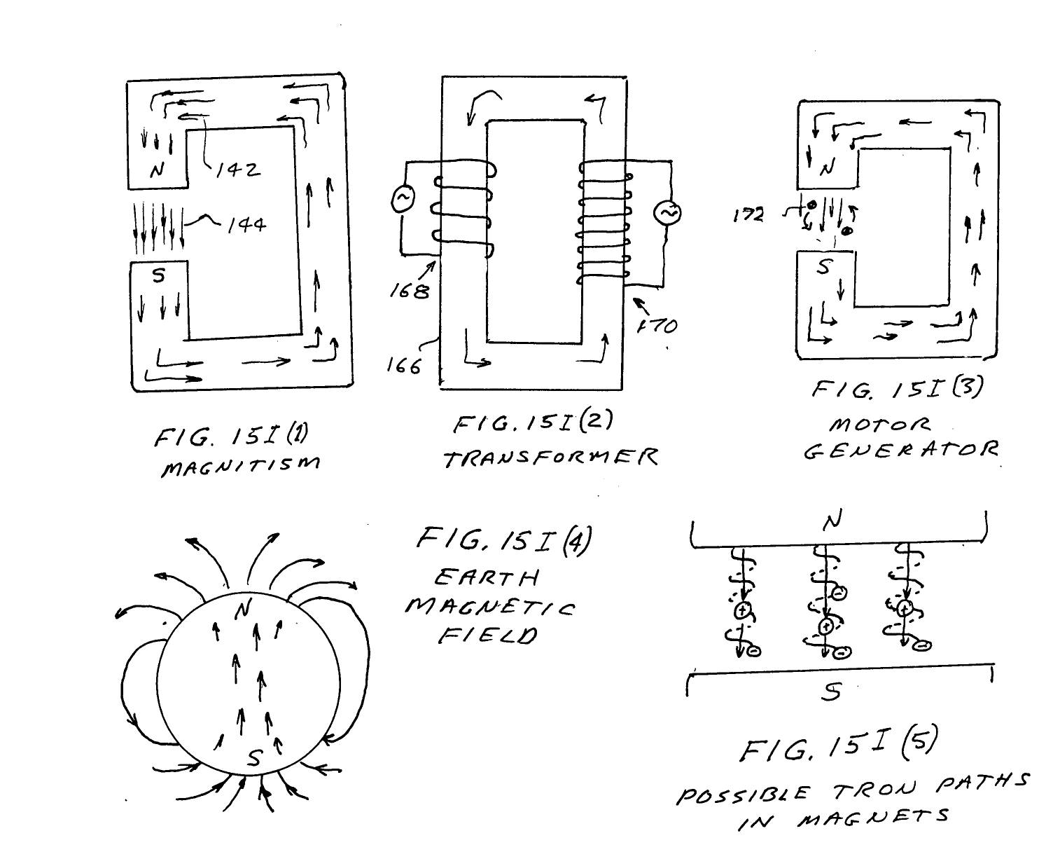

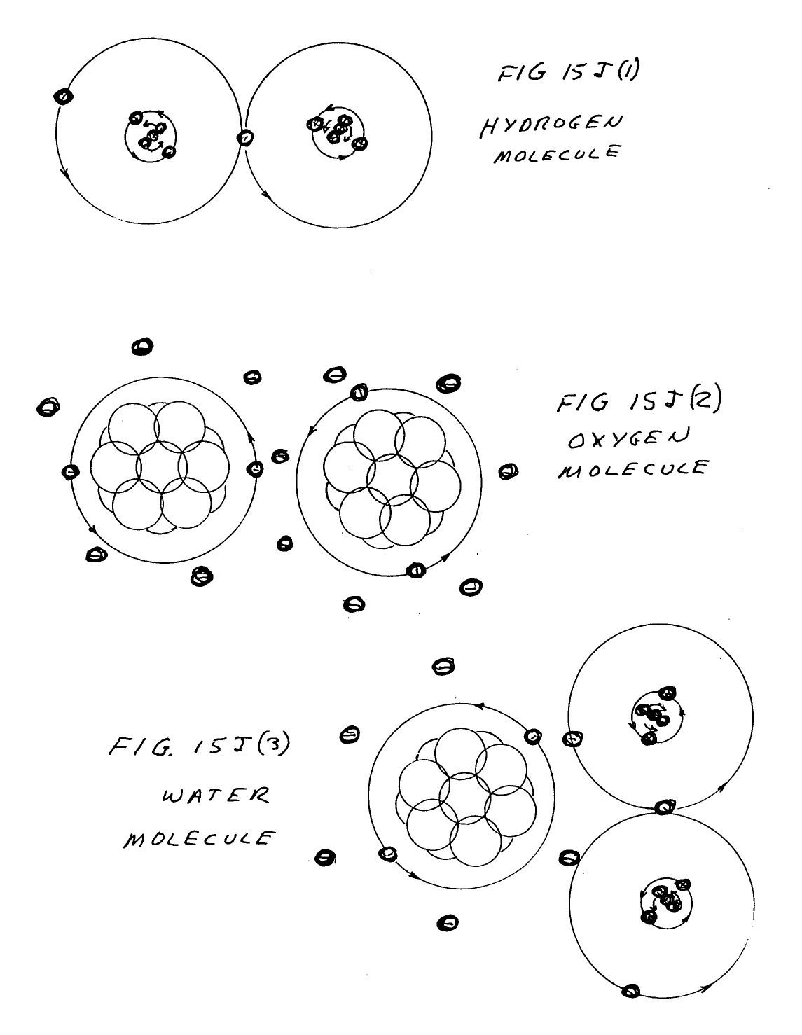

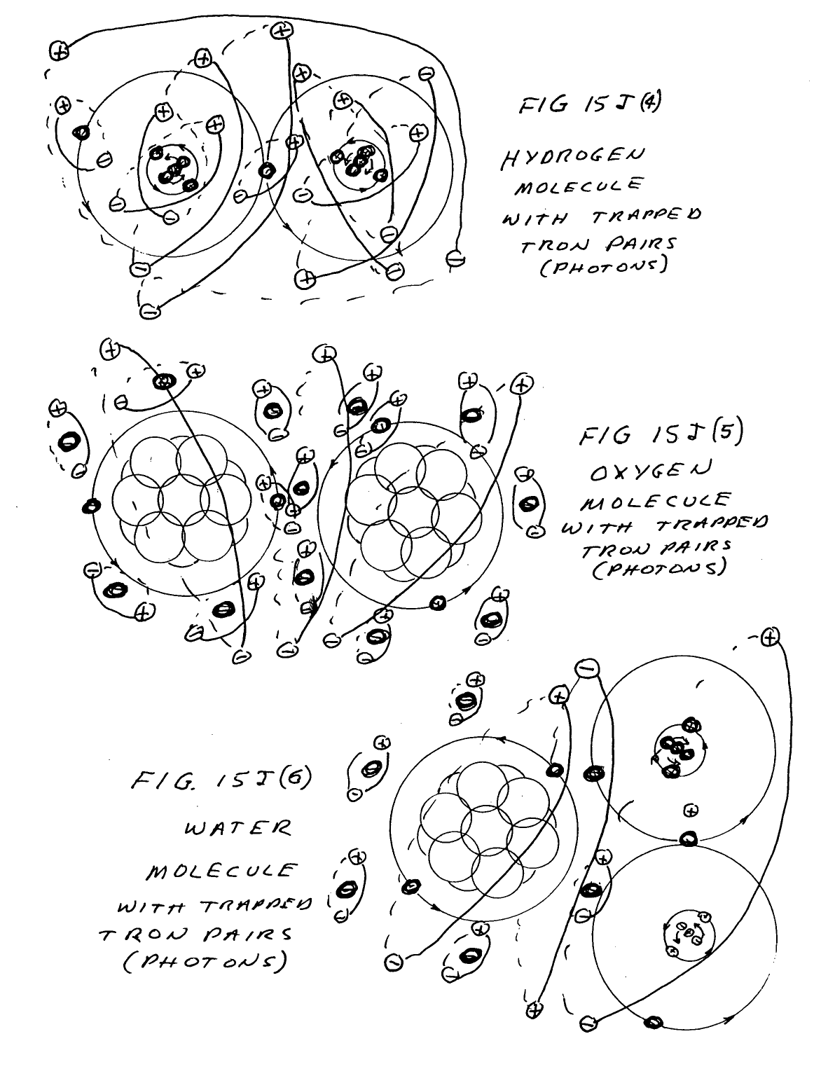

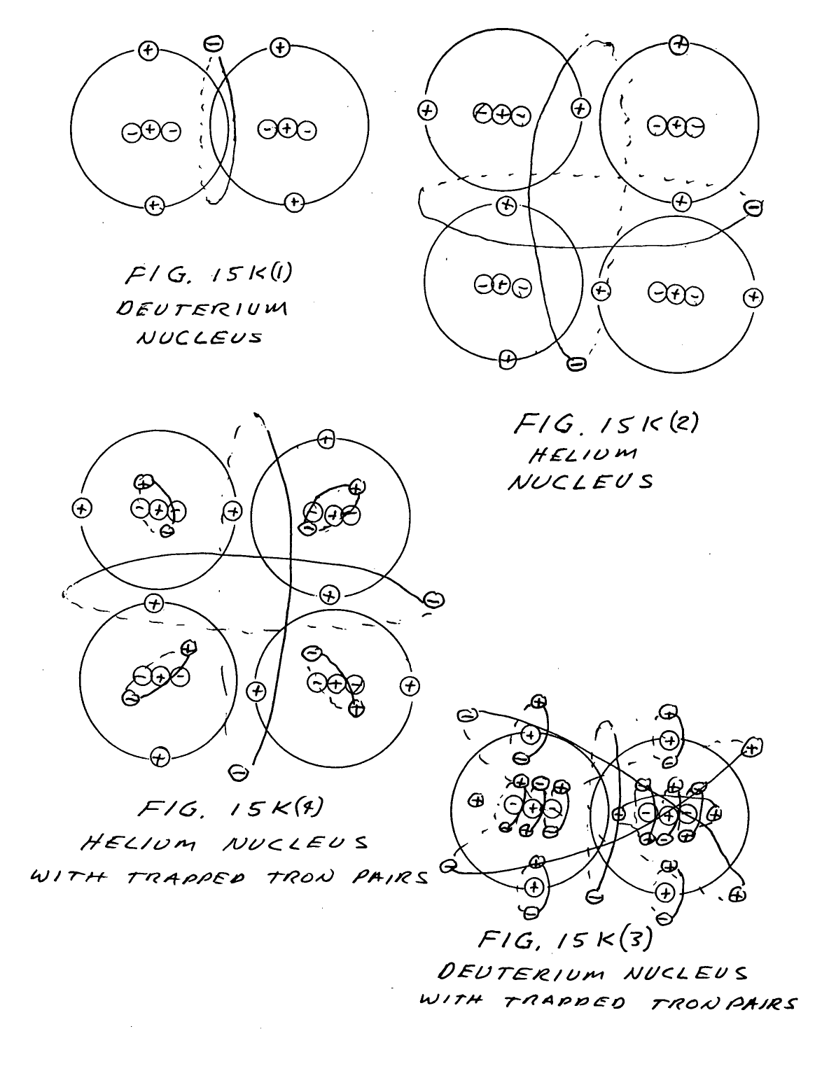

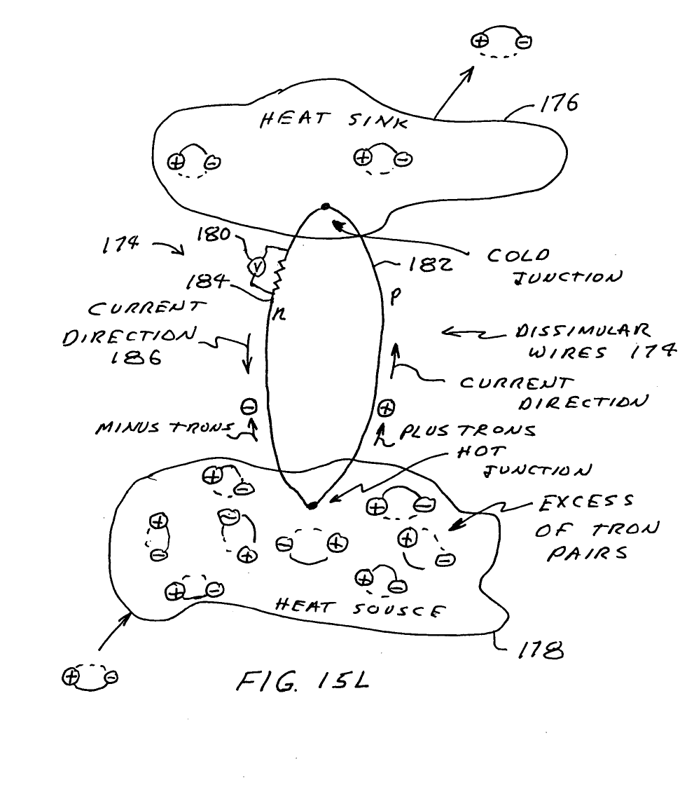

The anti-proton is just the opposite of the proton and comprises a positron in the place of negatron 322 in FIG. 18 and two negatrons in the place of positrons 324 and 326. The neutron would have an additional negatron (along with a corresponding neutrino [or high mass/energy photon] to drive it) added to the proton shown in FIG. 18. My guess is that it would locate itself on the path of negatron 322 at the minus T/2 position. (See FIG. 15F(4).) The reader should keep in mind that the neutron is extremely stable inside a nucleus but very unstable (with a half-life of only a few minutes) outside the nucleus. If this model is correct an anti neutron could be constructed by adding another positron to the positron loop of the anti-proton.

### Quarks

The reader may be wondering at this point how the Ross Proton Model squares with existing proton models. Accelerator experiments show that the proton can be broken apart. When this happens very short-lived particles are produced which decay into positrons and negatrons (plus photons and possibly neutrinos). The Ross Model is supported by this data. This experimental data also indicates (assuming the Ross Proton Model is correct) that the three central electrons are not stable by themselves. That is, they need the two orbiting positrons to help hold them in their very fast path around the central positron. Quarks are supposed to have charges such as +2e/3 and −1e/3. The Ross Proton Model does not need quarks to explain the construction of protons (or neutrons as explained below). I suspect that Quarks don't exist.

### Neutrons

One neutron model is merely a proton with an electron orbiting it or tied to it somehow. The measured mass of a neutron is greater than the combined mass of a proton and an electron by about 15×10⁻³¹ kg or the excess is equal to about 60 percent of the mass of an electron. This difference can be accounted for by an increased mass associated with an electron velocity of about 0.78 c. This would imply an orbit close to the orbit of the outer two positrons in the Ross Proton Model. Alternately, the electron orbit might be farther out but its presence may cause the two electrons to orbit faster to produce the missing mass. Also, the electron may have captured one or more extra neutrinos or a high-energy photon as explained below. (A photon [X or gamma ray] with frequency of 0.79×10²⁰/second has an energy equivalent to 5.9×10⁻³¹. The neutron is not stable, having a half-life outside nuclei, of only about 15 minutes. The Ross Neutron Model is shown in FIG. 2. When neutrons are part of a nucleus their extra electron is probably shared more or less equally with the protons in the nucleus.

### Neutron Modeled as a Proton plus an Electron plus a Neutrino

In a preferred model a neutron is modeled as a proton plus a “heavy electron”. This heavy electron is an electron which has captured a neutrino. The logic for this is very simple. A neutron decays to a proton by emitting an electron plus a neutrino. It certainly makes sense therefore that a neutron consists of these three things. In another model each tron in the electron may incorporate a neutrino.

### Atoms

### Atomic Models

### (With Five-Electron Protons)

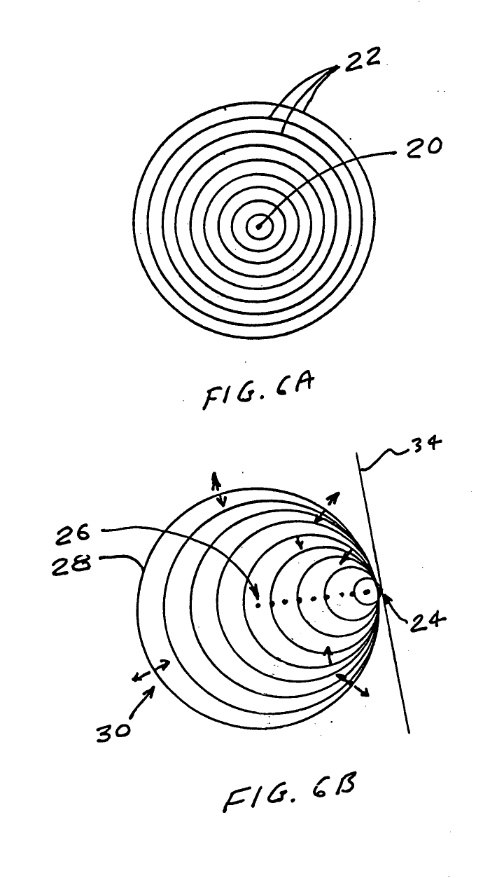

FIG. 3A shows a suggested arrangement of components of a helium 4 nucleus or an alpha particle according to the Ross Nuclear Model with the two extra negatrons (associated with the two neutrons of the helium nucleus) not shown. In this description, I will refer to the group of three positrons and two negatrons shown as shown in FIG. 1 as a “proton” recognizing that the group could have at least initially existed as a neutron with an extra electron orbiting as described above. This liberty is the result of my belief that a neutron (if it is ever identifiable as a separate entity in a nucleus can change places with a proton by having its outer negatron be stolen by a neighboring proton. The missing two negatrons in the FIG. 3A drawing are the outer negatrons of what the prior art refers to as the two neutrons in the nucleus of the helium atom or the alpha particle. Neutrons and protons each appear as five electrons, one positron at the center orbited closely at 3×10⁻¹⁸ m by two negatrons, with this threesome being orbited at 0.5×10⁻¹⁵ m by two positrons. The two extra negatrons are shown FIG. 3B at 61A and 61B in a close-in more or less arbitrary orbit around a central position of the four “protons”. Many orbits of the two negatrons are possible. For example, the negatrons could orbit a single proton or they could orbit any combination of the four protons.

So now let us estimate the forces acting on the protons in this configuration. Remember, the prior art thinking has been that some mysterious God-like “strong force” (which no one could very well explain) must be acting to hold the positive charged protons together in the nucleus. To get a feel for the forces between these protons, let's just consider the forces between the two protons on the left side of the FIG. 3A diagram. These two protons are reproduced in FIG. 4. In FIG. 4 the central positrons and the close-in orbiting negatrons appear as small circles, each with a plus and two minus signs in it. On any scale showing the two inner orbiting negatrons (orbiting at 3×10⁻¹⁸ m) and the two orbiting positrons (orbiting at 0.5×10⁻¹⁵ m) the three inner particles would appear as a tiny spot with a charge of −e while the two orbiting positrons appear as two orbiting spots each with a charge of +e.

So on with the Coulomb force calculation. (Remember from the Background section we reported that the prior art thinking was that the Coulomb force between two protons in a larger nucleus separated by 4×10⁻¹⁵ m was a repelling force of 14 N.) However, a close examination of FIG. 4 suggests that with the two protons arranged as shown, with the orbiting planes of the two orbiting positrons of each proton at right angles to each other, at certain distances the net forces of the particles making up the two protons could be attractive at certain ranges of separation and repelling at other ranges. For example at long separations (i.e., very long compared to the dimensions of the protons), the force acting between the protons is repelling since both have a net charge of +e. At very close separation, the closest positron of proton 4 will feel an attraction to the central three particles of proton 2 that is greater than the repulsion to the two orbiting positrons of proton 2. However, as the closest positron of proton 4 moves away from its position shown in FIG. 4, the repulsion from the orbiting positrons of proton 2 will exceed the attractive force of the central three particles of proton 2. Therefore, in the close position, the orbiting positrons of proton 4 will be both attracted and repelled as they make their orbits. The forces acting on the central three particles of proton 4 however would appear to be much more important in determining a stable position of proton 4 relative to proton 2 since their effective mass is about 1000 times greater than that of the orbiting positrons of proton 4. At long distances the central 3 particles of proton 4 feel a net attraction to proton 2, since the central 3 have a net negative charge and the net charge of proton 2 is positive. The closer proton 4 gets to proton 2 the stronger is the attraction of the central three particles of proton 4 to proton 2. However, once the central three particles of proton 4 approach very close to the central three particles of proton 2, the repulsive force due to the central three particles of proton 2 overcome the attractive force of the two orbiting positrons of proton 2 and the force from proton 2 acting on the central three particles of proton 4 becomes repulsive. Therefore, a “force well” is created between the particles of proton 2 and the central 3 particles of proton 4. Once the central three particles of proton 4 are in this well they cannot easily escape. I estimate for example that at a separation of about 0.5×10⁻¹⁵ m between the three central particles of the two protons, the central three particles of proton 4 are very strongly repelled from proton 2, but from about 0.7×10⁻¹⁵ m to about 5×10⁻¹⁵, the central three particles of proton 4 are very strongly attracted to proton 2, with the strongest attraction at a separation of about 1×10⁻¹⁵ m. The orbiting positrons of proton 4 do not like being so close to the orbiting positrons of proton 2, but they are very light as compared to the central three particles so they are not very determinative of the position of proton 4. Their orbits will be substantially altered from circular as a consequence of the pushing and pulling from the particles of proton 2 as the positrons of proton 4 make their many very quick journeys around the central three particles of proton 4. FIG. 5 is a graph of my very rough estimate of the forces acting between the particles of proton 2 and the central three particles of proton 4.

### CALCULATION EXAMPLE

The following is a calculation to estimate the attractive force acting between the central three particles of proton 4 and the particles of proton 2 when the central three particles of proton 4 are located 1×10⁻¹⁵ m from the orbit plane of proton 2. The net force is difference between: (i) the attractive force between central three particles of proton 4 and the two orbiting positrons of proton 2 and (ii) the repulsive force between the central three particles of proton 2 and the central three particles of proton 4.

### Force Exerted by the Particles of Proton 2 on the Central Three Particles of Proton 4

When the central three particles of protons 2 and 4 are separated by 1.0×10⁻¹⁵ m, the central three particles of proton 4 are separated from the proton 2 orbiting positrons by about 1.12×10⁻¹⁵ m and each of these positrons attract the three central particles of proton 4 at an angle of 26.5 degrees with the orbit axis of the positrons. (These estimates are based on the assumption that the orbits of the proton 2 orbiting positrons are not changed very much due to the presence of proton 4.) The cosine of 26.5 degrees is 0.894. Thus, the attractive force from proton 2 (due to the pull of the orbiting positrons) on the central three particles of proton 4 in a direction toward the central three particles of proton 2 is:

$$F = \frac{2 {q}^{2} ( 0.894 )}{4 π {ϵ}_{0} {r}^{2}} = \frac{( 2 ) ( 9.0 \times {10}^{9} N {m}^{2} / {C}^{2} ) {( 1.6 \times {10}^{- 19} C )}^{2} ( 0.894 )}{{( 1.2 \times {10}^{- 15} m )}^{2}} = 326.9 N$$

The repulsive force (due to the repulsive force between the center three particles of the two protons) is:

$$F = \frac{{q}^{2}}{4 π {ϵ}_{0} {r}^{2}} = \frac{( 9.0 \times {10}^{9} N {m}^{2} / C ) {( 1.6 \times {10}^{- 19} C )}^{2}}{{( 1.0 \times {10}^{- 15} m )}^{2}} = 230.4 N$$

The net force is:

F=+326.9−230.4=+96.5 N

that is a very strong attractive force.

As indicated above and shown on FIG. 5 if proton 4 approaches proton 2 in the direction shown in FIG. 4, the center three particles of proton 4 will be strongly attracted to proton 2 until the center three particles are within about 1×10⁻¹⁵ m of proton 2 at which time the attraction drops sharply and at about 0.6×10⁻¹⁵ m the center three particles are repulsed. FIG. 5 as stated above neglects the effect of the proton 4 positrons which (along most of their orbits) feel a net repulsive force from proton 2. Thus, proton 4 will quickly find its net zero force location somewhere around 6×10⁻¹⁵ m from the center of proton 2 as indicated in FIG. 5A and will probably oscillate about that zero force position at a very large frequency.

The other protons of the helium nucleus will arrange themselves in a similar configuration, a possible configuration being the one shown in FIGS. 3A and B. The atoms heavier than helium will have their protons arranged in a manner similar to that shown for helium. It should be relatively easy for persons skilled in this art to construct computer models which would model the Coulomb forces of these particles very accurately based on the guidance given herein. These models will predict the shape of these nuclei including the helium nuclei much more accurately than I have done here with my very simple calculations. These calculations are not intended to be precise. The purpose of these calculations is merely to show that there are potential configurations of positrons and negatrons which can account for the mass, size and charge of protons and neutrons, and that there are configurations of protons and neutrons (comprised of positrons and negatrons, which in turn are comprised of plus and minus trons) based on this model that can explain the structure of atomic nuclei.

### Atomic Model

### (With Three-Electron Protons)

My latest proton model as described in detail above is a three-electron proton, a drawing of which is shown in FIG. 18. It is comprised of one negatron having a circular path with that path being orbited by two negatrons. The orbit periods of each of the three electrons are the same. The proton has a basic shape similar to the positron. The electrons comprising the proton are each propelled by neutrinos. Coulomb forces hold the proton together and propel its parts. The net charge of the proton is plus one but like the five-electron model, the plus one charge is a net charge of combined charges of all of its parts. These charges are concentrated into three separate groups of charges (two positive charges and one negative charge. The charges are in dynamic equilibrium as explained above and as indicated in FIG. 18. FIG. 15G(5) show top views of two protons side-by-side, at four equal time slots during one period of proton oscillation. The negatron in one of the protons is orbiting in a clockwise direction and the other is orbiting in the opposite counter-clockwise direction. The reader can see qualitatively that the net Coulomb forces between these two protons could be attractive at distances in the range of proton dimensions. This model of two protons suggests a mechanism by which two protons or many protons, each with a positive charge could nevertheless be attractive toward each other within nuclear dimensions. Note, this would be a very dynamic attraction. Plus the nucleus would display oscillatory properties making the nucleus attractive to photons having matching frequencies. Note also that I do not show the three neutrinos in the proton drawings, but the reader should understand that in this preferred embodiment, they are there providing speed and mass to the parts of the protons. The reader should also note that current nuclear models propose that protons are comprised of two u-type quarks each having a charge of +2e/3 and one d-type quark having a charge of −e/3. This description is not much different form the above model where the two positrons would each have a net plus e charge along with one plus e and one minus e charge in its driving neutrino. (This may look like +2/3.) The negatron has a net minus one e charge and its driving neutrino adds another minus e charge and a plus e charge. (This may possibly look like −1/3). So maybe this model is not much different from the quark model that I have been criticizing all these years.

The nuclei of all the isotopes of all chemical elements are built up of protons and neutrons held together in Coulomb force wells according to this atomic model.

### Magnetism and Gravity

Preferred models of the present invention predict that the only forces in the universe are the Coulomb forces produced by trons. This means that there is no independent magnetic force and no independent gravitational force, and that these well-known forces are only manifestations of the tron Coulomb forces. I have not been able to derive the magnetic forces and the gravitational forces from this model; however, I have developed some very qualitative speculation as to possible connections. In the case of gravity, I present two models, the first from a parent application and the second that I like better is my newest gravity model.

### Magnetism

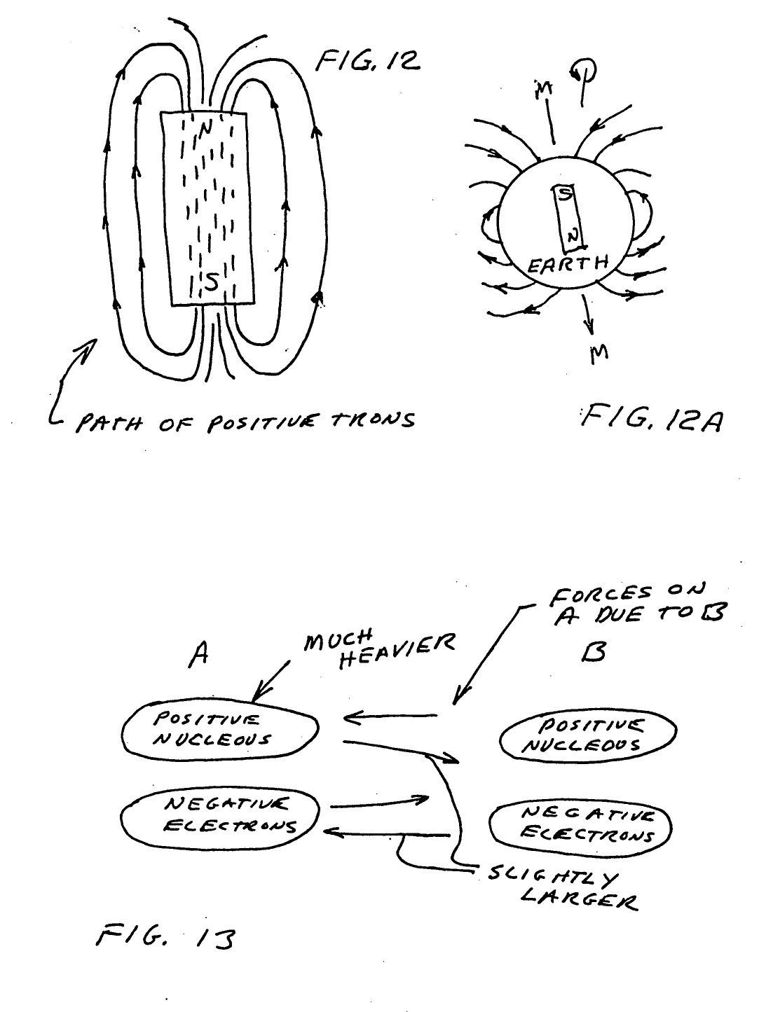

As to magnetism, see FIG. 12. All matter except possibly at extremely low temperatures are loaded (according to preferred models of the present invention) with unattached positive and negative unattached trons, most of which are whipping around a speeds equal to or in excess of the speed of light. When we measure temperature we are measuring the effects of these trons. In most cases the motions of these trons are random. The trons can pass into and out of the matter as tron pairs in the form of radiation and thermal conduction. Applicant speculates that when a magnet is formed, either a permanent magnet or an electric magnet, trons are forced to travel along specific routes as shown in FIG. 12. Applicant speculates that a result of this organized flow of these mass-less charged particles, the forces we call magnetic forces are produced. These trons flow through the earth (according to this model) out of the earth near one pole and into the earth near the other pole to produce the earth's magnetic field as shown in FIG. 12A. This may seem like a long way for these trons to go but remember these trons haul buggy at 3×10⁸ m/s or faster. So the round trip around and through the earth with its 6.37×10⁶ m radius might much take less than one second. Amazing! Additional speculation regarding magnetism is included in a following section.

### Gravity

### (First Explanation)

The immediately following explanation of gravity is from a parent application. (The reader should note that this was the best explanation I had at the time I filed my previous explanation. I believe I have a much better explanation now that is given in the next section.) The force of gravity according to Newton is:

F=GM₁M₂/r²

Where G=6.67×10⁻¹¹ Nm²/kg² and M₁ and M₂ are two masses.

So the 6×10²⁴ kg earth with a radius of 6.37×10⁶ m exerts a force on my 68 kg body of:

F=6.7×10² N

The earth has according to my extremely rough calculations about 4×10⁵¹ negative electrons orbiting in the atoms making up the earth. I have about 4×10²⁸ protons in the nuclei of the atoms making up my 68 kg body. The attractive force of the earth's orbiting electrons on the protons in my nuclei is about:

F=(9×10⁹ Nm²/C²)Q₁Q₂/r²

where the Qs represent the total charges of the above electrons and the protons; therefore,

F=9×10³⁸N.

Similar calculations can be made for the attraction between my electrons and the earth's protons and the repulsive forces between my electrons and the earth's electrons and my protons and the earth's protons. There is an extremely widely held general belief that these absolutely enormous forces are completely nullified by each other. This may be true; however, it may also be true that the electrostatic forces do not completely balance. And that for distances larger than atomic distances and shorter than galactic distances, this lack of complete balance in the electrostatic forces results in the force we have, since Newton's time, called the force of gravity. (As explained in detail above, this lack of complete balance of electrostatic forces (except at certain very specific distances) has allowed me to propose a Coulomb substitute to the nuclear “strong” force at nuclear distances.) There may not be a complete balance at distances of meters, to solar distances where we can clearly see the effects of the force we call gravity. It may be that the gravitational force results from the fact that the center three trons (making up nearly all of the mass of a proton) carry a net negative charge and so the center of the proton is attracted by distant protons not repelled by them. I note here that astronomers have collected evidence that stars in the outer reaches of galaxies do not seem to be moving consistently with the rules of gravity. The normal explanation is that there is matter in the galaxies that we can not detect. Another explanation is that at galactic distances and beyond our old gravity rules don't work. This may also explain why galaxies seem to be receding from each other.

### New Gravity Model

Applicant believes that the gravitation force must be derived from the Coulomb electrostatic forces. Explaining gravity in terms of the Coulomb force from trons is important, because a central idea of the present invention is to try to explain all of physics in terms of trons and the Coulomb force that exudes from them. I now believe that matter-penetrating photons (such as neutrinos) are the carrier of the gravitation force and that gravity is the result of Coulomb forces pushing on charges in the matter through which the matter-penetrating photons (such as neutrinos) are passing. The force is in the direction opposite the direction of travel of the matter penetrating photon. This is because a charged particle (such as an electron) near the path of a photon does not feel the effects of a photon until the photon passes the charged particle. Once the photon passes, the charged particle feels the expanding Coulomb force for a relatively long time period. The force from the photon will be expanding toward to source of the photon.

As indicated in the Background section, scientists believe that billions per square foot of neutrinos from the sun pass all the way through the earth each second. I suspect that the gravity of the earth results mostly from neutrinos from the sun temporarily captured in electrons or protons in the earth and then released in random directions. As suggested above a neutron may be a proton that has captured a high-energy electron (i.e., one driven by a captured neutrino). A neutron half-life is only a few minutes and its decay results in the emission of a neutrino (presumably in a random direction. Also if electrons capture neutrinos as I suspect they do, then they probably release them in random directions.

Black holes are the seat of enormous gravity. I suspect that this gravity results from the conversion of mass into neutrinos in the black holes. This may help explain what happens to much of the matter than gets sucked into a black hole. My guess is that the matter being converted is protons and neutrons. These elements according to embodiments of this invention contain lots of trapped neutrinos. This theory may also help explain why far away galaxies are drifting apart. My understanding is that the space between galaxies contains lots of hydrogen. I suggest that hydrogen atoms have a cross section for neutrino capture that is greater than their cross section for capture of longer wavelength photons such as visible light, which does not penetrate matter very well. Thus, at extremely long distances between far-apart galaxies the neutrino flux is greatly reduced relative to the non-penetrating photons. Non-penetrating photons apply a repulsive force pushing apart the far-apart galaxies. Black holes do not emit visible light. If they emit very large amounts of neutrinos and if the neutrinos are the carriers of the gravitational force, all as suggested here, a possible consequence of a future universe dominated by black holes is that the far-apart galaxies will begin to come together to produce another “big bang”.

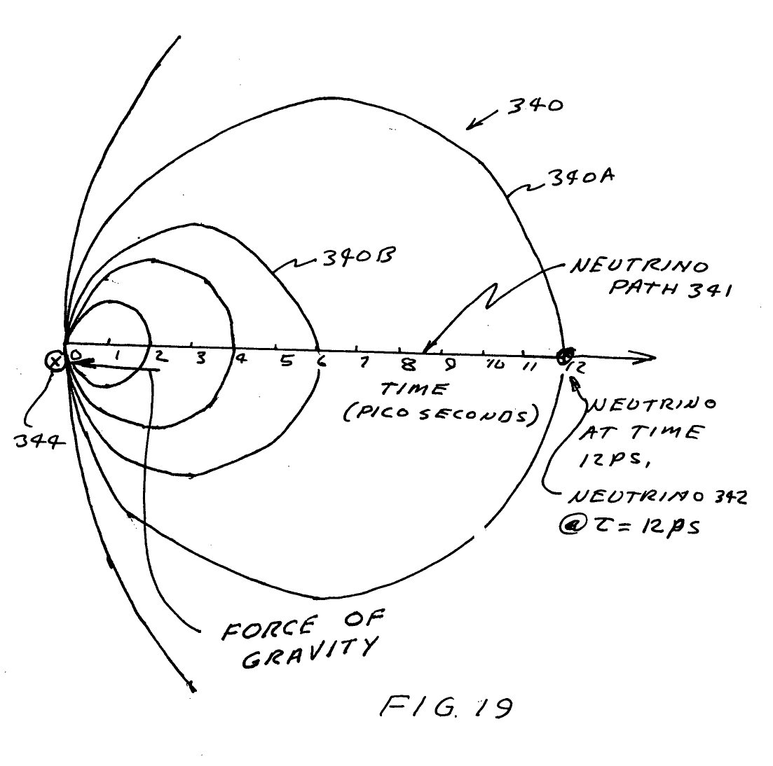

In prior art models of the universe, there is speculation that a particle called the “graviton” is the carrier of gravity although no one has ever seen a graviton despite extensive searches for them. The existence of neutrinos is well accepted in prior art theories although in all references to them that I have seen there is no indication that neutrinos carry any charge or charges. There is some question in the prior art as to whether neutrinos have mass. As explained above, in preferred models of the present invention the neutrino is nothing more than a high frequency, short wave length photon. It like all photons is comprised of a plus tron and a minus tron that travel through space as a double helix. The orbit of the neutrino is much smaller than atomic dimensions so it passes right through almost all atoms in its path and is only very rarely stopped even when passing through bodies as large as the earth. FIG. 19 shows Coulomb fields 340 produced by a neutrino 342 from the sun passing through the earth. It is traveling through the earth at the speed of light or a substantial fraction of the speed of light so that in 12 pico-seconds it would travel:

D=(12×10⁻¹²s)(3×10⁸ m/s)=3.6 mm,

or somewhat less than 3.6 mm.

It like all photons (according to the Ross Model of the Universe) is pushed by its own Coulomb forces as indicated at 342 in FIG. 19. Circle 340A represents a cross section of the field at t=12 ps that emanated from neutrino 342 at t=6 ps. Circle 340B is the field at t=6 ps that emanated from neutrino at t=3 ps. The reader should understand that the field from all points along the path of neutrino 342 define spheres which intersect the path 341 just behind neutrino 342. Of these only field 340A is shown. All of the above is just a review of elements of the present model previously discussed.

The new idea here is the effect of these fields on a charged element (such as an electron or the constituent parts of an electron [i.e., trons]) that is substantially stationary in the matter through which the neutrino is passing. The first thing to realize is that trons (such as a plus tron 344) near the path of a neutrino (as shown in FIG. 19) never feel effects of the neutrino until after the neutrino passes it. This is obvious from our earlier discussions of photons and from FIG. 19. However, after the neutrino 342 passes plus tron 344 plus tron 342 does feel the repulsive Coulomb forces emanating from the plus tron part of neutrino 342 and is repelled by it. In fact at every instant along the path 341 of neutrino 342 a Coulomb wave is emitted that repels tron 344 according to the physics of the Coulomb inverse square law. Thus, the matter in which tron 344 is trapped feels a force pushing it toward the sun (i.e., the origin of the neutrino). This (according to this preferred element of the Ross Model of the Universe) is the force of gravity carried by the neutrino from the sun to the earth. Thus, neutrinos and other mass penetrating photons (if there are any) not a graviton are the carriers of gravity. “OK”, a reader might ask, “Where does the earth get its gravity attracting me to its surface?” I suspect that a significant portion of neutrinos from the sun are scattered from protons and neutrons in the earth and some are absorbed then later released in all directions. So that the total of the matter penetrating photons is relatively uniform in all directions coming out from the earth and applying this reverse force to the charged elements inside our bodies thus pushing us toward the center of the earth. A reader may also ask “Why doesn't the Coulomb forces from neutrinos attract as many charges as it repels? I think the answer is there is a difference due to the fact that both Coulomb forces, attraction and repulsion are moving toward the sun at a speed of c.

I believe neutrinos are emitted from protons and neutrons and are absorbed by protons and neutrons. They may also be captured and released from electrons outside nuclei and maybe electrons outside atoms. Thus, in a mass like the earth an equilibrium will be reached in which the number of neutrinos absorbed in all of the protons, neutrons and electrons in the earth reaches a constant level which means that the earth is also a major source of neutrinos which are emitted in all directions. This source may be the carrier of the earth's gravity. So, a reader might ask. Why are galaxies moving apart from each other. An answer may be that a tremendous number of hydrogen atoms and molecules are distributed in the inter-galactic space. These hydrogen atoms and molecules may absorb neutrinos emitted from the galaxies and then re-emit them in random directions. Thus, reducing the effectiveness of these gravity carriers. However, longer wavelength photons do penetrate the intergalactic space, but these are absorbed near the surfaces of the galaxies applying a repulsive force.

### Biology

The present invention if it is confirmed and accepted will be enormously useful in explaining the forces of life. Applicant believes it is trons that travel through tiny nerve passages from the brain to wiggle toes upon command. Electrons and ions are too slow. I believe our brain cells somehow use plus and minus trons to store our experiences as memories in some of our hundred billion brain cells. Tron pairs provide the warmth that makes life possible. If Applicant is correct in his approach, the biology books as well as the physics and chemistry books will have to be rewritten.

### Summary Description of a Preferred Embodiment of a Ross Model of the Universe

I recognize that the above description is somewhat rambling and some models presented are inconsistent with other models, so I have prepared FIGS. 15A through 15L to support a quick summary description of my current best guess as to how the universe and everything in it is put together with trons. I apologize that this quick summary description is in many ways repetitious of some of the explanations given above. The reader should recognize that this model represents my current best guesses. I know this is speculative but I believe it is more believable than any other explanation that I have read about or heard about; and, therefore, this model should represent a useful process for examining the universe and elements of the universe, even if elements of the model turn out to be wrong.

The Tron

FIG. 15A is a drawing of a single negative tron 80. It is a point. It has no mass, only its negative charge and the Coulomb force associated with its negative charge. This force is in the form of a force field that proceeds out from the tron point in growing spheres at the speed of light. Tron 80 is pushed out by its own Coulomb force fields as shown in FIG. 15A. The space between the expanding circles represent a fixed time period such as a nanosecond or a second and a corresponding distance. If the time period is a second then the distance is 3×10⁸ meters! If the time period is one billionth of a second then the distance is about a foot. If the time period is a billionth of a billionth of a second (10⁻¹⁸ second), the distance is atomic size (3×10⁻¹⁰ m). Three of the circles expanding out from the location of tron 80 nine time intervals in the past are shown at 82. So you can see trons are very little and very fast which may be why we have lived with them for so long without realizing it.

In this embodiment trons must always be moving as fast as or faster than the speed of light. It has a few ways of doing this. If the tron is not tied to one or more other trons in some sort of association, it may travel through the universe along routes that seem random being pushed and pulled by other Coulomb forces everywhere present in the universe. It may also pair up with an opposite tron and the pair may travel in circles of any dimension at speeds of 1.57c while its Coulomb force field travels at a speed of c. When trapped in a solid, liquid or gas, the tron is usually paired up with an opposite tron and the pair is associated with an electron an atom or a molecule. The tron may also in some cases take longer loops in matter to create what is known as lines of force in a magnetic field. As a photon it normally travels in a helical path along with its partner both orbiting in the same direction. In the frame of reference of the photon, the tron often travels in a circle. No matter what path it takes it must always move at the speed of light or greater. The tron in its unassociated state offers no resistance to any Coulomb force. It is merely pushed around in the direction of the net force on it. However, once it becomes associated with other trons so that it is required to follow a definite route, then it (along with its associates) does resist any force which attempts to move it out of its path. It, by becoming associated, has acquired the property of mass. In a photon each tron has a mass of one half of hv. A photon with two trons orbiting with each other in a helical orbit at a frequency of 2.46×10²⁰/second has a mass of 18.22×10⁻³¹ kilograms (1.02 MeV). The three trons in an electron at rest together have a mass of 9.11×10⁻³¹ kilograms (0.51 MeV). Everything in the universe is made from trons. Electrons and positrons are comprised of trons. Electrons and positrons (probably with additional trons driving them) combine to form protons and neutrons. Protons neutrons and electrons combine to form atoms. Atoms combine to form molecules and atoms and molecules combine to form galaxies and galaxies combine to form the universe.

Tron Pairs

FIG. 15B is a drawing of a tron pair. A plus tron 84 and a minus tron 86 have joined together in a mutual attraction self repulsion orbit along path 88 in direction 90. The wavelength of the tron pair is λ. The period of the orbit is T=1/f=λ/c where f is the frequency. The wavelength could be any length. For example if λ is 3×10⁻⁶ m (infrared light), then T would be 1×10⁻¹⁴ second. The orbit diameter is ½. Minus tron 86 is located at the position shown for 86 at time, t=0. At time t=−0.5 T minus tron 86 was located at the position 84 on the opposite side of circle 88. At time t=about −0.3 T plus tron 84 was located at position 92 and minus tron 86 was located at position 94. The forces on tron 86 are shown by arrows 86A, 86R, and the forces on tron 84 are shown by arrows 84A and 84R. Thus, repulsive forces 86R and 84R keep the two trons located on tangents of circle 88 and attractive forces 86A and 84A keep the two trons directed around the circle at a frequency of 1×10¹⁴/second (ten thousand billion times per second!).

Photons

A photon is depicted in FIGS. 15C(1) and 15C(2) as a plus tron and a minus tron with wavelength λ moving along a double helical path at a speed of c. In this case each tron in the tron pair shown in FIG. 15B is pushed in a direction perpendicular to the plane of orbit by its own force field from one wavelength back on its helical path. For example, the expanding force field of minus tron 86 originating from its location at position 96 (one wavelength back) arrives at position shown for tron 86 the same time tron 86 arrives there. Also, force fields from two, three, four, etc wavelengths back also arrive at the tron position shown at 86 the same time tron 86 arrives there. Tron 84 is similarly pushed along. (The reader should note that the attractive force field from tron 84 when it was at location 100 also arrives at the position of tron 86 at the same time as the repulsive force of tron 86 from location 96. I'm not sure why this force doesn't pull tron 86 back. Maybe it does not because the force is moving in the direction of tron 86 at the same speed as tron 86.) A polarized photon may be modeled as two trons oscillating along a line perpendicular to the photon direction. In this case the photon would map out from the side view two criss crossing sine functions as shown at in FIGS. 15C(4) and 15C(5).

Applicant suspects that the photon can proceed in a variety of modes other than the two shown in FIGS. 15C(1) and (2). And 15C(4) and (5). For example, the orbit direction (shown as clockwise in FIG. 15C(2) coulod be counter clockwise. Eliptical orbits may be possible.

Neutrino

FIG. 15C(3) is a drawing of a neutrino. It, in this embodiment, is exactly the same as the photon shown in FIG. 15C(1 and 2) except the wavelength is much shorter, shorter than proton dimension. The reader should note that typical charts showing the electromagnetic spectrum show wavelengths between about 1×10⁻¹⁵ m and 1×10⁸ m. Note that 1×10⁻¹⁵ m is about the size of a proton. This means that photons smaller than 1×10⁻¹⁵ m would be very difficult to detect since they would easily pass right through atoms and might even pass right through nuclei. So we don't detect them and we are unaware of photons with wavelengths shorter than about 1×10⁻¹⁵ m. One feature of a preferred model is that photons can have any wavelength without limit from the smallest imaginable to the largest imaginable. I think these facts support the idea that neutrinos may very well be high frequency photons and that they come from the inside of protons and neutrons during fusion and fission reactions and can be captured inside protons and neutrons.

Positrons and Electrons

My latest negatron model is shown in FIG. 15D(3). A plus tron 302 follows a circular path and two minus trons 304A and 306A orbit the path one fourth period behind the plus tron. The negatron is viewed from a position 30 degrees above the plane of the plus tron's circular path 300. The path of minus tron 304A is shown in large dashes above the plus tron's plane and small dashes below the plane. The path of the minus tron 306A is shown in solid line above the plane and dots below the plane. FIG. 15D(3) is a snap shot drawing at a time, t=0. Three arrows show the direction of the three trons at the time of the snap shot. The positron and the negatron are produced in a pair production process as explained above in reference to FIGS. 14A, B and C as the result of the marriage of one high-energy photon with two lower energy photons. According to a preferred embodiment, a minus tron of the high energy photon can desert its mate, the plus tron, to form a three part electron only if the plus tron finds partners to form a three part positron at the same time. This assures that the number of electrons and positrons in the universe are exactly the same. (I admit this is a very wild statement and it is in all likelihood not true. Nevertheless, it is included in this particular embodiment. It is not very likely that anyone could ever prove that the numbers of electrons and protons are in fact exactly equal.) FIGS. 15D(2) and 15D(3) show earlier models of a positron and an electron in which two like trons orbit outside an opposite inner tron.

Electron with Captured Tron Pairs

In this preferred embodiment of the present invention an electron (negatron) may capture one or more tron pairs and thereby increase its energy. Thus, the speed of the electron, its energy, its mass is determined at least in part by the tron pair or pairs it captures. FIG. 15E(1) shows an electron 104 as in FIG. 15D(2). As the two negative trons orbit the positive tron they create orbiting force fields which are rotating and are attractive for trons paired up in photons provided the wavelengths and frequencies match. Thus, a photon can be captured if its frequency is resonant with the orbits of the trons in the electron. FIG. 15E(2) shows an electron which has captured a single photon 106 and FIG. 15E (3) shows an electron which has captured two photons 106 and 108. Captured photons apply forces on the electron increasing its velocity and thus its energy/mass. FIG. 15E(4) shows what happens if the electron is moving at a significant fraction of the speed of light. The orbiting trons 84 and 86 in the captured tron pair are attracted to the place 110 where the electron was when its force field left. Thus, both trons are behind the electron as shown in FIG. 15E(4). In that position a force field of tron 84 exerts a repelling force on electron 104. The speed of the repelling force in the direction of the electron motion depends on the orbit diameter (the smaller the size the greater the energy) of the photon. As shown in FIG. 15E(4) the captured photon is pushing the electron at a speed of 0.5 c. FIG. 15E(5) is an example of a much higher frequency photon 112 captured by the electron. In this case the electron is being pushed along at near the speed of light. Thus, I believe that electron energy and electric potential is determined by photons captured by electrons. Thus, electrons can be made to go faster by causing them to capture more photons or higher energy photons. When we talk about high voltage what we mean, according to this embodiment, is the electrons at issue have captured enough high energy tron pairs that the electrons are moving with speed corresponding to the voltage we are talking about. The smaller the wavelength of the tron pair, the closer the negative tron will be to the electron and the greater the force pushing the electron forward. Also, as shown in FIG. 15E(6) multiple tron pairs could be attached to one electron and their effects are additive.

My old electron model is used in FIGS. 15E(1)-(6). The reader should note that my new electron model shown in FIG. 15D(3) could be substituted. Also, with the 15D(3) model the plus tron of the photon could be attracted to the inside of the negatron to orbit in the path of the plus tron 302A leaving the minus tron of the photon to follow along behind the electron attracted to its trapped mate but applying a repulsive Coulomb force to give the negatron its speed.

Electric Circuit

FIG. 15E(7) shows a simple electrical circuit with four 6 Volt batteries 142 A-D connected in series and providing power to 12 Volt lamp 144 and 24 Volt lamp 146. This circuit is intended to explain qualitatively current flow according to this preferred model. It is not intended to be accurate in a quantitative sense even though quantitative numbers are used. The circuit is grounded at 147. The lamps are separated from the batteries by about 100 meters of copper wire. In this model electrons at ground potential are shown at 148 as having no more captured tron pairs than other electrons at ground potential. The act of charging the batteries to 6 Volts adds tron pairs to the electrons (symbolized by one tron pair to each electron) on the negative plates of the battery. As shown at 150 electrons on the negative plates of battery 142A have captured one extra tron pair. As shown at 152 electrons on the negative plates of battery 142B have captured two extra tron pairs and as shown at 154 electrons on the negative plates of battery 142D have captured four extra tron pairs. As explained the excess energy of the electrons (above its ground state) depends on the number of captured tron pairs (we are assuming in this case that all tron pairs have the same energy). When switches 156 and 158 are open all electrons downstream of the switches are at ground state. When switch 156 is closed, 24 Volt electrons begin to flow downstream of switch 156 repelling minus trons. Millions of minus trons are now free to move at almost the speed of light toward the plus side of battery 142A. Almost instantly these minus trons travel the 100 meters to lamp 146 repelling other minus trons in the process until almost instantly the entire 100 meters of coper wire is at the same potential. However, trons greatly prefer copper to tungsten and therefore do not pass through the tungsten filament in lamp 146. After the minus trons reach the end of the copper, they still must travel as fast or faster than the speed of light. In order for huge numbers of minus trons to travel at the speed of light or faster in a thin copper wire the minus trons must travel very fast in very small circles. Plus trons are attracted to the fast circling minus trons and join them in forming tron pairs around the free electrons creating 24 Volt electrons all along the conductor between battery 142D and lamp 146. All free electrons share the trons pairs so that all electrons in the wire reac an equilibrium at about the same energy. The negative high-energy electrons on the high voltage side of lamp 146 are attracted to the ground side of lamp 146 by Coulomb forces and they flow through the tungsten filament of lamp 146. These electrons give up their excess tron pairs in the tungsten filament, heating it up and the tron pairs exit lamp 146 as photons 160. Plus trons flow up from ground at almost light speed as shown at 162 to balance the negative charge flow through lamp 146. When switch 158 is closed, the process is similar except the electrons lose only half of their extra tron pairs as they pass through lamp 144.

FIG. 15E(8) shows a light emitting diode. Here plus trons flow clockwise and minus trons flow counterclockwise in the circuit as shown at 164 to the p-leg and the n-legs of the diode. Photons are formed and emitted when the trons meet at the junction.

Proton

My original proton model is shown in FIG. 1SF. It is comprised of a central electron 116, two close in positrons 118A and 118B separated by about 3×10⁻¹⁸ m and two outer electrons 120A and 120B separated by about 1×10⁻¹⁵ m. FIG. 15F(1) shows how captured photons 122 and 124, could be pushing the orbiting electrons and positrons in their orbits. Another possible configuration is one in which each of the three trons in each of the electrons and positrons are being driven by neutrinos. My current preferred proton model is shown in FIG. 15F(3).

Neutron

FIG. 15F(2) shows a neutron, which is the same as the proton shown in FIG. 15F(1) except with an extra high-energy electron 126, driven by a neutrino type photon 128. My currently preferred neutron model is shown in FIG. 15F(4) which is just like the proton in FIG. 15F(3) except for the addition of negatron 327 and its driving neutrino 328.

Atoms

FIGS. 15G(1-4) show how nuclei of atoms are built up with protons and neutrons (based on my five-electron proton model) taking advantage of Coulomb forces without the need for any “strange force”. As explained in more detail above, specific distribution of five separate charges (three plus and two minus) in the proton and six separate charges in the neutron (three plus and three minus) allow the protons and the neutrons to position themselves within force wells in nuclei in very stable configurations under the influence only of the Coulomb forces. My currently preferred atomic nuclei model is based on the three-electron proton and the four-electron neutron and is shown in FIGS. 15F(3) and 15F(4). FIG. 15G(5) shows a possible configuration in which two protons each with a positive net charge can be held tightly together in a stable Coulomb force well.

Heat and Temperature

In this embodiment heat and temperature of a solid, liquid or gas are expressions of photons (or tron pairs) which have been captured and are temporarily located in the solid liquid or gas. According to this model, all atoms and molecules naturally define a number of tron pairs which help define the basic atom or molecule in its natural unheated state (i.e., its absolute zero temperature state). FIG. 15H(1) depicts the atoms 128 of a solid crystal at zero degrees Kelvin. The atoms of this crystal comprise tron pairs, but these tron pairs are part of the make-up of the crystal and there is no force within the crystal structure encouraging them to leave, even at a temperature of absolute zero. However, the crystal can accommodate a great many tron pairs, and if it is placed in an environment warmer than absolute zero, tron pairs will enter the crystal as indicated at 130 in FIG. 15H(2) and will remain as shown at 132. The more tron pairs that enter through radiation or conduction, the warmer the crystal becomes. Some tron pairs may also leave, but there will be a net inflow until the crystal becomes in equilibrium with its environment. FIG. 15H(3) depicts a hot crystal with tron pairs entering 130 and tron pairs leaving 134 and many remaining temporally trapped 132. Tron pairs may retain their entering frequencies inside the crystal or as the result of interactions inside the crystals with other trons which are part of the atoms or part of other tron pairs they may have their frequencies increased or decreased. For example a hamburger heated in a microwave oven with photons at a specific frequency will cool off by emitting thermal photons over a wide range of wavelengths. If tron pairs are continuously added to the solid crystal faster than they are released the number of tron pairs in the crystal will grow and become more and more crowded. This will cause the crystal structure to expand and eventually disruptive forces of all of these tron pairs will overcome the forces holding the atoms together in their crystal structure. The crystal may melt as depicted in FIG. 15H(4). The atoms of the crystal move about more or less randomly as indicated at 136 but Coulomb forces continue to provide a net attraction between the atoms. However, occasionally tron pairs circling an atom will produce net repulsive forces to cause atoms to evaporate and leave the melted crystal as shown at 138. Continued heating of the melted crystal will put more and more tron pairs into the liquid. This has the effect of forcing the pairs into smaller and smaller circles (i.e., higher and higher frequency tron pairs) and as a result the tron pairs leaving as thermal radiation have on the average shorter wavelengths. Also, the shorter circles tend to cause the tron pairs to circle individual atoms. (In a molecular fluid the tron pairs will tend to circle molecules.) This reduces the attraction between the atoms in the fluid and more and more of them will become disassociated from the liquid, i.e., they evaporate. FIG. 15H(5) shows all of the atoms of the original crystal evaporated and completely filling the container as vapor. Each atom is encircled by a number of tron pairs producing conglomerations of atoms and captured tron pairs and the conglomerations all repel each other and the container creating a pressure in the container. Adding more tron pairs to the vapor in the form of radiation or convection through the container will increase the number of ion pairs encircling each atom. Tron pairs will travel from one atom to another and to and from the walls of the container producing a substantial equilibrium among the atoms in the vapor. The temperature is a measure of the number of tron pairs per atom throughout the process of the heating of the crystal from its absolute zero state to its hot vapor state.

Magnetism

As indicated in the previous section, all solids above absolute temperature have a lot of captured trons. These trons normally come in as tron pair through conduction or radiation and tend to remain as tron pairs within the solid. However, a tron does not have to be paired up. What is important is that it be free to travel at the speed of light or greater. If a tron slows down it faces an infinite Coulomb force from immediately behind. The tron typically likes to be paired up because that allows the to go at a speed greater than the speed of light in a circle with its partner pulling him through his own force field at points half-way around the circle as shown at 208 in FIG. 14. However, if conditions are right the tron is just as happy making longer loops so long as the tron can do it at the speed of light or greater. This is what I believe happens in a permanent magnetic as shown in FIG. 15I(1). There trons 142 loop around the magnetic moving at the speed of light. They can continue across gaps as shown at 144 in this horse shoe magnetic. If this were a bar magnetic the trons would exit the bar at one pole, loop around on the outside and enter at the other pole. Magnets can be created with materials such as iron and a current carrying coil as is well known.

I have not figured out which tron takes to route shown by arrows 142 and 144 in FIG. 15I(1). I think it is the positive trons in most magnets and the negative trons orbit around the positrons in a helical pattern as shown in FIG. 15I(5). FIG. 151(2) shows a transformer. Here electrons flow in four loops 168 around iron core 166. The fields set up by the orbiting electrons and minus trons pushed along by the electrons allow plus trons to flow freely around iron core 166 at speeds equal to or greater than the speed of light. If the current in primary winding 168 is alternating then the direction of the tron flow will alternate accordingly. This will produce a circulating flow of negative trons around core 166 which will create a current in loop 170.

FIG. 15I(4) depicts the earth's magnetic field. I believe that circulating metals in the earth's interior create conditions under which trons are able to travel through and around the earth as shown in the figure. At speeds in the range of the speed of light or greater, the round trip is probably less than a second. FIG. 15I(3) represents motors and generators which involves conductors rotating in magnetic fields. I have not figured out exactly how electricity is generated and exactly how the flowing trons and electrons turn the motor shaft. I think it works like this: As a conductor 172 passes through the magnetic field (i.e., the streaming trons) shown at 172 in FIG. 151(3) plus trons in the conductor are forced in one direction and minus trons are forced in the opposite direction. When the conductor loops around and passes back through the streaming trons in the opposite direction then the trons in the conductor are forced in directions opposite those of the first pass. Another possibility is that the trons shown in FIG. 15I(5) are captured into the conductor as it makes one pass through the streaming trons and exits the conductor into the stream when the conductor passes back through the stream in the opposite direction.

Chemical Energy

FIG. 15J(1) depicts a hydrogen molecule which is two hydrogen atoms sharing electrons. FIG. 15J(2) shown an oxygen molecule which are two oxygen atoms each with six electrons in their outer shells and sharing two electrons to complete the eight electrons desired shell. FIG. 15J(3) depicts a water molecule H₂O. FIG. 15J(4) depicts a hydrogen molecule like that shown in FIG. 15J(1) but with a large number of trapped tron pairs. FIG. 15J(5) shows an oxygen molecule also with a large number of trapped tron pairs. These numbers of tron pairs in the hydrogen and the oxygen is assumed to represent equilibrium states at a particular temperature. FIG. 15J(6) depicts a water molecule at the same temperature as the hydrogen and oxygen temperatures, but according to the drawings the water molecule has around it many fewer tron pairs than the pairs in the hydrogen molecule plus one half of the tron pairs in the oxygen molecule. This example is suppose to show that when hydrogen bums in oxygen to form water the energy produced is excess tron pairs which are released in the process in the form of photons. The point here is that in all exothermic reaction the heat released is excess tron pairs. In many reactions heat must be added to make them go. In these cases the natural state of the product needs more tron pairs than the constituents at the same temperature.

Fusion and Fission

FIGS. 15K(1) through 15K(4) show a similar example as above except on a nuclear scale. FIGS. 15K(1) shows a deuterium nucleus (a proton and a neutron) and 15K(2) show a He nucleus (two protons and two neutrons). FIGS. 15K(3) shows the deuterium nuclei with many surrounding tron pairs. FOG 15K(4) shows the He nuclei with tron pairs but here the natural state of two deuterium nuclei have more tron pairs than the helium nuclei that results from the fusion of the two deuterium nuclei. Thus, the excess tron pairs are released a photons, in this case very high energy gamma photons plus some neutrinos. In fission I believe uranium 235 has more tron pairs associated with it than the fission products resulting from the fission.

Thermo Electric Effects

Electric energy can be generated directly from a temperature difference by reason of the thermoelectric effects. FIG. 15L depicts a thermocouple made from dissimilar wires 174 with one junction at cold heat sink 176 and the other junction in hot heat source 178. Voltmeter 180 measures the potential difference generated. As indicated the heat source contains many more tron pairs than the heat sink. Plus trons travel along p-leg 182 from heat source 178 to heat sink 176 and minus trons travel along n leg 184 from heat source 178 to heat sink 176. This results in a current as shown at 186 and a potential difference as measured at 180.

### When a Photon Meets an Electron

What happens when a photon meets an electron? Readers may enjoy considering the result. We don't know the size of an electron; however it must be much smaller than a proton which is about 10⁻¹⁵ m. We might assume that the electron's dimensions are about 10⁻¹⁸ m. (Let that be the diameter of the path 300 of plus tron 302.) Therefore, the typical photon is going to be much larger than an electron. In the vicinity of an electron plus trons will be attracted and minus trons will be repelled. Any plus tron that intersects the electron cross section will probably be sucked into it. However once inside the minus trons' orbits the plus tron will encounter electron's plus tron, and the invading plus tron will in most cases be kicked out. This may explain reflection. Also, the plus tron may locate itself on the electron's plus tron orbit at the 180-degree position where it may be temporarily stable. The minus tron mate of the invading plus tron may continue to orbit the invading plus tron which is stuck inside the electron. If so its Coulomb force repels the electron. My guess is that the two trons of the photon are only very loosly coupled to the electron and are easily ejected. This we would see as a photon emission from the electron. This may occur when an electron passes through a resistor.

### Relativity

Readers may wonder how these models relate to Professor Einstein's theories of relativity. Applicant submits that he does not know. In preferred models the only thing that exists in the universe are trons and the only force is the Coulomb force from the trons. A tron's speed is not dependent on the source of the tron. Thus, the speed of light in every frame of reference is the same. This is one of the key foundations on which Dr. Einstein's theories rest. These models are consistent with the equivalence of mass and energy.

### Nuclear Model

The structure of protons, neutrons, nuclei, atoms, the earth, us and the rest of the universe can be explained very simply without resort to the strong force, quarks and other prior art theories of “modem physics” that the leading writers apparently believe in without proof of their existence. This model also, better than any other example that I am aware of, shows that mass and energy really are the same thing! Trons are the building blocks of the universe. Trons are mass-less. They offer no resistance to forces placed upon them. Trons pair up to form tron pairs. The pairs do resist forces placed upon them. Thus, they have mass and therefore energy. The also push themselves through the universe with their own forces at the speed of light. Positrons and negatrons are generated from photons including at least one high-energy photon. Positrons and negatrons do have mass and move at speeds less than the speed of light, usually much less. We also know that when a positron and a negatron collide both may be annihilated with the production of two high-energy gamma rays. Protons and neutrons are, in the Ross models, nothing but combinations of these positrons and negatrons with possibly some neutrinos thrown in. Two of the negatrons are moving extremely fast, fast enough to produce almost all of what we have thought of as the mass of these particles. Alternatively, it may be that the energy of the neutrinos account for most of the mass of the proton and the neutron. So in protons and neutrons, the masses of electrons and positrons are amplified. But, based on this model, electrons and positrons are made from mass-less things (trons) which develop their mass when subjected to conflicting forces created by the trons them selves and each other. Atoms are made of protons and neutrons along with some orbiting negatrons and all of the things we see in the universe are made of atoms. Thus, all the mass of the things we see in the universe is derived from the electrostatic forces generated by these mass-less trons and applied to themselves and each other.

This model also is consistent with the notion that for each negatron, there must be a positron. In my model the universe has exactly the same number of negatron as positrons. My preferred models also propose the exact same number of plus trons and minus trons. With this model, believers will have a good time revising theories dealing with the big bang. It is very easy to speculate how trons released in the big bang would have combined to form jillions (a huge number, not quite equal to infinity) of trons which would have combined to somewhat fewer jillions of positrons and negatrons many of which quickly would have quickly annihilated itself and one of its opposites or would have combined with four other electrons to form a proton or five other electrons to form a neutron. Protons are extremely stable. Most of them would have at some time captured a negatron to form a hydrogen atom. The neutrons would either have combined with a proton to form heavy hydrogen or would have quickly decayed to a proton. The positrons that did not join in the formation of a proton or neutron would have been annihilated. Thus, shortly after the big bang we are left with jillions of photons, maybe jillions of still uncombined trons, fewer jillions of protons and an equal number of negatrons. In the course of all of this some hydrogen nuclei combined to form helium nuclei. This is what happened at the start of the present universe according to a preferred embodiment of the Ross Model. Later on heaver elements were made in stars which exploded to spread the heavy elements around the universe.

### Big Bang Speculation

I'm hoping that believers will have great fun using embodiments of the Ross Model to explain the origin of the last big bang and to predict the next big bang. Since we now understand the basic structure of nuclei, we can understand what will happen when all the matter of the universe comes crushing in to almost a single point or to approximately a single point. This is possible since everything is made of trons and trons are points, since there are equal numbers of them and since opposite trons love each other and attract each other with an infinite force when they are very close to each other. Think of the fun we will have calculating the energy released when all of the positrons and negatrons of all the atoms of the known universe are crushed together and annihilate each other. For example: Prior to the big bang there existed an earlier universe similar to ours. After trillions of years, all of the stars burnt out and cooled down stopping a previous expansion and starting a contraction toward the biggest black hole in that earlier universe. The negatrons in atoms combine with protons in nuclei to produce neutrons. As long as the black hole was eating the rest of the universe, the energy released (i.e., released tron pairs and neutrinos) kept it from collapsing in on itself. However, when essentially all of the universe had been consumed this biggest of all black holes began to collapse in on itself so that the positrons and negatrons comprising the neutrons combine to release neutrinos and produce gamma rays. Escaping neutrinos drive other neutrinos and other high-energy photons in the black hole toward its center. At the center the photons and the neutrinos and other high energy photons combine in a volume the size of a softball to produce the big bang in which a large portion of the trons making up the neutrinos and photons are released as plus and minus trons all of which expand out from the center of the big bang pushed by their own repulsive forces at speeds equal to or greater than c.

### Energy in the Proton

If the Ross Proton Model is correct, it should be apparent that the proton (the hydrogen nucleus) has within it one heck of a lot of energy. Therefore, we may want to put some effort into trying to figure out how to release that energy. The energy available is many orders of magnitude greater (for a given amount of hydrogen) than that released in a hydrogen bomb. The current belief is the in a hydrogen bomb two hydrogen nuclei are converted to a helium nucleus. The energy released is the difference in mass of the two hydrogen nuclei and the mass of the helium nucleus. This is a small fraction of the mass of a hydrogen nucleus. If this model is correct all (or almost all) of the mass of the hydrogen nucleus would be released if we could cause it to break apart so that the positrons and negatrons could combine to release gamma ray photons and neutrinos. If we could knock off one of the orbiting positrons, the remaining particle would probable be unstable and decay rapidly into positron and negatrons flying apart at high speeds and annihilating each other along with the release of gamma rays.

### Correctness of Models

The models presented in this specification (including the proton and the model of atomic nuclei presented above) constitute a major departure from the most widely accepted theories explaining the makeup of nuclear particles. The reader should understand that the models presented herein are evolving. Some are going to be proven incorrect in all likelihood. I expect to develop better models. I am sure others will also if it turns out that I am generally on the right track with the concepts described in this specification. If all of my ideas are not correct, I will be in good company. Newton and Maxwell did not get it right in every situation. If these models are anywhere close to being correct all physics books written during the past 20 years will have to be substantially revised. Applicant recognizes that many of the smartest people in the world have devoted their lives to efforts directed at explaining the makeup of these nuclear particles. Applicant has described his models in the very long shot belief that they might be correct or that they are close to correct. Applicant has presented these models as a patent application for three reasons: (1) he is a patent attorney (a long time ago he used to be a nuclear engineer) and is familiar with patent applications as a technique for publishing discoveries, (2) a patent application is at least initially kept secret and can be abandoned, or corrected in continuations-in-part so if he learns soon that he has made foolish mistakes, he can perhaps minimize his embarrassment and (3) in the unlikely event he his right, he would like to have some control over the applications of his discoveries. However, all of his current and past clients will have a royalty-free right to practice (in their current business activities or in any current or past anticipated research and development) under any resulting patent.

### Testing the Models

Many processes are available for utilizing, testing and evaluating the models described herein. One process is for a person experienced in modern nuclear physics to evaluate the models as they have been presented in this specification. This can easily be accomplished with a hand calculator.

### Computer Models

A more sophisticated model would be to utilize a digital computer model incorporating one or more of the models. It should be fairly simple to model the trons, the positrons the negatrons the protons and neutrons in the Proton Models and determine which are stable. If I am right, these models will show that the electron and proton and their antiparticles should be enormously stable except when opposites meet. By making the computer model a little more complicated, it should be feasible to determine how hard it would be to make a proton using the technique described above for doing that. Perhaps then the computer model could be extended to predict the formation of protons in the models during the process that followed the big bang. Once the proton and the neutron have been modeled on a digital computer it would be relatively simple to create similar computer models to examine the Nuclear Models. After these models are created investigations could be preformed to determine if a technique can be developed to breakup the proton and release its energy. If this could be done economically, we would have what may be the most important invention since the beginning of civilization. The models of current flow described herein should be extremely important if they are correct in understanding current flow in everything from integrated circuits to electric power transmission circuits. The techniques herein should also be very valuable in the understanding and design of communication systems from radio, microwave to fiber optics. In each case a heretofore unknown thing, the tron, is the workhorse in making these systems work. Now we should really understand why they work and as a result maybe make them work better.

### Nuclear Tests and Experiments

If computer modeling shows that the models are correct or that modifications or derivations of the models are correct. A next step is to perform some experiments with particle accelerators to test the models or aspects of the models. It may be that current accelerators do not have the capabilities to properly investigate the models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced form photons and that the annihilation of electrons and positrons produce photons. All of these experiments support the models described above.

### Trons Deserve Their Own Unit

Applicant believes that if his model is correct and the entire universe is made of these trons, each having a particular charge approximately equal to the values set forth above; the magnitude of that charge should be considered the most important thing in the world important enough to rate its own value. And also the other forces at work in the universe all of which will be, one way or other, derived from these charges should be spoken of in terms of the quantity of these charges and not vice versa. Applicant has thus generated a new term that represents the exact magnitude of the charge of a tron. That term is the “Ross” the symbol for a Ross is “R”. Thus, the charge of a plus tron is +1 Ross or +1R. The charge of a minus tron is minus 1 Ross or −1R. The plural of Ross is Ross (like the plural of deer is deer). Therefore, one Coulomb is equal to about 6.25×10¹⁹ R. Since force between charges is the product of the two charges divided by the square of the distance between them, force is expressed as Ross per square meter (R²/m²). Thus, the attractive Coulomb force between a plus tron and a minus tron positioned 5.3×10⁻¹¹ meter apart is equal to 3.56×10²⁰ R²/m². That force in Newtons is 8.2×10⁻⁸ N; thus, one Newton equals 4.34×10²⁷ R²/m².

### No Quarks, No Special Weak Force and No Strong Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

While preferred embodiments of the present invention are described above, the reader should not construe the present invention as limited by the above description. In fact persons skilled in nuclear physics will envision many other possible variations within the scope of the present invention. For example, other models of proton, somewhat more complicated than the one described above may be the true proton model. For example, instead of two negatrons in the close-in orbit there could be four or six with a corresponding four or six positrons in the outer orbit, again to give the proton a plus 1 charge. The basic Ross Proton Model is a proton that is comprised of electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. Alternatively, the proton mass may also be the result of very high energy photons which are pushing the electrons in their tight orbits. These very high-energy photons may be neutrinos. Processes involving many other branches of physics will need to be revised for a correct understanding of the true nature of the atomic structure. The above disclosures may also be useful in processes for analyzing electromagnetic radiation, especially high-energy radiation. Accordingly, the reader is requested to determine the scope of the invention by the appended claims and their legal equivalents and not by the above examples.

I claim:

1) A process for modeling elements of the universe utilizing in models negatively charged trons, each having zero mass and a negative charge of about 1.9×10⁻¹⁹ Coulomb and positively charged trons, each having zero mass and a positive charge of about 1.9×10⁻¹⁹ Coulomb, said process comprising:
A) assigning an electric force field to each plus tron which expands out spherically from each of said plus tron with a velocity equal to the vacuum speed of light and produces an attractive Coulomb force on minus trons and a repulsive Coulomb force on plus trons,
B) assigning an electric force field to each minus tron which expands out spherically from each of said minus tron with a velocity equal to the vacuum speed of light and produces an attractive Coulomb force on plus trons and a repulsive Coulomb force on minus trons,
C) allowing some or all or said trons to be repulsed by their own force fields and to be repulsed and attracted by force fields from other trons so as to attain velocities equal to and greater than the vacuum speed of light, and
D) using said plus trons and said minus trons to model elements of the universe.

2) The process of claim 1 wherein everything in the universe is comprised of only said plus and minus trons.

3) The process of claim 1 wherein a photon is modeled as being comprised of one plus tron and one minus tron traveling together with each tron being pushed by its own force field and attracted by the force field of the other tron.

4) The process of claim 3 wherein said plus tron and said minus tron are modeled as traveling in a double helix pattern.

5) The process of claim 1 wherein a neutrino is modeled as being comprised of a plus tron and a minus tron.

6) The process of claim 1 wherein a negatron is modeled as being comprised of a plus tron and two minus trons.

7) The process of claim 1 wherein a positron is modeled as being comprised of a minus tron and two plus trons.

8) The process as in claim 6 wherein said plus tron is modeled as traveling in a circular path or an approximately circular path and said two minus trons are modeled as orbiting helically around said circular or approximately circular path resonantly with said plus tron.

9) The process of claim 1 wherein at least one proton is modeled as being comprised of nothing but trons.

10) The process of claim 9 wherein at least some of said trons within said proton are parts of at least one negatron and at least two positrons.

11) The process of claim 10 wherein said at least one negatron is modeled as one electron traveling in a circular or approximately circular path and said at least two positrons are modeled as two positrons modeled as orbiting said circular or approximately circular path resonantly with said negatron.

12) The process of claim 1 wherein a proton is modeled as being comprised of a central element having a plus charge, two negatrons in a close orbit about said central plus charge at speed extremely close to the vacuum speed of light and two positrons orbiting said central plus charge and said two negatrons in a farther out orbit.

13) The process of claim 12 wherein said central element comprises a positron.

14) The process of claim 12 wherein each of said negatrons is modeled as having three neutrinos in orbit with it and at least two of said positrons is modeled as having three neutrinos in orbit with it.

15) The process of claim 15 wherein at least one neutron is modeled as being comprised of a proton plus a negatron.

16) The process of claim 15 wherein said negatron is a heavy negatron which is a negatron having captured a neutrino.

17) The process of claim 1 wherein a nucleus of an atom is modeled as being comprised of protons and neutrons held together with Coulomb forces.

18) The process of claim 1 wherein a magnetic force is modeled as being produced by the flow of trons into and out of magnetic material.

19) The process of claim 18 wherein the magnetic material is the core of the earth and the trons are modeled as flowing into and out of the earth at locations near the north and south poles.

20) The process of claim 1 wherein the entire universe and its evolution before and after the big bang is model using only plus and minus trons as building blocks.

21) The process of claim 1 wherein neutrinos are modeled as a high-energy photon.

22) The process of claim 21 wherein the neutrino is modeled as a carrier of gravitational force.

23) The process as in claim 1 wherein gravity is modeled as a slight imbalance of Coulomb forces.

24) The process as in claim 1 wherein galaxies are modeled as being pushed apart from one another by photons.

25) The process of claim 1 heat and temperature of an object is modeled using tron pairs.

26) The process of claim 1 wherein tron pairs circling atoms or molecules are treated as causing phase changes from solid to liquid and from liquid to gas.

27) The process of claim 1 wherein trons are utilized to represent at least in part a flow of electric current in a conductor.

28) The process of claim 1 wherein trons are utilized to represent transfer of nerve signals through portions of a living animal.

29) The process of claim 23 wherein the living animal is a human.

30) The process of claim 8 wherein said negatron is modeled as a high energy negatron comprising a captured photon providing a force propelling said high energy negatron.
